(19) United States
(12) Patent Application Publication
(10) Pub. No.: US 2025/0372717 A1
(43) Pub. Date: Dec. 4, 2025

(54) SECONDARY BATTERY

(71) Applicant: Semiconductor Energy Laboratory Co., Ltd., Atsugi-shi (JP)

(72) Inventors: Yuya MIYASHITA, Atsugi (JP); Kazutaka KURIKI, Ebina (JP); Teppei OGUNI, Isehara (JP); Daichi HIGO, Atsugi (JP); Akira NAGASAKA, Atsugi (JP)

(21) Appl. No.: 19/215,658

(22) Filed: May 22, 2025

(30) Foreign Application Priority Data
May 31, 2024 (JP) 2024-088733
Mar. 31, 2025 (JP) 2025-057951

(51) Int. Cl. H01M 10/0569; H01M 10/0568; H01M 50/414

(52) U.S. Cl. CPC H01M 10/0569; H01M 10/0568; H01M 50/414; H01M 2300/0034; H01M 2300/0037

(57) ABSTRACT

To provide an electrolyte solution capable of inhibiting ignition or the like and a secondary battery including the electrolyte solution. The secondary battery includes a positive electrode, a negative electrode, a separator between the positive electrode and the negative electrode, and an electrolyte solution. The electrolyte solution includes a mixed solvent and a lithium salt. In the electrolyte solution, a concentration of the lithium salt is higher than 1 mol per liter of the mixed solvent. The mixed solvent includes a fluorinated linear carbonate and a fluorinated cyclic carbonate. In a DSC measurement of the electrolyte solution, a peak of heat flow of a heat generation reaction in a range higher than or equal to 180° C. and lower than or equal to 300° C. is less than or equal to 200 mW/g.

### BACKGROUND OF THE INVENTION

### 1. Field of the Invention

The present invention relates to a secondary battery. Note that the technical field of the present invention is not limited to the secondary battery; a semiconductor device, a display device, a light-emitting device, a power storage device, a lighting device, an electronic device, a vehicle, manufacturing methods thereof, and the like can be given as the technical field. For example, a secondary battery of the present invention can be used as a power supply necessary for a semiconductor device, a display device, a light-emitting device, a power storage device, a lighting device, an electronic device, and a vehicle. Examples of such electronic devices include an information terminal device provided with a secondary battery, and examples of a power storage device include a stationary power storage device.

### 2. Description of the Related Art

In recent years, demand for lithium-ion secondary batteries with high output and high capacity has rapidly grown with the development of the semiconductor industry. The lithium-ion secondary batteries are essential as rechargeable energy supply sources for today's information society.

When a lithium-ion secondary battery is heated from outside, a positive electrode, a negative electrode, and an electrolyte solution independently react or react with each other, which causes a heat generation reaction. In general, when the temperature of a lithium-ion secondary battery reaches approximately 100° C., a negative electrode starts to collapse, which generates heat, and when the temperature exceeds 100° C., a reduction reaction of an electrolyte solution occurs in the negative electrode, which generates heat. After that, when the temperature of the lithium-ion secondary battery reaches approximately 180° C., thermal decomposition of the electrolyte solution occurs, and oxygen release and thermal decomposition occur in the positive electrode, leading to thermal runaway. In some cases, heat generation that is continuously caused melts a separator. When the separator is melted, an internal short circuit is generated in the lithium-ion secondary battery, and Joule heat due to the internal short circuit may cause thermal runaway of the lithium-ion secondary battery.

By the above heat generation, a gas such as hydrogen, carbon monoxide, carbon dioxide, or hydrocarbon is generated from the lithium-ion secondary battery. The gas is a gas generated from an organic solvent used for the electrolyte solution or a thermal decomposition product of the organic solvent and contains a flammable gas, leading to a risk of ignition of the lithium-ion secondary battery.

To inhibit such a thermal runaway reaction, Patent Document 1 proposes a structure in which a nonflammable agent is mixed into a positive electrode mixture or a negative electrode mixture. Furthermore, Patent Document 2 proposes a structure including a container containing a stack in which positive electrodes and negative electrodes are alternately stacked with separators therebetween, an electrolyte solution stored in the container, and a high thermal conductivity gas filling the container.

Various researches and developments have been conducted for the reliability and safety of lithium-ion secondary batteries. For example, Non-Patent Document 1 describes the thermal stability of a positive electrode active material and an electrolyte solution.

### REFERENCES

[Patent Document 1] Japanese Published Patent Application No. 2009-16106
[Patent Document 2] Japanese Published Patent Application No. 2010-262792
[Non-Patent Document 1] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, pp. 68-72.

### SUMMARY OF THE INVENTION

In order to inhibit thermal runaway or ignition of a secondary battery, it is necessary to improve an electrolyte solution. However, the improvement of an electrolyte solution is not examined in Patent Documents 1 and 2. In view of the above, an object of one embodiment of the present invention is to provide an electrolyte solution with high thermal stability in order to inhibit at least ignition or thermal runaway of a secondary battery. Another object of one embodiment of the present invention is to provide an electrolyte solution that is unlikely to cause generation of a gas at a temperature higher than 25° C. in order to inhibit at least ignition or thermal runaway of a secondary battery. Another object of one embodiment of the present invention is to provide a separator with high heat resistance and favorable wettability with an electrolyte solution in order to inhibit at least ignition or thermal runaway of a secondary battery. Another object of one embodiment of the present invention is to provide a secondary battery in which at least ignition or thermal runaway is inhibited.

Note that the description of these objects does not preclude the presence of other objects. In one embodiment of the present invention, there is no need to achieve all the objects. Other objects can be derived from the descriptions of the specification, the drawings, the claims, and the like.

In view of the above problems, one embodiment of the present invention is a secondary battery including a positive electrode, a negative electrode, a separator between the positive electrode and the negative electrode, and an electrolyte solution. The electrolyte solution includes a mixed solvent and a lithium salt. In the electrolyte solution, the concentration of the lithium salt is higher than 1 mol per liter of the mixed solvent. The mixed solvent includes a fluorinated linear carbonate and a fluorinated cyclic carbonate. In a differential scanning calorimetry (DSC) measurement of the electrolyte solution, a peak of heat flow of a heat generation reaction in a range higher than or equal to 180° C. and lower than or equal to 300° is less than or equal to 200 mW/g.

Another embodiment of the present invention is a secondary battery including a positive electrode, a negative electrode, a separator between the positive electrode and the negative electrode, and an electrolyte solution. The electrolyte solution includes a mixed solvent and a lithium salt. In the electrolyte solution, the concentration of the lithium salt is higher than 1 mol per liter of the mixed solvent. The mixed solvent includes a fluorinated linear carbonate and a fluorinated cyclic carbonate. In a DSC measurement of the electrolyte solution, a peak of heat flow of a heat generation reaction in a range higher than or equal to 180° C. and lower than or equal to 300° is less than or equal to 100 mW/g.

Another embodiment of the present invention is a secondary battery including a positive electrode, a negative electrode, a separator between the positive electrode and the negative electrode, and an electrolyte solution. The electrolyte solution includes a mixed solvent and a lithium salt. In the electrolyte solution, a concentration of the lithium salt is higher than 1 mol per liter of the mixed solvent. The mixed solvent includes a fluorinated linear carbonate and a fluorinated cyclic carbonate. In a DSC measurement of the electrolyte solution, a peak of heat flow of a heat generation reaction in a range higher than or equal to 180° C. and lower than or equal to 300° is less than or equal to 200 mW/g. The separator includes an imide compound in a region in contact with the electrolyte solution.

Another embodiment of the present invention is a secondary battery including a positive electrode, a negative electrode, a separator between the positive electrode and the negative electrode, and an electrolyte solution. The electrolyte solution includes a mixed solvent and a lithium salt. In the electrolyte solution, the concentration of the lithium salt is higher than 1 mol per liter of the mixed solvent. The mixed solvent includes a fluorinated linear carbonate and a fluorinated cyclic carbonate. In a DSC measurement of the electrolyte solution, a peak of heat flow of a heat generation reaction in a range higher than or equal to 180° C. and lower than or equal to 300° is less than or equal to 100 mW/g. The separator includes an imide compound in a region in contact with the electrolyte solution.

In the present invention, the lithium salt is preferably one or more of LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₃SO₂)₃, LiN(CF₃SO₂)₂, LiN(C₄F₉SO₂)(CF₃SO₂), and LiN(C₂F₃SO₂)₂.

In the present invention, the fluorinated linear carbonate is preferably fluoroethylene carbonate (FEC).

In the present invention, the cyclic fluoride carbonate is preferably methyl 3,3,3-trifluoropropionate (MTFP).

In the present invention, the imide compound is preferably polyimide.

According to one embodiment of the present invention, an electrolyte solution with high thermal stability can be provided. According to another embodiment of the present invention, an electrolyte solution that is unlikely to cause generation of a gas at a temperature higher than 50° C. can be provided. According to another embodiment of the present invention, a separator with high heat resistance and favorable wettability with an electrolyte solution can be provided. According to another embodiment of the present invention, a secondary battery in which ignition or thermal runaway is inhibited can be provided.

BRIEF DESCRIPTION OF THE DRAWINGS

In the accompanying drawings:

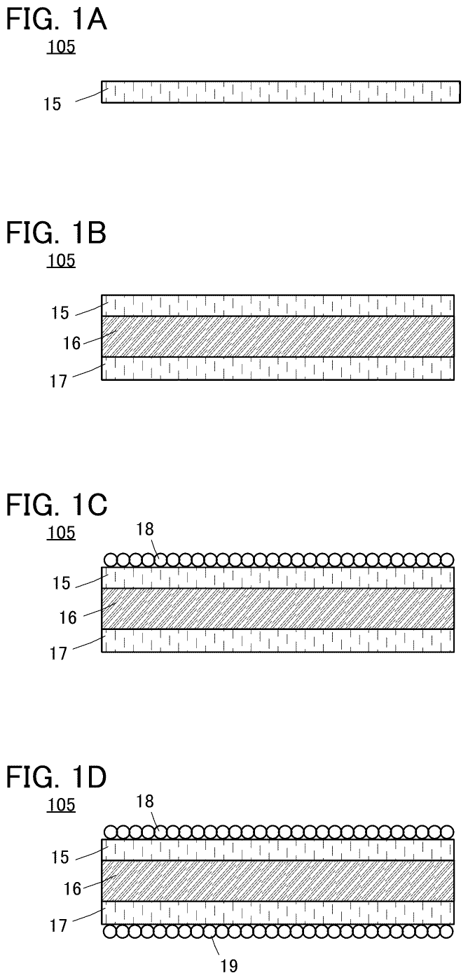

FIGS. 1A to 1D illustrate a separator included in a secondary battery of one embodiment of the present invention;

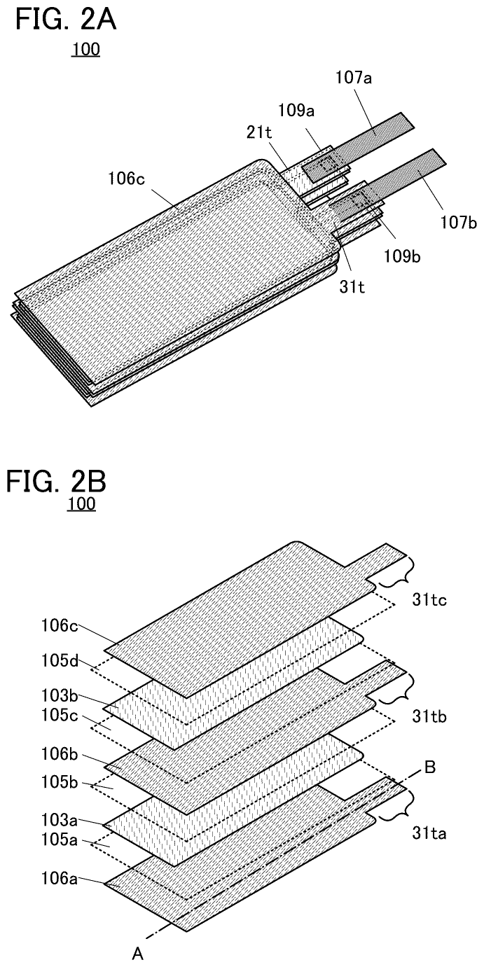

FIGS. 2A and 2B illustrate a secondary battery of one embodiment of the present invention;

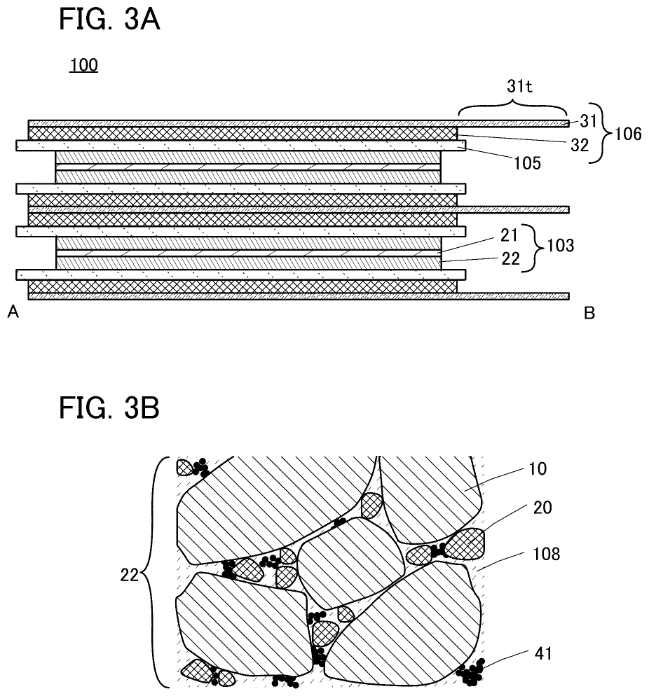

FIG. 3A illustrates a secondary battery of one embodiment of the present invention, and FIG. 3B illustrates a positive electrode active material layer of one embodiment of the present invention;

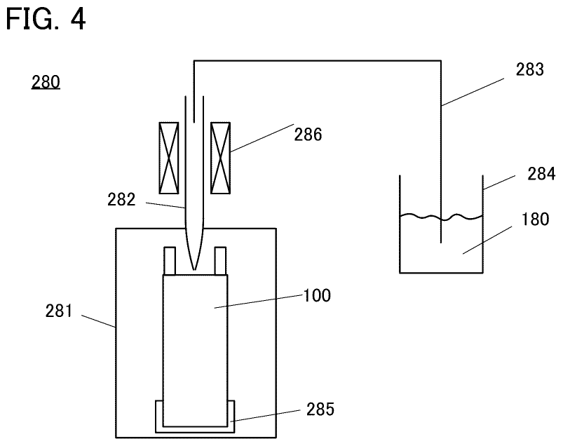

FIG. 4 illustrates an apparatus for injecting an electrolyte solution;

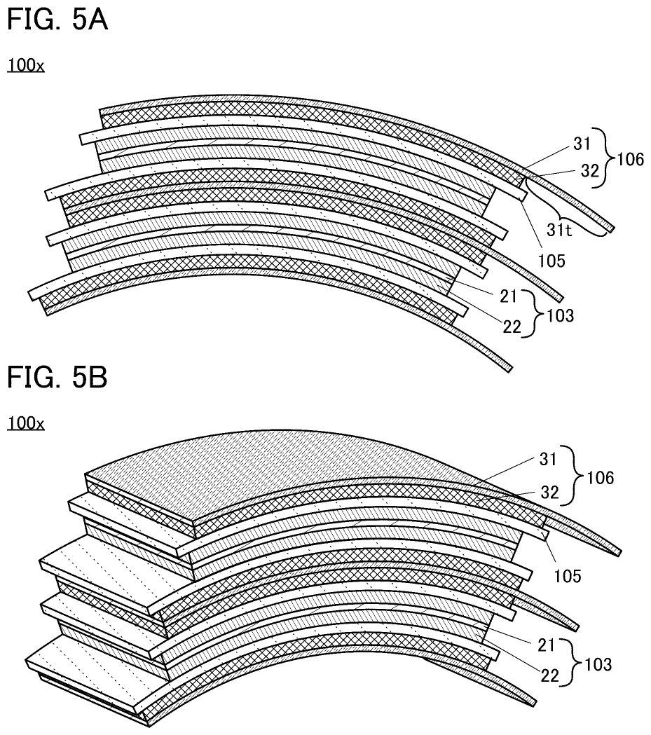

FIGS. 5A and 5B illustrate a bendable secondary battery of one embodiment of the present invention;

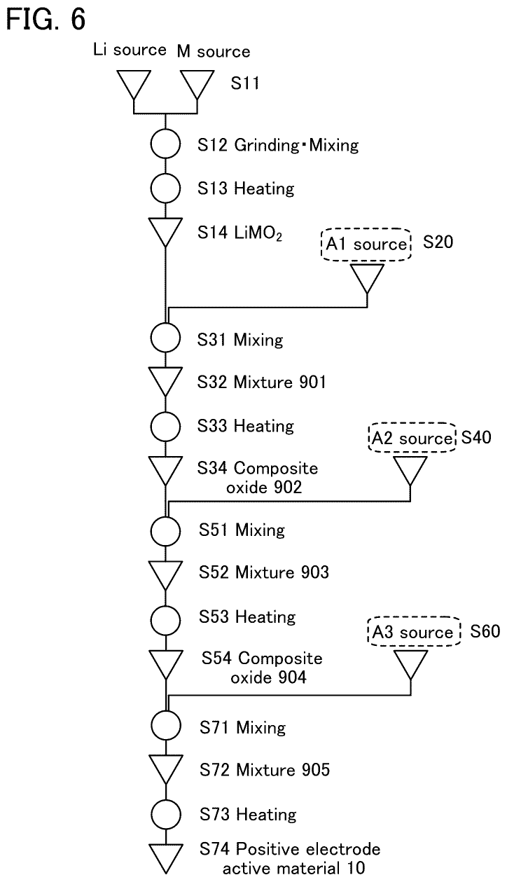

FIG. 6 is a flowchart of a method for forming a positive electrode active material;

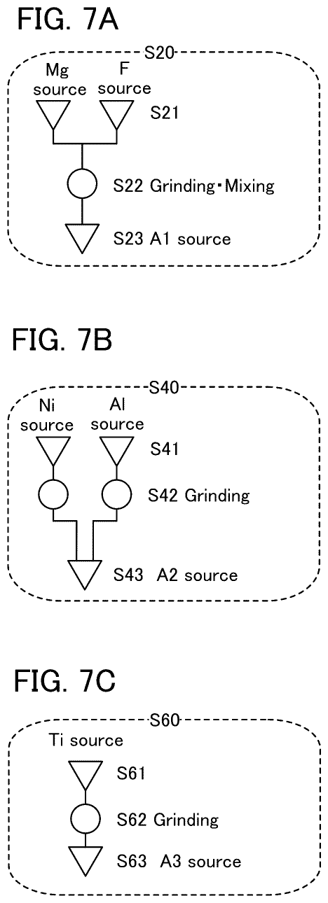

FIGS. 7A to 7C illustrate formation methods of a positive electrode active material;

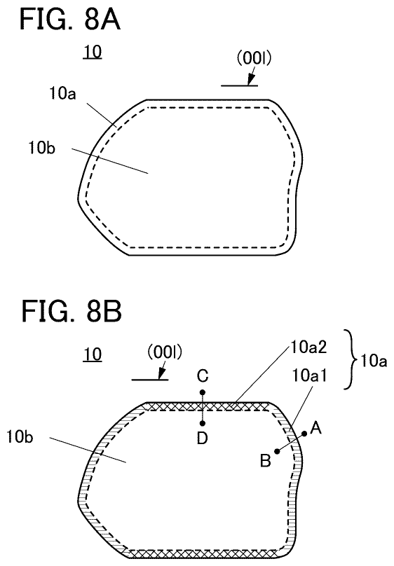

FIGS. 8A and 8B are cross-sectional views illustrating a positive electrode active material;

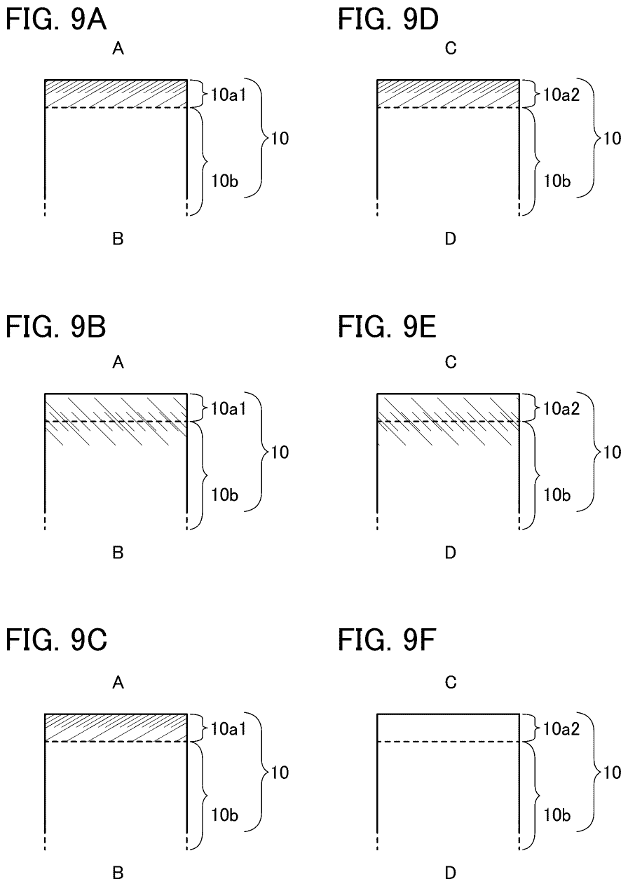

FIGS. 9A to 9F are cross-sectional views illustrating a positive electrode active material;

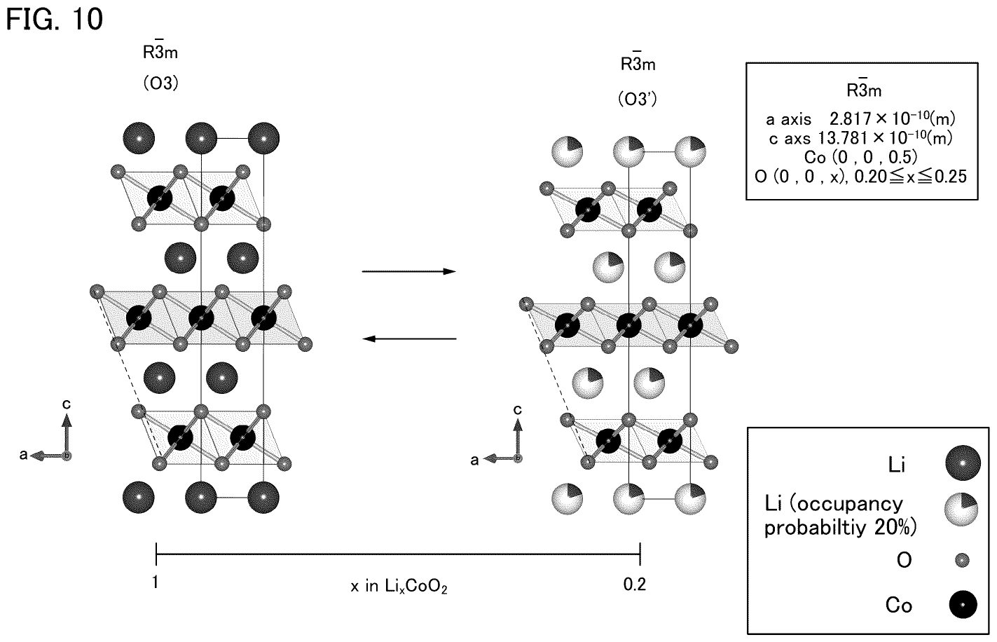

FIG. 10 illustrates crystal structures of a positive electrode active material;

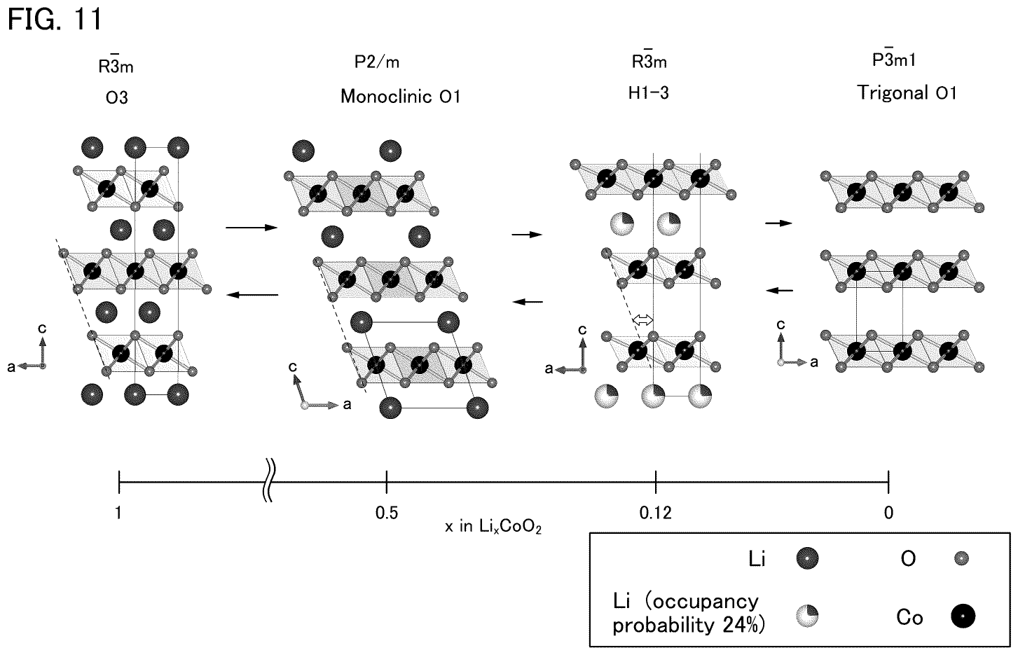

FIG. 11 illustrates crystal structures of a conventional positive electrode active material;

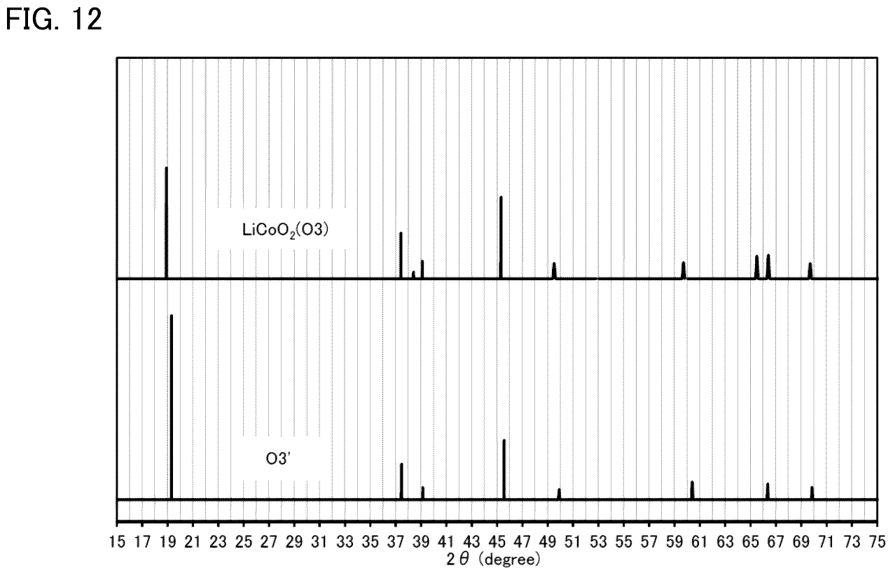

FIG. 12 shows XRD patterns calculated from crystal structures;

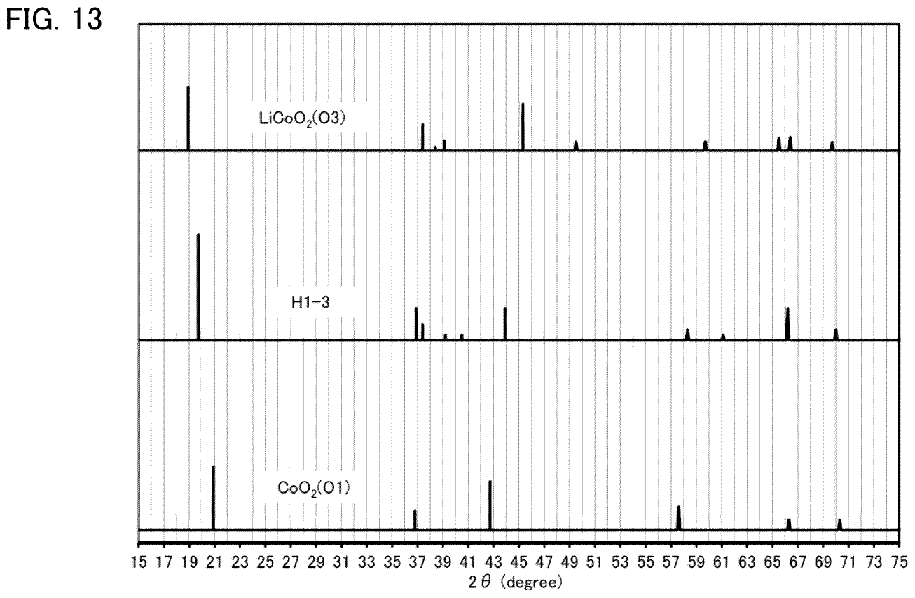

FIG. 13 shows XRD patterns calculated from crystal structures;

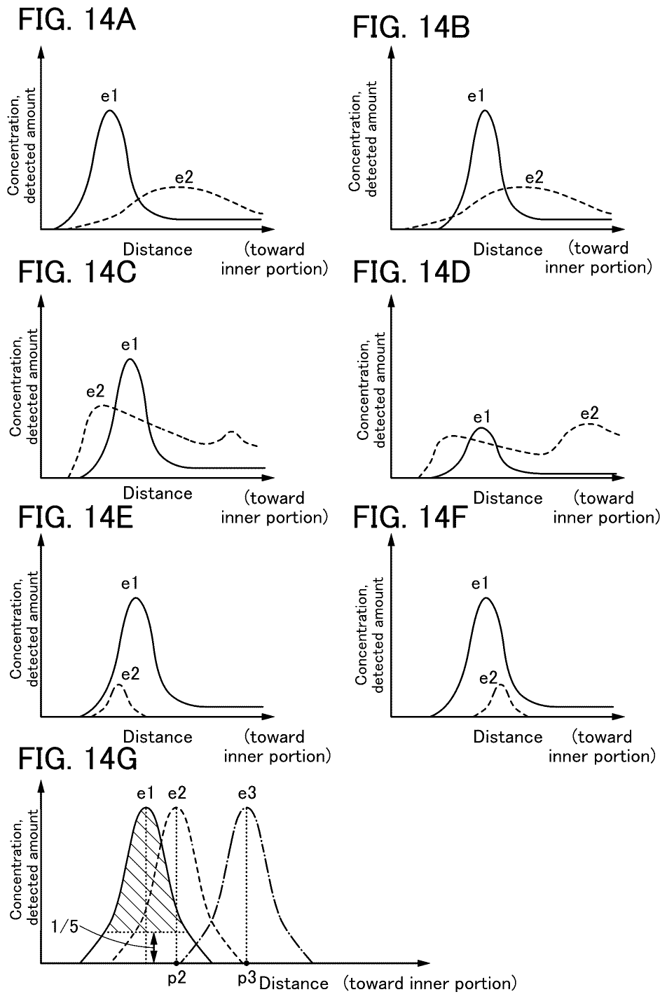

FIGS. 14A to 14G show positional relations of distributions according to EDX line analysis;

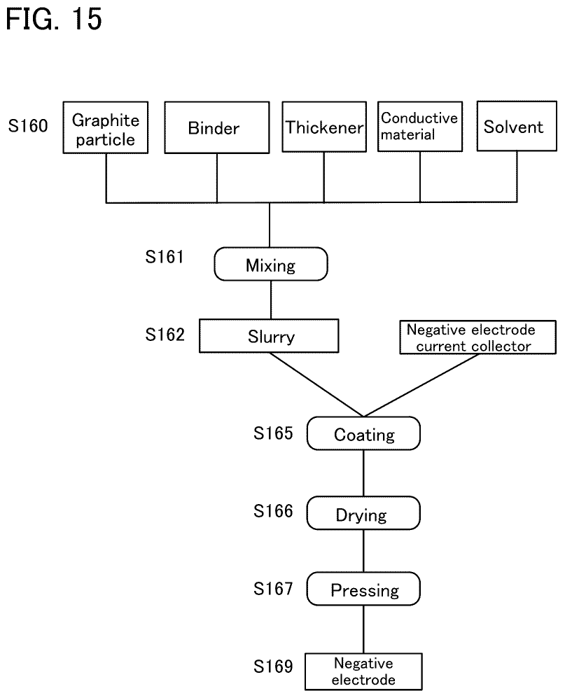

FIG. 15 is a flowchart of a method for forming a negative electrode active material layer;

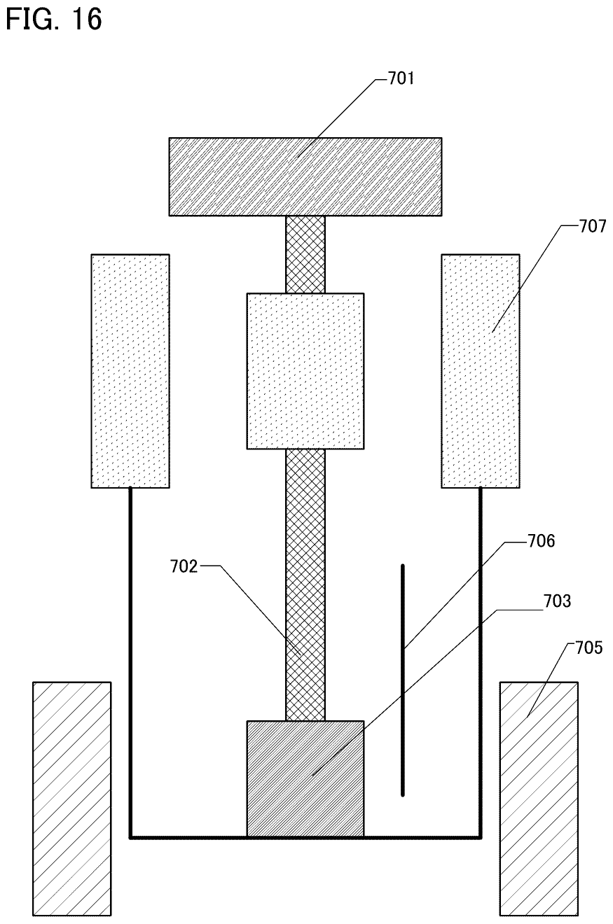

FIG. 16 illustrates a TMA test apparatus;

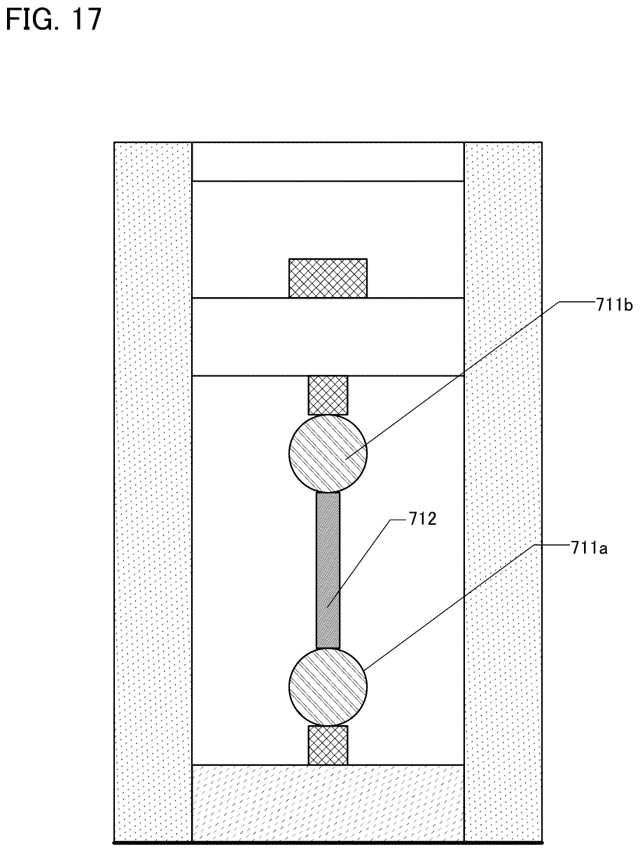

FIG. 17 illustrates a tensile tester;

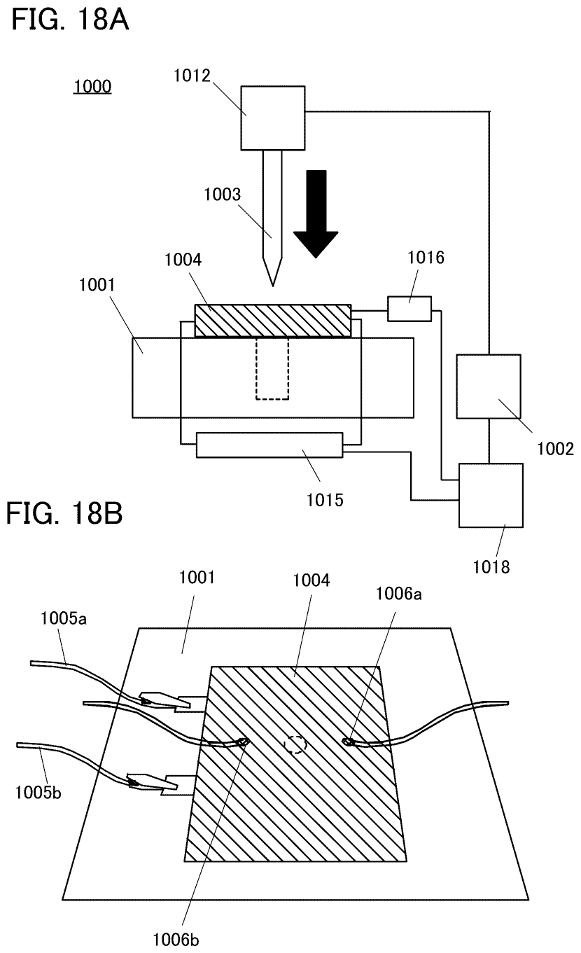

FIGS. 18A and 18B illustrate a nail penetration test;

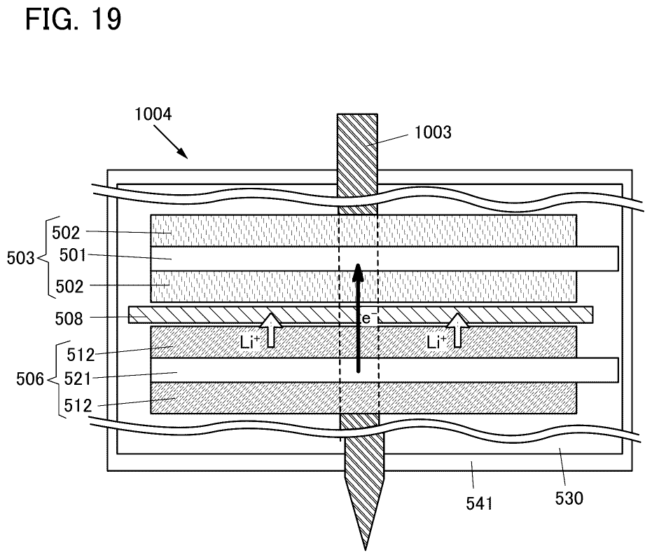

FIG. 19 illustrates a nail penetration movement;

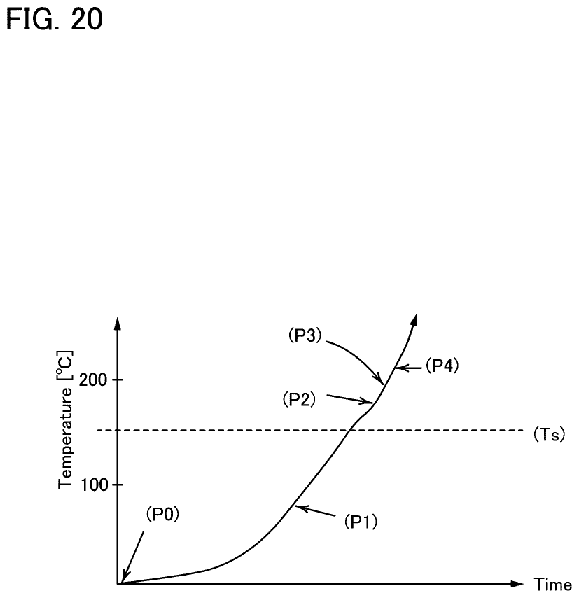

FIG. 20 is a graph showing a change at the time of an internal temperature increase of a secondary battery in which an internal short circuit has occurred;

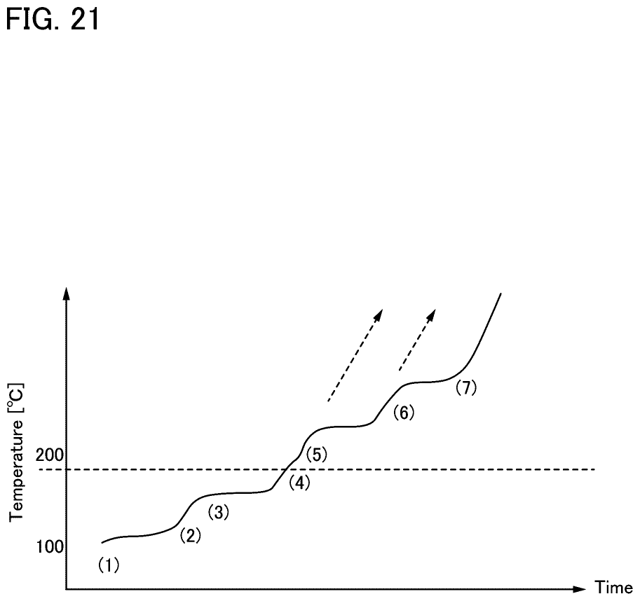

FIG. 21 is a graph showing a change at the time of an internal temperature increase of a secondary battery;

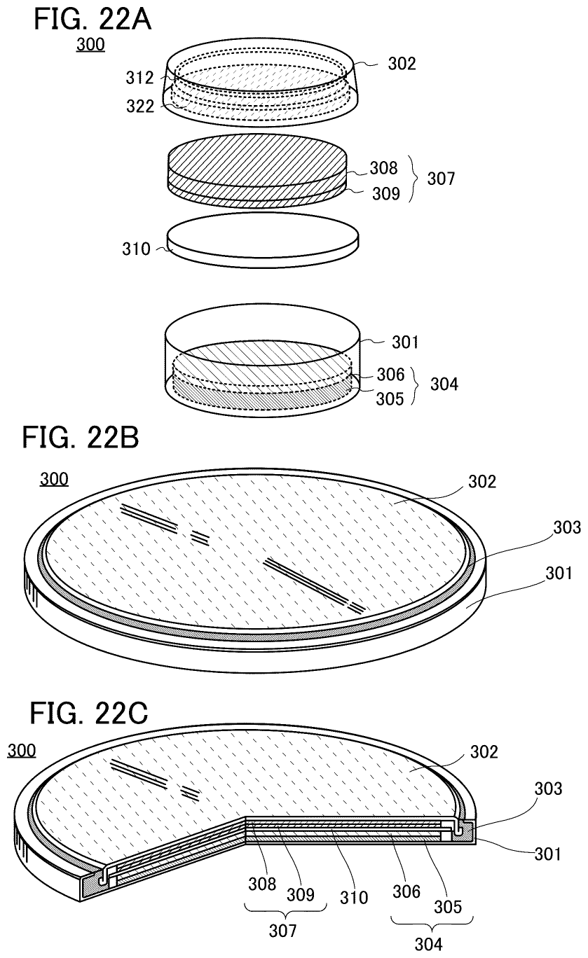

FIG. 22A is an exploded perspective view of a coin-type secondary battery, FIG. 22B is a perspective view of the coin-type secondary battery, and FIG. 22C is a cross-sectional perspective view of the coin-type secondary battery;

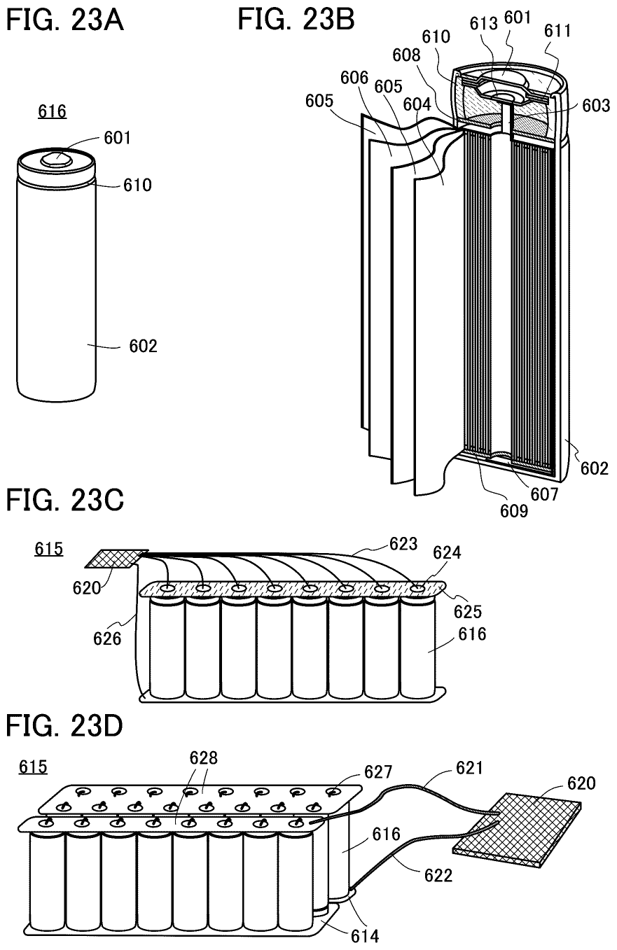

FIG. 23A illustrates an example of a cylindrical secondary battery, FIG. 23B illustrates an example of an internal structure of the cylindrical secondary battery, FIG. 23C illustrates an example of a plurality of cylindrical secondary batteries, and FIG. 23D illustrates an example of a power storage system including the plurality of cylindrical secondary batteries;

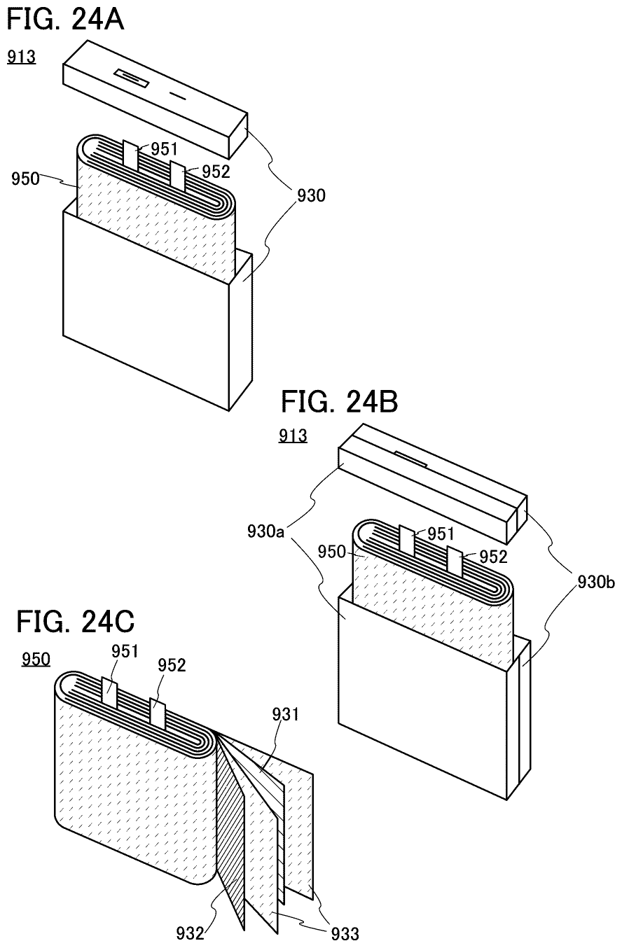

FIGS. 24A and 24B illustrate examples of a secondary battery, and FIG. 24C illustrates an internal state of the secondary battery;

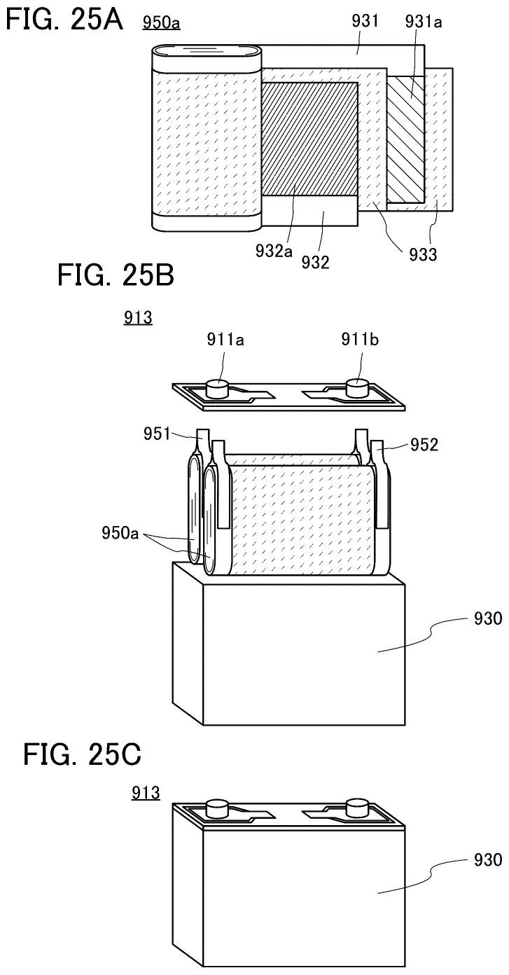

FIGS. 25A to 25C illustrate examples of a secondary battery;

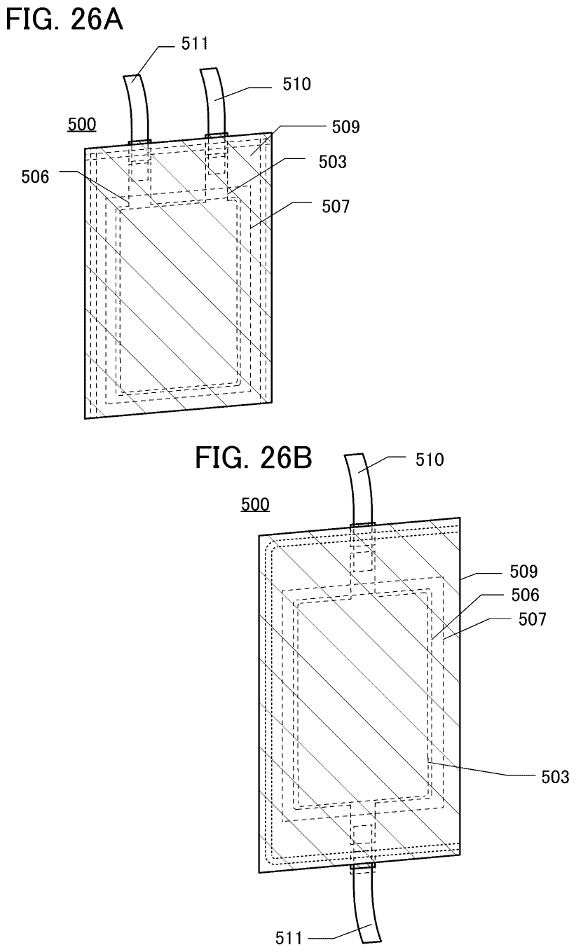

FIGS. 26A and 26B illustrate examples of secondary batteries;

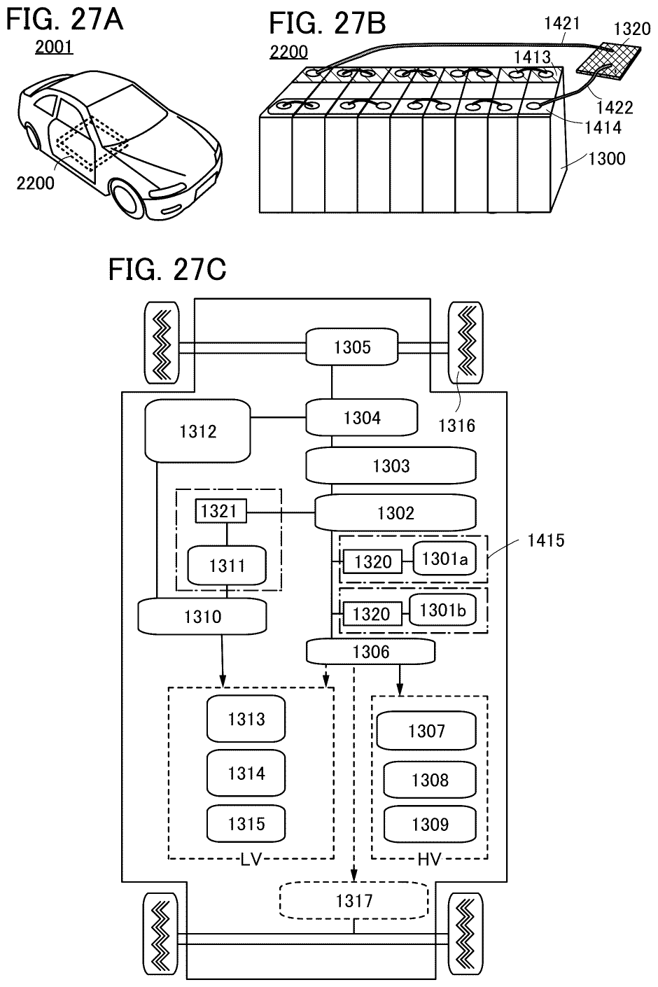

FIG. 27A illustrates a structure example of an automobile, FIG. 27B illustrates a battery pack, and FIG. 27C illustrates an example of a structure including a battery pack in an electric vehicle;

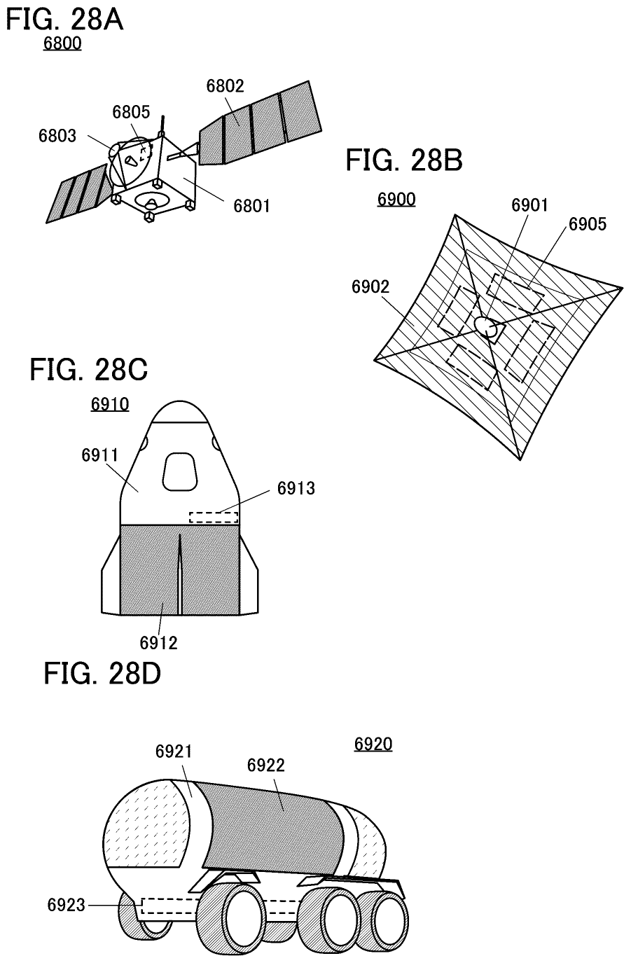

FIGS. 28A to 28D are diagrams each illustrating an example of space equipment;

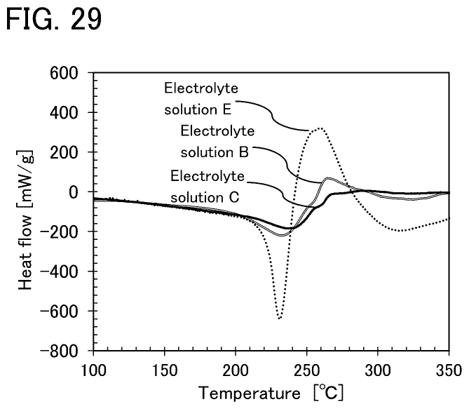

FIG. 29 is a graph showing DSC measurement results of electrolyte solutions;

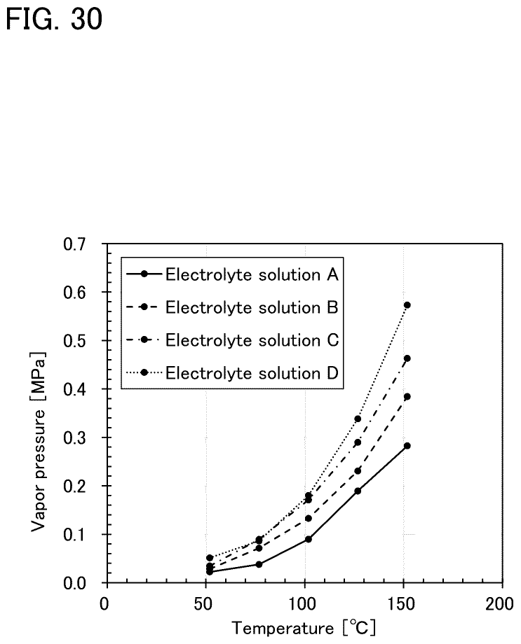

FIG. 30 is a graph showing vapor pressures with respect to temperatures of electrolyte solutions;

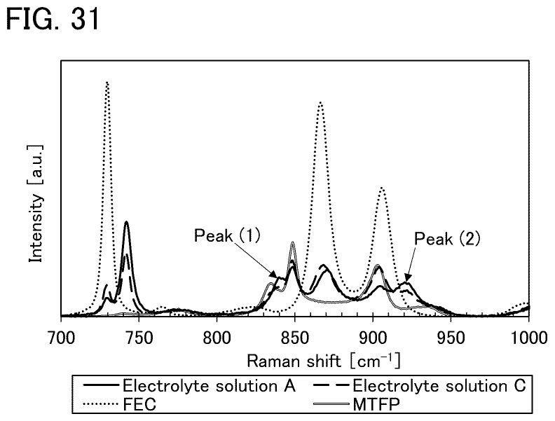

FIG. 31 shows measurement results of Raman spectroscopy analysis of electrolyte solutions;

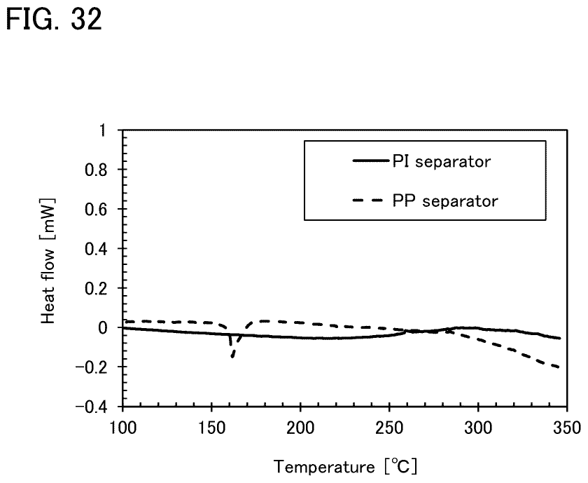

FIG. 32 shows DSC measurement results of separators;

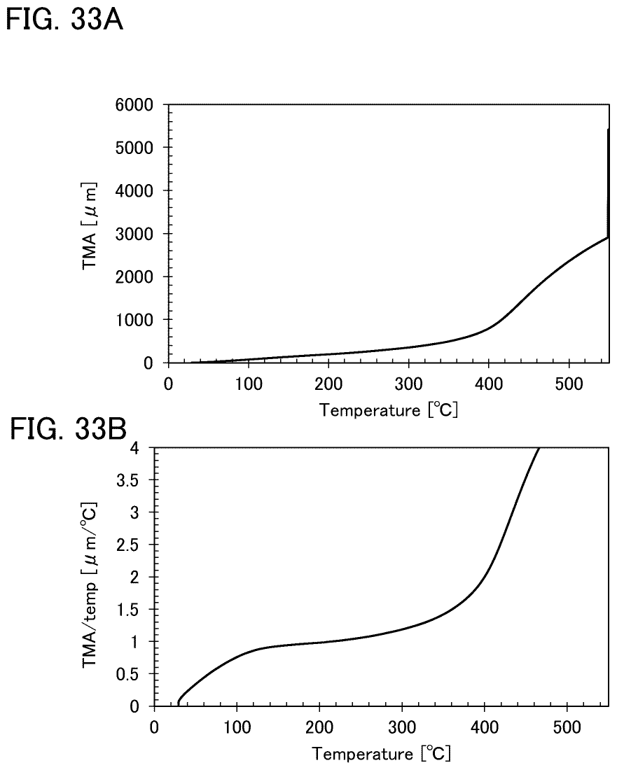

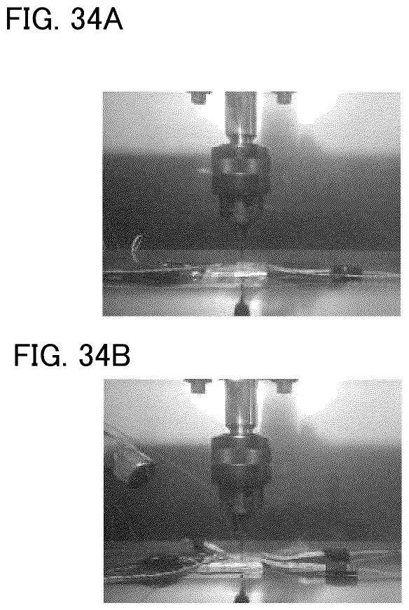

FIGS. 33A and 33B show TMA analysis results of a separator; and FIGS. 34A and 34B are photographs of a nail penetration test.

### DETAILED DESCRIPTION OF THE INVENTION

Embodiments of the present invention will be described in detail with reference to the drawings as appropriate. However, the present invention is not limited to the description below, and it is easily understood by those skilled in the art that modes and details can be modified in various ways without departing from the spirit and scope of the present invention. Therefore, in the embodiments of the present invention described below, reference numerals denoting the same portions are used in common in different drawings.

Ordinal numbers such as “first” and “second” in this specification and the like are used for convenience and do not limit the number or the order of components. The order of components includes, for example, the order of steps or the stacking order of layers. That is, the ordinal numbers used in Embodiments of this specification are not necessarily the same as the ordinal numbers used in the scope of claims in some cases. In addition, the ordinal numbers used in Examples of this specification are not necessarily the same as the ordinal numbers used in the scope of claims in some cases. Furthermore, the ordinal numbers used in Embodiments of this specification are not necessarily the same as the ordinal numbers used in Examples of this specification in some cases.

In this specification and the like, a lithium-ion secondary battery is sometimes called a lithium-ion battery, which means a secondary battery in which lithium ions are used as carrier ions; however, the carrier ions in the present invention are not limited to lithium ions. For example, as the carrier ions in the present invention, alkali metal ions or alkaline earth metal ions can be used, specifically, sodium ions or the like can be used. In that case, the present invention can be understood by replacing lithium ions with sodium ions or the like. In the description of the case where there is no limitation on carrier ions, the term “secondary battery” or “battery” is sometimes used.

In this specification and the like, a positive electrode active material is sometimes referred to as a composite oxide, a positive electrode member, a positive electrode material, a secondary battery positive electrode member, a lithium-ion secondary battery positive electrode member, or the like.

In this specification and the like, an electrolyte solution is referred to as an electrolyte in some cases. The term “electrolyte solution” means that an electrolyte solution has a liquid state at 25° C. In addition, the term “electrolyte” means that the state of an electrolyte at 25° C. is not limited.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, the space group of a positive electrode active material or the like is identified by XRD, electron diffraction, neutron diffraction, or the like. Thus, in this specification and the like, belonging to a space group or being a space group can be rephrased as being identified as a space group.

In this specification and the like, a structure is referred to as a cubic close-packed structure when three layers of anions are shifted and stacked as in ABCABC packing. Accordingly, anions do not necessarily form a cubic lattice structure. Actual crystals naturally have a defect and thus, analysis results may not necessarily agree with the theory. For example, in an electron diffraction pattern or a fast Fourier transform (FFT) pattern of a transmission electron microscope (TEM) image or the like, a spot may appear in a position different from a theoretical position. For example, anions may be regarded as forming a cubic close-packed structure when a difference in orientation from a theoretical position is 5° or less or 2.5° or less.

In this specification and the like, the (001) plane, the (003) plane, and the like are sometimes collectively referred to as a (00l) plane. In this specification and the like, the (00l) plane is sometimes referred to as a C-plane, a basal plane, or the like. In lithium cobalt oxide, lithium diffuses through two-dimensional paths. In other words, the diffusion path of lithium extends along the (00l) plane. In this specification and the like, a plane where a lithium diffusion path is exposed, i.e., a plane where lithium is inserted and extracted (specifically, a plane other than the (00l) plane), is sometimes referred to as an edge plane.

In this specification and the like, the cross-sectional shape of a particle is not limited to a circular cross section, in other words, a particle is not limited to having a spherical shape. Examples of the cross-sectional shape of a particle includes an ellipse, a rectangle, a trapezoid, a triangle, a quadrangle with rounded corners, and an asymmetrical shape. In the case where a plurality of particles are included, the cross-sectional shapes of the particles may be different from each other.

In the specification and the like, in the case where the features of individual particles of a positive electrode active material are described in Embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

In the specification and the like, the particle diameter can be measured with a particle size analyzer (laser diffraction particle size distribution analyzer,) or the like using a laser diffraction and scattering method. In this specification and the like, a median diameter (D50) can be employed as an average particle diameter. D50 is a particle diameter when accumulation of particles accounts for 50% of a cumulative curve in a measurement result of the particle size distribution.

In the specification and the like, the particle size may be calculated by measuring the major axis of the cross section of the particle obtained by analysis with a scanning electron microscope (SEM), a transmission electron microscope (TEM), or the like, instead of using laser diffraction particle size distribution measurement. In this specification and the like, a particle diameter that can be observed in one 100-μm-square cross section of a positive electrode can be used as a maximum particle diameter. In addition, an example of a method for measuring D50 with a SEM, TEM, or the like includes a method in which 20 or more particles are measured to make a cumulative curve and a particle diameter when the accumulation of particles accounts for 50% is set as D50.

In this specification and the like, a theoretical capacity of a positive electrode active material refers to the amount of electricity obtained when all lithium that can be inserted into and extracted from the positive electrode active material is extracted. For example, the theoretical capacity per weight of LiCoO₂ is 274 mAh/g, the theoretical capacity per weight of LiNiO₂ is 275 mAh/g, and the theoretical capacity per weight of LiMn₂O₄ is 148 mAh/g.

In this specification and the like, the remaining amount of lithium that can be inserted into and extracted from a positive electrode active material is represented by x in a compositional formula, e.g., LiₓMO₂. Note that M represents a transition metal and is cobalt and/or nickel unless otherwise specified in this specification and the like. In the case of a positive electrode active material in a lithium-ion secondary battery, x can be represented by (theoretical capacity−charge capacity)/theoretical capacity. For example, when a lithium-ion secondary battery that includes a positive electrode active material containing lithium cobalt oxide is charged to 219.2 mAh/g, the positive electrode active material can be expressed by Li_{0.2}CoO₂, or x=0.2. Note that “x in LiₓMO₂ is small” means, for example, 0.1<x≤0.24.

In this specification and the like, lithium cobalt oxide to be used for a positive electrode, which has been appropriately synthesized and almost satisfies the stoichiometric proportion, is LiCoO₂ with x of 1. Also in a secondary battery after its discharging ends, lithium cobalt oxide therein can be LiCoO₂ with x of 1. Here, “state where discharging ends (discharged state)” means that the voltage becomes 3.0 V or lower or 2.5 V or lower at a current of 100 mA/g or lower, for example.

In this specification and the like, charge capacity and/or discharge capacity used for calculation of x in LiₓMO₂ are/is preferably measured under the conditions where there is no influence or small influence of a short circuit and/or thermal decomposition of an electrolyte solution. For example, data of a secondary battery containing a sudden capacity change that seems to result from a short circuit should not be used for calculation of x.

In this specification and the like, the distribution of an element indicates the region where the element is continuously detected by an analysis method to the extent that the detection value is no longer on the noise level. The region where the element is continuously detected to the extent that the detection value is no longer on the noise level can also be referred to as a region where the element is detected in a range not less than the lower detection limit.

In this specification and the like, the description is made on the assumption that materials (such as a positive electrode active material, a negative electrode active material, an electrolyte solution, and a separator) of a secondary battery have not been degraded unless otherwise specified. A decrease in discharge capacity due to aging treatment and burn-in treatment during the manufacturing process of a secondary battery is not regarded as degradation. For example, a state where discharge capacity is higher than or equal to 97% of the rated capacity of a secondary battery composed of a cell or an assembled battery can be regarded as a non-degraded state. The rated capacity conforms to Japanese Industrial Standards (JIS C 8711:2019) in the case of a secondary battery for a portable device. The rated capacities of other secondary batteries conform to JIS described above, JIS for electric vehicle propulsion, industrial use, and the like, standards defined by the International Electrotechnical Commission (IEC), or the like.

In this specification and the like, a secondary particle refers to a particle formed by aggregation of primary particles. In this specification and the like, a primary particle refers to a particle whose appearance shows no grain boundary. In this specification and the like, a primary particle is referred to as a single particle in some cases. In this specification and the like, a grain boundary may refer to an interface between two crystal grains being contact with each other.

Here, the flow of electrons and the flow of lithium ions in a secondary battery during charging are described. When a charger is connected to start charging of a secondary battery, an oxidation reaction occurs due to electron release in a positive electrode, and a reduction reaction occurs due to electron supply in a negative electrode. Then, lithium ions are released from the positive electrode to an electrolyte solution, and the lithium ions move to the negative electrode. At the time of discharging, a reduction reaction occurs in the positive electrode, and an oxidation reaction occurs in the negative electrode. In other words, in the secondary battery, an anode and a cathode change places with each other in discharging and charging, and an oxidation reaction and a reduction reaction occur on the corresponding sides; hence, an electrode with a high reaction potential is called a positive electrode and an electrode with a low reaction potential is called a negative electrode. For this reason, in this specification and the like, the positive electrode is referred to as a “positive electrode” or a “plus electrode” and the negative electrode is referred to as a “negative electrode” or “minus electrode” in all the cases where charging is performed and discharging is performed.

In this specification and the like, a full cell means a battery cell assembled using different electrodes, as in a unit cell including a positive electrode and a negative electrode. In this specification and the like, a half cell means a battery cell assembled using a lithium metal for a negative electrode (a counter electrode).

In this specification and the like, unless otherwise specified, a charge voltage is represented with reference to the potential of a lithium metal. In this specification and the like, the “high charge voltage” is a charge voltage, for example, higher than or equal to 4.6 V, preferably higher than or equal to 4.65 V, further preferably higher than or equal to 4.7 V, still further preferably higher than or equal to 4.75 V, or most preferably higher than or equal to 4.8 V. That is, in the case of a half cell in which a lithium metal is used as a counter electrode, a charge voltage higher than or equal to 4.6 V is referred to as a high charge voltage.

In this specification and the like, a high charge voltage is a charge voltage higher than or equal to 4.5 V with reference to a potential at the time when a carbon material (e.g., graphite) is used for a negative electrode. That is, in a full cell where a carbon material (e.g., graphite) is used for a negative electrode, a charge voltage higher than or equal to 4.5 V is referred to as a high charge voltage.

In this specification and the like, a “carbonate” refers to a compound containing at least one carbonic ester in its molecular structure and includes a cyclic carbonate and a linear carbonate in its category unless otherwise specified. The term “linear” carbonate includes both “straight-chain” and “branched-chain” carbonate.

In this specification and the like, a mixed solvent refers to a mixture of two or more kinds of solvents.

In this specification and the like, a porosity (also referred to as void fraction) can be a value calculated from volume, density, and mass. In this specification and the like, the porosity can also be obtained in the following manner: a void contained in an object is filled with an organic material and then the object is processed into a thin-film shape; after that, the object processed into the thin-film shape is observed and the porosity can be obtained from the observation image. A focused ion beam (FIB) or ion milling can be used for the processing.

In this specification and the like, flexibility refers to a property of an object being flexible and being transformable. In this specification, the expression “an object has flexibility” means that at least part of the object has flexibility. That is, the flexible object may include a portion that is not flexible (also referred to as a hard portion).

In this specification and the like, a secondary battery whose shape can be changed along with a transformable electronic device is referred to as a transformable secondary battery, a secondary battery having flexibility, or a flexible battery. In this specification and the like, the term “transformable” means a change of the shape of an object and includes a change of the shape of the object in accordance with external force applied to the object. In this specification and the like, the change of the shape of an object in accordance with external force refers to a change of the shape of an object by hands of an average adult person without requiring excessive force.

In this specification and the like, a changed shape of an object by external force includes a bent shape of an object by external force. In this specification and the like, a secondary battery that can be bent along with a bendable electronic device is referred to as a secondary battery that can be bent, a foldable battery, a bendable battery, or the like. The shape of a foldable battery changed by external force include a folded shape.

In this specification and the like, a bendable electronic device, a bendable secondary battery, and the like can have a bent and fixed state, and also have a mode in which bending and stretching are repeated. In this specification and the like, the mode in which bending and stretching are repeated includes a repetition mode of a bent state and a state before the bent state. In this specification and the like, the state before the bent state includes a flat state, for example.

In this specification and the like, ignition in a nail penetration test refers to a state where fire is observed outside an exterior body within one minute after a nail penetrates into a cell or a state where thermal runaway of a secondary battery has occurred within one minute after a nail penetrates into a cell. For example, a state where a pyrolysate(s) of a positive electrode and/or a negative electrode is observed at a position 2 cm or more away from a penetration point after a nail penetration test is finished is referred to as a state where thermal runaway has occurred. The case where smoke is caused but no fire is observed at the time of nail penetration is regarded as non-ignition.

In this specification and the like, the expression “including A and/or B” means “including A,” “including B,” and “including A and B.”

### Embodiment 1

A secondary battery of one embodiment of the present invention includes an electrolyte solution, and the electrolyte solution contains at least a solvent and a lithium salt.

[Solvent]

The solvent contained in the electrolyte solution of one embodiment of the present invention is described. The electrolyte solution preferably contains a mixed solvent as the solvent. As the mixed solvent, a mixture containing a fluorinated cyclic carbonate and a fluorinated linear carbonate is preferably used. In this specification and the like, a mixed solvent of a fluorinated cyclic carbonate and a fluorinated linear carbonate is sometimes referred to as a fluoride mixed solvent. Although each of the fluorinated cyclic carbonate and the fluorinated linear carbonate includes a substituent with an electron-withdrawing property and tends to have a low solvation energy of lithium ions serving as carrier ions, each of the fluorinated cyclic carbonate and the fluorinated linear carbonate can solvate lithium ions in a secondary battery and is preferable as the mixed solvent.

The fluoride mixed solvent has a low viscosity at room temperature (e.g., 25° C.), and thus is preferable as the electrolyte solution. In particular, a fluorinated linear carbonate is expected to have a low viscosity at a low temperature (e.g., 0° C.); thus, a mixed solvent including a fluorinated linear carbonate is suitable for use of the secondary battery at low temperatures (including temperatures below freezing).

An electrolyte solution containing a fluoride mixed solvent is preferably used, in which case a heat generation reaction can be inhibited. For the heat generation reaction, heat flow obtained by a differential scanning calorimeter (DSC) measurement can be used as a reference. Inhibiting the heat generation reaction includes lowering a peak of the amount of heat generation (heat flow). Inhibiting the heat generation reaction also includes making the start temperature of the heat generation reaction higher. In a secondary battery including a fluoride mixed solvent as an electrolyte solution, a heat generation reaction is inhibited even when the internal temperature of the secondary battery rises owing to an internal short circuit; thus, thermal runaway and/or ignition of the secondary battery can be prevented.

Since the fluoride mixed solvent has a low vapor pressure at a temperature higher than 50° C., vaporization at the temperature can be inhibited. Accordingly, in a secondary battery including a fluoride mixed solvent as an electrolyte solution, generation of a flammable gas from the electrolyte solution is inhibited even when the internal temperature of the secondary battery rises owing to an internal short circuit; thus, thermal runaway and/or ignition of the secondary battery can be prevented.

As the fluorinated cyclic carbonate, fluoroethylene carbonate (FEC or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and has a low solvation energy of lithium ions; thus, the fluorinated cyclic carbonates are each preferable as the mixed solvent.

The structural formula of FEC is represented by Structural Formula (H10) below. The substituent with an electron-withdrawing property in FEC is an F group.

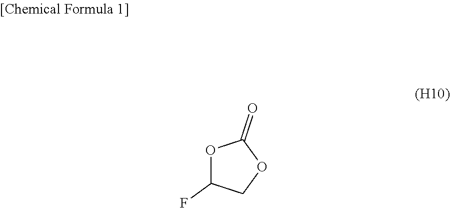

An example of the fluorinated linear carbonate is methyl 3,3,3-trifluoropropionate. The abbreviation of methyl 3,3,3-trifluoropropionate is MTFP. The structural formula of MTFP is represented by Structural Formula (H22) below. The substituent with an electron-withdrawing property in MTFP is a CF₃ group.

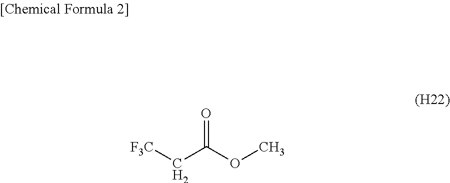

An example of the fluorinated linear carbonate is trifluoromethyl 3,3,3-trifluoropropionate. The structural formula of trifluoromethyl 3,3,3-trifluoropropionate is represented by Structural Formula (H23) below. In trifluoromethyl 3,3,3-trifluoropropionate, the substituent with an electron-withdrawing property is a CF₃ group.

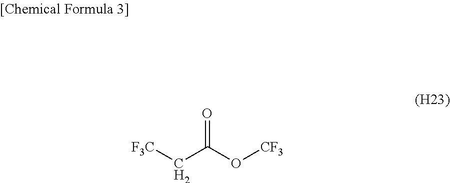 [SMILES: O=C(CC(F)(F)F)OC(F)(F)F]

An example of the fluorinated linear carbonate is trifluoromethyl propionate. The structural formula of trifluoromethyl propionate is represented by Structural Formula (H24) below. In trifluoromethyl propionate, the substituent with an electron-withdrawing property is a CF₃ group.

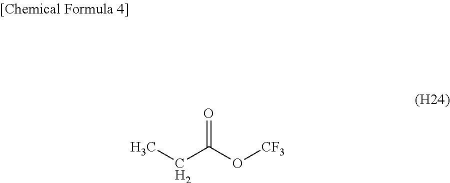

An example of the fluorinated linear carbonate is methyl 2,2-difluoropropionate. The structural formula of methyl 2,2-difluoropropionate is represented by Structural Formula (H25) below. In methyl 2,2-difluoropropionate, the substituent with an electron-withdrawing property is a CF₂ group.

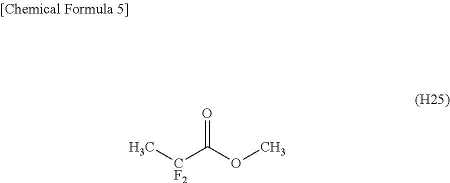

An example of the fluorinated linear carbonate is methyl 2,2,2-trifluoroethyl carbonate. The structural formula of methyl 2,2,2-trifluoroethyl carbonate is represented by Structural Formula (H26) below. In methyl 2,2,2-trifluoroethyl carbonate, the substituent with an electron-withdrawing property is a CF₃ group.

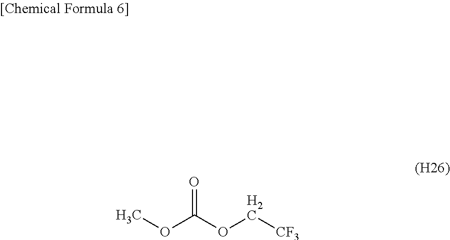

The organic solvent of one embodiment of the present invention preferably includes one or more of the above-described fluorinated cyclic carbonates and one or more of the above-described fluorinated linear carbonates. For example, the mixed solvent further preferably includes FEC and MTFP for the following reasons described below.

### [FEC and MTFP]

FEC, which is one of fluorinated cyclic carbonates, has a high dielectric constant and thus has an effect of promoting dissociation of a lithium salt when used in an electrolyte solution. Furthermore, it can be said that since FEC includes fluorine having an electron-withdrawing property as a substituent, a lithium ion is desolvated with FEC more easily than with ethylene carbonate (EC) not including a substituent having an electron-withdrawing property. Specifically, FEC has lower solvation energy of lithium ions than ethylene carbonate (EC). Thus, FEC is preferably used, in which case lithium ions are likely to be released from surfaces of a positive electrode active material and a negative electrode active material, which can reduce an internal resistance of a secondary battery.

In addition, FEC is preferable because FEC has a deep highest occupied molecular orbital (HOMO) level and is thus not easily oxidized and has high oxidation resistance. On the other hand, a concern of FEC is high viscosity. In view of this, a mixed solvent obtained by adding MTFP to FEC is preferably used as an electrolyte solution. MTFP is one of linear carbonates and can reduce the viscosity of an electrolyte solution. Specifically, MTFP can maintain its low viscosity even at low temperatures (e.g., 0° C.). In general, solvation is not caused when the solvation energy is low; however, MTFP has different solvation energies depending on the molecular arrangement; thus, solvation with a lithium ion is sometimes caused in the case where the solvation energy is high, for example. That is, FEC and MTFP can each solvate lithium ions, which is preferable.

The following table lists the HOMO levels, solvation energy, and boiling points of FEC, MTFP, EC, and MP. The HOMO levels and the solvation energy are obtained by quantum chemical calculation, and in the following table, higher solvation energy means that solvation is caused more easily.

TABLE 1

| Name of organic | | | | |
|---|---|---|---|---|
| compound (abbreviation) | FEC | MTFP | EC | MP |
| Structural formula | 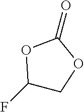 | 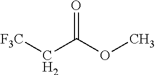 (H22) | 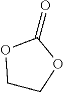 | 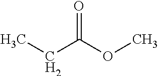 |
| | (H10) | | | |
| HOMO level [eV] | −8.71 | −8.15 | −8.23 | −7.56 |
| Solvation energy [eV] | 5.39 | 4.33 to 5.38 | 5.79 | 4.45 to 5.22 |
| Boiling point [° C.] | 210 | 96 | 238 | 80 |

The mixed solvent used for the electrolyte solution is preferably prepared to contain a higher proportion of a fluorinated linear carbonate than a fluorinated cyclic carbonate. For example, when the total content of the mixed solvent is 100 vol %, the volume ratio (vol %) of FEC, which is a fluorinated cyclic carbonate, to MTFP, which is a fluorinated linear carbonate, is preferably x:100−x (where 5≤x≤30, preferably 10≤x≤20). An electrolyte solution containing MTFP at a higher proportion than FEC in this manner is preferable because the viscosity of the electrolyte solution can be reduced.

It is preferable that peaks attributed to impurities in the solvents included in the mixed solvent be hardly observed by nuclear molecular resonance (NMR) measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002.

For example, in the case of MTFP, it is known that when ¹H-NMR measurement is performed using an acetonitrile-d₃ solvent, four peaks are generated in the 6 range of 3.29 ppm to 3.43 ppm, inclusive. However, when another peak appears in the vicinity of the peaks, for example, in the 6 range of from 3.24 ppm to 3.29 ppm, inclusive, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

An apparatus used for the NMR measurement is not particularly limited, and for example, Bruker AVANCE III 400 can be used. Among the five peaks of acetonitrile derived from acetonitrile-d₃ used in a diluted solvent in the ¹H-NMR measurement, the center peak can be 1.94 ppm.

Preferably, the mixed solvent has a low content of water (H₂O) or moisture and is highly purified. Specifically, the content of the water (H₂O) or moisture contained in the mixed solvent is less than or equal to 100 ppm, preferably less than or equal to 50 ppm, further preferably less than 10 ppm. For example, moisture can be measured by Karl Fischer titration.

[Solvent that can be Added]

Another solvent may be added to the above-described mixed solvent. As another organic solvent that can be added to the mixed solvent, for example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate (MP), ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used.

### [Lithium Salt]

Next, a lithium salt is described. As the lithium salt, for example, one or more of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₃SO₂)₃, LiN(CF₃SO₂)₂, LiN(C₄F₉SO₂)(CF₃SO₂), and LiN(C₂F5SO₂)₂, can be used in an appropriate combination and in an appropriate ratio. For example, when LiPF₆ and LiBF₄, which are fluorides, are used, LiPF₆ and LiBF₄ are preferably combined as lithium salts to improve the safety of a lithium-ion secondary battery. Note that the concentration of a lithium salt in the electrolyte solution is preferably higher than 1 mol and lower than or equal to 3.0 mol, further preferably higher than 1 mol and lower than or equal to 2.0 mol per liter of a mixed solvent. The expression “per liter of a mixed solvent” means per liter of the total amount of the mixed solvent.

For example, a fluoride mixed solvent in which a lithium salt is dissolved at higher than 1 mol and lower than or equal to 3.0 mol per liter of the fluoride mixed solvent, preferably higher than 1 mol and lower than or equal to 2.0 mol per liter of the fluoride mixed solvent is used as an electrolyte solution, in which case thermal runaway and/or ignition of a secondary battery can be prevented even when the internal temperature of the secondary battery rises owing to an internal short circuit. This is because a fluoride mixed solvent in which a lithium salt is dissolved at higher than 1 mol and lower than or equal to 3.0 mol per liter of the fluoride mixed solvent, preferably higher than 1 mol and lower than or equal to 2.0 mol per liter of the fluoride mixed solvent can serve as an electrolyte solution having high thermal stability. Furthermore, a fluoride mixed solvent in which a lithium salt is dissolved at higher than 1 mol and lower than or equal to 3.0 mol per liter of the fluoride mixed solvent, preferably higher than 1 mol and lower than or equal to 2.0 mol per liter of the fluoride mixed solvent can serve as an electrolyte solution having a lower vapor pressure at a temperature higher than 50° C. than that of an electrolyte solution in which a lithium salt is dissolved at 1 mol or lower per liter of the fluoride mixed solvent. Therefore, even in the case where the internal temperature of the secondary battery rises and exceeds 50° C. because of an internal short circuit, generation of a gas can be inhibited.

### [DSC Measurement]

In the electrolyte solution used for the secondary battery of one embodiment of the present invention, a peak of heat flow (the amount of heat generation) in the range higher than or equal to 180° C. and lower than or equal to 300° is preferably less than or equal to 200 mW/g, further preferably less than or equal to 100 mW/g. In the case where two or more peaks are observed in the above temperature range, the maximum peak is preferably less than or equal to 200 mW/g, further preferably less than or equal to 100 mW/g. In the case where two or more peaks are observed in the above temperature range, it is further preferable that all the peaks be less than or equal to 200 mW/g, further preferably less than or equal to 100 mW/g. Unexpectedly, the heat flow (the amount of heat generation) obtained by the DSC measurement does not depend on the concentration of the lithium salt, and there is not a large difference depending on the concentration of the lithium salt. That is, the use of the fluoride mixed solvent enables the peak of heat flow (the amount of heat generation) to be less than or equal to 200 mW/g, preferably less than or equal to 100 mW/g in the range higher than or equal to 180° C. and lower than or equal to 300°. For the value of heat flow, the description of Examples below can be referred to. In a secondary battery including such a fluoride mixed solvent as an electrolyte solution, a heat generation reaction is inhibited even when the internal temperature of the secondary battery rises owing to an internal short circuit; thus, thermal runaway and/or ignition of the secondary battery can be prevented.

Although the apparatus and conditions of the DSC measurement are not particularly limited, the apparatus and conditions described below are preferably employed in this embodiment.
DSC apparatus: Rigaku EVO2 DSC8271
Temperature rising rate: 5° C./min to 10° C./min, both inclusive
Temperature range: room temperature (25° C.) to 500° C., both inclusive

The obtained measurement results are subjected to background correction using analysis software Thermo plus EVO. Heat Flow means heat flow per weight of a sample.

### [Combustion Test]

Nonflammability and thermal stability are preferably confirmed by a combustion test, and the combustion test is not contradictory to DSC measurement. The electrolyte solution used in the secondary battery of one embodiment of the present invention is preferably nonflammable.

### [Vapor Pressure]

The vapor pressure is a value depending on temperature, and the vapor pressure of the electrolyte solution also depends on the concentration of a lithium salt, unexpectedly. The vapor pressure of the electrolyte solution used in the secondary battery of one embodiment of the present invention at 50° C. can be lower than or equal to 0.03 MPa when the concentration of a lithium salt is higher than 1.0 mol per liter of a fluoride mixed solvent. When the concentration of a lithium salt is higher than 1.0 mol per liter of a fluoride mixed solvent, the vapor pressure of the electrolyte solution at 75° C. can be lower than or equal to 0.08 MPa. When the concentration of a lithium salt is higher than 1.0 mol per liter of a fluoride mixed solvent, the vapor pressure of the electrolyte solution at 100° C. can be lower than or equal to 0.2 MPa. When the concentration of a lithium salt is higher than 1.0 mol per liter of a fluoride mixed solvent, the vapor pressure of the electrolyte solution at 125° C. can be lower than or equal to 0.3 MPa. When the concentration of a lithium salt is higher than 1.0 mol per liter of a fluoride mixed solvent, the vapor pressure of the electrolyte solution at 150° C. can be lower than or equal to 0.4 MPa. For the value of the vapor pressure, the description of Examples below can be referred to.

### [Additive Agent]

The electrolyte solution included in the secondary battery of one embodiment of the present invention may contain an additive agent as long as it has the above-described structure. The additive agent is described. As the additive agent, any of the organic materials listed as the above mixed solvent can be used. As other organic materials that can be used as the additive agent, one or more selected from vinylene carbonate (VC), propane sultone (PS), tert-butylbenzene (TBB), lithium bis(oxalate)borate (LiBOB), and a dinitrile compound such as succinonitrile or adiponitrile are preferably contained. The concentration of the additive agent is preferably higher than or equal to 0.1 wt % and lower than or equal to 10 wt % with respect to the sum (total weight) of the mixed solvent and the lithium salt. FEC, VC, and LiBOB are preferable as the additive agents because they easily form a favorable coating portion. Note that in the case where FEC is contained as the fluoride mixed solvent, FEC does not need to be contained as the additive agent.

Among the above-described additive agents, 1,3-propane sultone (PS) has HOMO and LUMO levels equivalent to those of ethylene carbonate (EC) and diethyl carbonate (DEC); thus, 1,3-propane sultone (PS) is less likely to be oxidized and reduced even when a high cutoff voltage is employed as charge and discharge conditions. Moreover, PS is likely to be a polymer when decomposed on a surface of a positive electrode active material, and thus has an advantage of a low possibility of gasification. The electrolyte solution preferably contains PS at greater than or equal to 0.25 wt % and less than or equal to 7.5 wt % of the sum (total weight) of the mixed solvent and the lithium salt. When the additive agent is mixed in the electrolyte solution in this manner, generation of a gas at a temperature higher than 25° C. can be inhibited.

### [Separator]

A separator of one embodiment of the present invention preferably has high wettability with the electrolyte solution containing the above mixed solvent. A specific example of the compound having high wettability with the electrolyte solution containing the above mixed solvent is an imide compound, and typically, polyimide is preferably used. Thus, the separator preferably includes an imide compound in a region in contact with the electrolyte solution. The imide compound has high wettability probably because negatively polarized oxygen in the imide compound interacts with hydrogen in the fluoride mixed solvent, typically hydrogen in FEC and hydrogen in MTFP. Note that in this specification and the like, wettability can be evaluated using a contact angle. The contact angle is preferably measured by a method conforming to JIS R 3257; for example, the contact angle can be measured when 10 μL to 25 μL, both inclusive, of an electrolyte solution is dropped onto a separator member and then 30 seconds to 60 seconds, both inclusive, have passed in an environment at 25° C. The contact angle can be measured on an image observed from the horizontal direction. As the contact angle, an average value of angles measured at a plurality of portions is preferably employed. In this specification and the like, the term “high wettability” means that the contact angle is less than 30°, preferably less than 20°, further preferably less than 10°.

Specific examples of the separator are described with reference to FIGS. 1A to 1D.

As illustrated in FIG. 1A, a separator 105 can have a single-layer structure including a member 15. The contact angle between the member 15 and the electrolyte solution is preferably less than 30°, further preferably less than 20°, still further preferably less than 10°. The member 15 positioned on the surface of the separator 105 preferably has high wettability with the electrolyte solution, in which case the electrolyte solution can be injected into an exterior body favorably. Furthermore, the member 15 positioned on the surface of the separator 105 preferably has high wettability with the electrolyte solution, in which case the amount of the electrolyte solution held in the separator 105 can be ensured even in the case where the electrode expands and shrinks in charging and discharging. An imide compound is preferably used as a material enabling the above contact angle. Examples of the imide compound include polyimide and polyamic acid (a precursor of polyimide). When the above-described DSC measurement is performed on the separator material, it can be said that a separator material that does not exhibit an endothermic peak at higher than or equal to 25° C. and lower than or equal to 500° C., preferably higher than or equal to 25° C. and lower than or equal to 350° C. has high heat resistance and a secondary battery including the separator material has a high level of safety. As the separator material that does not exhibit an endothermic peak in the above temperature range, an imide compound, specifically, polyimide is given; however, a material other than polyimide may be used as long as the material does not exhibit an endothermic peak in the above temperature range.

As illustrated in FIG. 1B, the separator 105 can have a structure in which a member 17, a member 16, and the member 15 are stacked in this order. The contact angle of each of the member 15 and the member 17 with the electrolyte solution is preferably less than 30°, further preferably less than 20°, still further preferably less than 10° with the electrolyte solution. The member 15 and the member 17 each positioned on the surface of the separator 105 preferably have high wettability with the electrolyte solution, in which case the electrolyte solution can be injected into the exterior body favorably. Furthermore, the member 15 and the member 17 each positioned on the surface of the separator 105 preferably have high wettability with the electrolyte solution, in which case the amount of the electrolyte solution held in the separator 105 can be ensured even in the case where the electrodes expand and contract in charging and discharging. An imide compound is preferably used as a material enabling the above contact angle. Examples of the imide compound include polyimide and polyamic acid (a precursor of polyimide).

The member 16 is preferably formed using a porous base material. As the material of the porous base material, an insulating material is preferable, and one or more selected from organic materials and inorganic materials can be used as the insulating material. Note that in the porous base material, a thermoplastic resin is preferably used as the organic material so that the separator 105 can have a shut-down function. The shut-down function is a function of closing the pores of the separator 105 when abnormal heat generation occurs in the secondary battery. A thermoplastic resin softens when heated, so that the pores are closed by softening. With the use of such a thermoplastic resin, the separator 105 can have a shut-down function. As the thermoplastic resin, a material having a softening point or a melting point lower than 200° C. is preferably used, and typically, one or more selected from polypropylene (PP), polyethylene (PE), acrylic, and polyamide (PA) can be used. Polypropylene has higher heat resistance than polyethylene, and has a softening point that is higher than or equal to 140° C., and a melting point that is higher than or equal to 164° C. and lower than or equal to 170° C. Since the softening point of polypropylene is close to the temperature of abnormal heat generation, polypropylene can be a material having a favorable shut-down function. In the case where the above-described DSC measurement is performed on the separator material, an endothermic peak is detected at higher than or equal to 100° C. and lower than or equal to 200° C., preferably higher than or equal to 160° C. and lower than or equal to 180° C., meaning that a favorable shut-down effect can be obtained. As long as such a peak is detected, a material other than a thermoplastic resin may be used for the separator.

A material other than polypropylene (PP), polyethylene (PE), acrylic, and polyamide (PA) can also be used for the member 16. As an insulating material usable for the member 16, one or more of a fiber containing cellulose, nonwoven fabric, glass fiber, ceramics, and synthetic fiber including nylon (polyamide), vinylon (polyvinyl alcohol-based fiber), polyester, acrylic, polyolefin, and polyurethane can be used. Although the above-described materials may each have a lower shut-down function than polypropylene or the like, the separator 105 includes the member 15 and the member 17, and thus the range of choices for the material that can be used for the member 16 can be expanded.

Furthermore, in the separator 105, one or more of a fiber containing cellulose, such as paper, nonwoven fabric, glass fiber, ceramics, or synthetic fiber including nylon (polyamide), vinylon (polyvinyl alcohol-based fiber), polyester, acrylic, polyolefin, and polyurethane can be provided between the member 16 and the member 15.

Furthermore, in the separator 105, one or more of a fiber containing cellulose, such as paper, nonwoven fabric, glass fiber, ceramics, or synthetic fiber including nylon (polyamide), vinylon (polyvinyl alcohol-based fiber), polyester, acrylic, polyolefin, and polyurethane can be provided between the member 16 and the member 17.

As illustrated in FIG. 1C, the separator 105 can have a structure in which the member 17, the member 16, and the member 15 are stacked in this order, and a coating layer 18 can be provided on the surface of the member 15. For the coating layer 18, a ceramic-based material, a fluorine-based material, a polyamide-based material, a mixture thereof, or the like can be used. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid). In the separator 105, the member 17 can ensure high wettability with the electrolyte solution. In the case where the member 15 has high wettability with the electrolyte solution, it is preferable that the coating layer 18 be selectively formed and the member 15 be partly exposed from the coating layer 18 in the separator 105.

As illustrated in FIG. 1D, the separator 105 can have a structure in which the member 17, the member 16, and the member 15 are stacked in this order, the coating layer 18 can be provided on the surface of the member 15, and a coating layer 19 can be provided on the surface of the member 17. The coating layer 19 can be formed using any material selected from the above-described materials usable for the coating layer 18, and may be formed using the same material as that of the coating layer 18 or a material different from that for the coating layer 18. In the case where the member 15 can have high wettability with the electrolyte solution in the separator 105, it is preferable that the coating layer 18 be selectively formed and the member 15 be partly exposed from the coating layer 18 in the separator 105. In the case where the member 17 can have high wettability with the electrolyte solution in the separator 105, it is preferable that the coating layer 19 be selectively formed and the member 17 be partly exposed from the coating layer 19 in the separator 105.

Next, the thickness of the separator 105 will be described. The thickness of the separator 105 is preferably greater than or equal to 10 μm and less than or equal to 80 μm, further preferably greater than or equal to 20 μm and less than or equal to 60 μm. When the separator 105 has a stacked structure, members having different physical properties can be combined, and thus the total thickness of the separator can be reduced. Typically, when the thickness is greater than or equal to 20 μm and less than or equal to 40 μm, the safety of the secondary battery can be maintained. Thus, the proportions of the positive electrode and the negative electrode can be increased and the capacity per volume of the secondary battery can be increased. Note that the thickness of the separator 105 can be a value measured at the center portion of a cross-sectional observation image of the secondary battery including the separator 105, for example.

Next, the thicknesses of the members 15, 16, and 17 are described. The member 16 is a member that imparts a shut-down function to the separator 105, and preferably has a larger thickness than each of the member 15 and the member 17. Since polyimide used for each of the member 15 and the member 17 can have a porosity higher than or equal to 75% and lower than or equal to 85%, the thickness of each of the member 15 and the member 17 can be easily made smaller than that of the member 16. The member 15 and the member 17 are members for ensuring the wettability with the electrolyte solution, and even when their thicknesses are smaller than that of the member 16, the member 15 and the member 17 can function well as parts of the separator 105. Note that the thicknesses of the members 15, 16, and 17 can each be a value measured at the center portion of a cross-sectional observation image of the secondary battery including the members 15, 16, and 17, for example.

Furthermore, in the case where the separator 105 is provided such that the member 15 is close to the negative electrode side, the thickness of the member 15 is preferably larger than the thickness of the member 17. An internal short circuit of the secondary battery due to a dendrite that might be generated in the negative electrode can be inhibited. Also in the case where the coating layer 18 is close to the negative electrode side in the separator 105, an internal short circuit of the secondary battery due to the dendrite can be inhibited.

Furthermore, the member 15 may have a depressed portion on its surface. The depressed portion is a region with a small thickness in a cross-sectional observation image, and the depressed portion can be formed by removing a part of the member 15. The depressed portions are preferably arranged in a stripe pattern. Similarly, the member 17 may have a depressed portion on its surface. The depressed portion is a region having a smaller thickness than the other region in a cross-sectional observation image, and the depressed portion can be formed by removing a part of the member 17. The depressed portions are preferably arranged in a stripe pattern. When the depressed portions are included, the coating layer 18 and the coating layer 19 are easily formed. Owing to the depressed portions, the coating layer 18 and the coating layer 19 can be selectively formed.

The shape of the separator 105 is not limited and can be a sheet-like shape, for example. The separator 105 may have a pouch-like shape, and a mode in which one of the positive electrode and the negative electrode is held in a pouch is also suitable for the separator 105.

### [Thermomechanical Analysis (TMA)]

TMA is a method for measuring the degree of deformation of a sample under a non-oscillating stress such as compression, tension, or bending while the temperature of the sample is changed, as a function of temperature or time.

FIG. 16 is a simplified view of a measurement apparatus (TMA test apparatus) used for thermal mechanical analysis. The TMA test apparatus includes a force generation portion 701, a probe 702, and a heating furnace 705, and the temperature of a sample 703 can be changed using the heating furnace 705 while a constant tensile stress is applied to the sample 703 from the force generation portion 701 through the probe 702. The TMA test apparatus further includes a thermocouple 706, and the temperature of the sample 703 can be obtained by detecting a temperature signal from the thermocouple 706. When deformation such as thermal expansion or softening occurs in the sample 703 in accordance with the temperature change, the displacement amount is measured by a position detection portion 707 as the positional change amount of the probe 702 and output as a signal. In the above manner, deformation with respect to temperature can be measured while a non-oscillating stress (constant force) is applied.

In the case where the separator material is subjected to thermomechanical analysis, it is preferable that the separator material not shrink nor be broken and extend under applied stress even when the temperature is increased. Specifically, when a graph showing the elongation rate of the sample (the length of expansion or shrinkage [μm]/temperature (° C.)) on the vertical axis and the temperature (° C.) on the horizontal axis is created, the elongation rate of the separator material is preferably higher than or equal to 0.2 μm/° C. and lower than or equal to 3.0 μm/° C. in the range higher than or equal to 150° C. and lower than or equal to 300° C. It is further preferable that the elongation rate of the separator material be higher than or equal to 0.6 μm/° C. and lower than or equal to 2.0 μm/° C. in the range higher than or equal to 150° C. and lower than or equal to 300° C.

### [Tensile Test]

In order to obtain the mechanical strength characteristic value of the separator material, a tensile test may be performed as measurement different from TMA. A precision universal tester can be used for the tensile test, and the tensile strength is increased at a set rate while the temperature is constant, whereby the amount of change in the separator material can be obtained. A difference from TMA is that the tensile test is performed at constant temperature, without a change in temperature.

FIG. 17 is a simplified view of a tensile tester. A test is performed in the following manner: a test sample 712 is attached to a first jig 711a and a second jig 711b of the tester, and the sample 712 is pulled at a set rate until the sample 712 is broken. In the tensile test, the temperature can be set to any temperature; for example, the temperature can be set to 25° C. as a room temperature and 250° C. as a temperature at the time of thermal runaway of a secondary battery. Typically, the set tensile rate can be greater than or equal to 45 mm/min and less than or equal to 70 mm/min, and the separator material is evaluated with the maximum value [N] of the force and the maximum value [MPa] of the stress.

In the case of a separator material, the maximum value of the force is preferably greater than or equal to 0.2 N, further preferably greater than or equal to 1.0 N in the tensile test at 25° C. In the tensile test, the maximum value of stress is preferably greater than or equal to 20 MPa, further preferably greater than or equal to 30 MPa. In the case of using a separator material, the maximum value of the force is preferably greater than or equal to 0.1 N, further preferably greater than or equal to 0.5 N in the tensile test at 250° C. In the tensile test, the maximum value of stress is preferably greater than or equal to 10 MPa, further preferably greater than or equal to 20 MPa. Incidentally, for the evaluation of the separator material, conditions and a tensile testier different from the conditions and the tensile tester described in this embodiment may be used.

### [Secondary Battery]

Next, a secondary battery including the electrolyte solution and the separator 105 is described with reference to FIGS. 2A and 2B and FIGS. 3A and 3B. FIG. 2A illustrates a state where components of a secondary battery 100 overlap with each other, and FIG. 2B illustrates the components of the secondary battery 100 apart from each other. FIG. 3A is a cross-sectional view of the secondary battery 100, and FIG. 3B illustrates a positive electrode active material layer 22 included in the secondary battery 100.

The secondary battery 100 includes a plurality of positive electrodes. As the plurality of positive electrodes, a first positive electrode 103a and a second positive electrode 103b are illustrated in FIG. 2B. The first positive electrode 103a and the second positive electrode 103b are collectively referred to as a positive electrode 103. Note that in the secondary battery 100, the number of positive electrodes is not limited to two and may be one or three or more.

The secondary battery 100 includes a plurality of negative electrodes. As the plurality of negative electrodes, a first negative electrode 106a, a second negative electrode 106b, and a third negative electrode 106c are illustrated in FIG. 2B. The first negative electrode 106a, the second negative electrode 106b, and the third negative electrode 106c are collectively referred to as a negative electrode 106. Note that the number of negative electrodes in the secondary battery 100 is not limited to three and may be one, two, or four or more.

The secondary battery 100 includes separators between the negative electrodes and the positive electrodes. In FIG. 2B, a plurality of separators, a first separator 105a, a second separator 105b, a third separator 105c, and a fourth separator 105d are illustrated by dashed lines. The first separator 105a, the second separator 105b, the third separator 105c, and the fourth separator 105d are collectively referred to as the separator 105. Note that the number of separators is not limited to four and may be one, two, three, or five or more in the secondary battery 100. As the plurality of separators, sheet-shaped separators independent of one another may be prepared as illustrated in FIG. 2B; alternatively, a continuous separator can be used. The continuous separator refers to a structure in which a separator having a larger area than the positive electrode and the negative electrode is prepared, the separator is folded as appropriate, and the separator portions are placed in positions corresponding to the first separator 105a to the fourth separator 105d. Since the number of separators is larger than that of positive electrodes or negative electrode, the total thickness of the separators is reduced, so that the capacity per volume of the secondary battery can be increased.

FIG. 3A is an example of a cross-sectional view of the secondary battery 100 along the dashed-dotted line AB in FIG. 2B. Description of FIG. 3A is given using the positive electrode 103, the separator 105, the negative electrode 106, a protruding portion 31t, and the like.

The positive electrode 103 includes the positive electrode current collector 21 and the positive electrode active material layer 22. The positive electrode active material layer 22 is a layer including positive electrode active material particles and includes a region in contact with the positive electrode current collector 21. A manufacturing process of the positive electrode 103 includes a pressing step; in the positive electrode subjected to the pressing step, a depressed portion is sometimes formed in a part of the positive electrode current collector 21 by a positive electrode active material particle pressed into the positive electrode current collector 21. As illustrated in FIG. 3A, the positive electrode active material layer 22 can be formed on both surfaces of the positive electrode current collector 21. Such a structure is referred to as a double-side coating structure. Although not illustrated, the positive electrode active material layer 22 can be formed on only one surface of the positive electrode current collector 21. Such a structure is referred to as a single-side coating structure.

A protruding portion 21t illustrated in FIG. 2A is a part of the positive electrode current collector 21. In other words, the protruding portion 21t is a region of the positive electrode current collector 21 where the positive electrode active material layer 22 is not provided. As illustrated in FIG. 2A, in the secondary battery 100, the plurality of protruding portions 21t overlap with each other to form a group. The group of the protruding portions 21t is referred to as a positive electrode tab. The positive electrode tab is bonded to the positive electrode lead 107a in a bonding portion 109a. For the bonding, ultrasonic bonding can be performed. As a result of the bonding, the components are electrically connected to each other. The positive electrode lead 107a can be formed using a material selected from aluminum, nickel, titanium, and an alloy thereof. An insulator seal may be placed to surround the bonding portion 109a and/or the positive electrode lead 107a. A Kapton tape can be used as the insulator seal.

FIG. 3B illustrates an example of a cross-sectional view of the positive electrode active material layer 22. The positive electrode active material layer 22 includes at least a positive electrode active material 10. The positive electrode active material layer 22 may include the second positive electrode active material 20. The positive electrode active material layer 22 may include a conductive material 41. The positive electrode active material layer 22 includes an electrolyte solution 108. The positive electrode active material layer 22 may include a binder, although not illustrated. The positive electrode active material layer 22 may not necessarily include the second positive electrode active material 20. The positive electrode active material layer 22 may not necessarily include the conductive material 41. The positive electrode active material layer 22 may not necessarily include a binder or a conductive material.

As the positive electrode active material 10, an active material having an average particle diameter of greater than or equal to 9 μm and less than 20 μm and a maximum particle diameter of less than 30 μm is preferably used, and an active material having a large diameter (also referred to as a large particle diameter) is preferably used. A secondary particle may be used as the positive electrode active material 10, and the secondary particle preferably has an average particle diameter of greater than or equal to 9 μm and less than 20 μm and a maximum particle diameter of less than 30 μm. As the positive electrode active material 10, a composite oxide represented by LiM1O₂ (M1 is one or more selected from Fe, Ni, Co, Mn, and Al) having a layered rock-salt crystal structure can be used, and typically lithium cobalt oxide can be used. Note that lithium cobalt oxide with favorable high-voltage charge characteristics is described in Embodiment 2 and subsequent embodiments.

Furthermore, the positive electrode active material 10 preferably has an average particle diameter less than or equal to 5 μm, preferably greater than or equal to 0.1 μm and less than or equal to 5 μm, and a maximum particle diameter less than 9 μm, and an active material having a small diameter (also referred to as a small particle diameter) is preferably used. As the positive electrode active material 10, LiM2PO₄ having an olivine crystal structure (M2 is one or more selected from Fe, Ni, Co, and Mn) can be used. Examples of LiMPO₄ are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1), and typically, lithium iron phosphate can be used. The particle surface of the positive electrode active material 10 preferably includes a carbon layer.

The second positive electrode active material 20 included in the positive electrode active material layer 22 has an average particle diameter of 5 μm or less, preferably 0.1 μm or more and 5 μm or less, and a maximum particle diameter of less than 9 μm, and an active material having a small diameter (also referred to as a small particle diameter) is preferably used. As the second positive electrode active material 20, LiM2PO₄ having an olivine crystal structure (M2 is one or more selected from Fe, Ni, Co, and Mn) can be used. Examples of the general formula LiMPO₄ are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1), and typically, lithium iron phosphate can be used. The particle surface of the second positive electrode active material 20 preferably includes a carbon layer.

The negative electrode 106 includes a negative electrode current collector 31 and a negative electrode active material layer 32. The negative electrode active material layer 32 is a layer including negative electrode active material particles and includes a region in contact with the negative electrode current collector 31. A manufacturing process of the negative electrode 106 includes a pressing step; in the negative electrode subjected to the pressing step, a depressed portion is sometimes formed in a part of the negative electrode current collector 31 by a negative electrode active material particle pressed into the negative electrode current collector 31. As illustrated in FIG. 3A, the negative electrode active material layer 32 can be formed on only one surface of the negative electrode current collector 31. In the negative electrode provided as the outermost layer of the secondary battery 100, carrier ions are not inserted or extracted or are unlikely to be inserted or extracted from the negative electrode active material layer that does not face the positive electrode. Thus, this negative electrode active material layer may not be necessarily formed. That is, single-side coating is often employed for the negative electrode as the outermost layer. Although not illustrated, a double-side coating structure in which the negative electrode active material layers 32 are formed on both surfaces of the negative electrode current collector 31 may be employed. All the negative electrodes preferably have a double-side coating structure, in which case high productivity can be obtained. In that case, the negative electrode having a double-side coating structure can also be provided as the outermost layer.

The negative electrode current collector 31 further includes the protruding portion 31t. The protruding portion 31t is a region where the negative electrode active material layer 32 is not provided. FIG. 2B illustrates a first protruding portion 31ta, a second protruding portion 31tb, and a third protruding portion 31tc as a plurality of protruding portions. The first protruding portion 31ta, the second protruding portion 31tb, and the third protruding portion 31tc are collectively referred to as the protruding portion 31t. FIG. 2A also illustrates the protruding portion 31t. The plurality of protruding portions 31t overlap with each other to form a group. The group of the protruding portions 31t is referred to as a negative electrode tab. Note that in FIG. 3A, the protruding portion 31t is illustrated apart from the other protruding portions.

As illustrated in FIG. 2A, the negative electrode tab (the protruding portion 31t) is bonded to the negative electrode lead 107b in the bonding portion 109b. For the bonding, ultrasonic bonding can be performed. As a result of the bonding, the components are electrically connected to each other. The negative electrode lead 107b can be formed using a material selected from nickel, copper, titanium, and an alloy thereof. An insulator seal may be placed to surround the bonding portion 109b and/or the negative electrode lead 107b. A Kapton tape can be used as the insulator seal.

The negative electrode active material layer 32 may include a binder. The negative electrode active material layer 32 may further include a conductive material. Needless to say, it is acceptable that the negative electrode active material layer 32 does not include a binder or a conductive material. The binder and the conductive material will be described later.

In this specification and the like, a structure body in which a plurality of positive electrodes, a plurality of negative electrodes, and a plurality of separators are stacked as illustrated in FIG. 2B is referred to as a stacked electrode.

FIG. 4 illustrates a liquid-injection apparatus 280 of the electrolyte solution 180. The liquid-injection apparatus 280 includes a treatment chamber 281, a liquid-injection nozzle 282 positioned on the top surface of the treatment chamber 281, a pump 283 for transferring the electrolyte solution 180 to the liquid-injection nozzle 282, and a tank 284 for storing the electrolyte solution 180. The pump 283 preferably has a function of adjusting liquid-transferring speed. The treatment chamber 281 includes a fixing unit 285 for fixing the secondary battery 100 (in a state in which a stacked battery is held in an exterior body and part of the exterior body is thermocompression-bonded). Although not illustrated, the treatment chamber 281 preferably includes a vacuum pump or the like and liquid injection is performed in a vacuum atmosphere. As the vacuum pump, a dry pump, a turbomolecular pump, an oil rotary pump, a cryopump, or a mechanical booster pump can be used. The vacuum atmosphere includes an atmosphere where the pressure is reduced such that a differential pressure gauge in the treatment chamber 281 becomes higher than or equal to −0.1 MPa and lower than −0.08 MPa. A heating mechanism 286 is preferably included in a portion of the liquid-injection nozzle 282 that is close to the treatment chamber 281. The viscosity of the electrolyte solution 180 can be controlled by the heating mechanism 286. After the injection of the electrolyte solution 180 is finished, the liquid-injection nozzle 282 is lifted up and thermocompression bonding can be performed on the exterior body in the treatment chamber 281.

Since the area of the separator 105 is larger than those of the positive electrode and the negative electrode, the separator 105 first comes into contact with the electrolyte solution at the time of injection of the electrolyte solution. Thus, the use of the separator 105 that has high wettability with the electrolyte solution is preferable because the electrolyte solution is easily injected.

In the case where depressed portions are provided in a stripe-manner in each of the member 15 and the member 17 in the separator 105, the depressed portions provided in a stripe-manner preferably extend toward the opposite side from the liquid-injection nozzle 282 as the starting point.

### [Exterior Body]

Although not illustrated, the secondary battery 100 includes an exterior body, and the stacked electrode is held in the exterior body. For an exterior body of the secondary battery 100, a resin material or a metal material such as aluminum, stainless steel, or titanium can be used, for example. A film-shaped exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer in the laminate film may sometimes affect flexibility, i.e., bendiness of the secondary battery 100. As an exterior body used for the secondary battery 100 in which flexible or lightweight is required, for example, an aluminum laminated film including a polypropylene layer, an aluminum layer, and an nylon layer is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

For an exterior body used for the secondary battery 100 emphasizing physical intensity or safety, it is preferable to use a stainless steel laminated film including a polypropylene layer, a stainless steel layer, and a nylon layer. Furthermore, a polyethylene terephthalate layer may be provided over the nylon layer. Here, the thickness of the stainless steel layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the stainless steel layer is smaller than 10 μm, a gas barrier property might be lowered by pinholes of the stainless steel layer; thus, the thickness of the stainless steel layer is desirably larger than or equal to 10 μm. Note that stainless steel in this specification and the like refers to steel containing chromium at approximately 12% or more (i.e., an alloy of iron and carbon), and can be roughly classified into martensitic stainless steel, ferritic stainless steel, or austenite stainless steel according to the composition. Moreover, stainless steel to which one or more kinds of elements selected from Ti, Nb, Mo, Cu, Ni, and Si are added is also included in the stainless.

Alternatively, for example, it is preferable to use a titanium laminated film including a polypropylene layer, a titanium layer, and a nylon layer. Furthermore, a polyethylene terephthalate layer may be provided over the nylon layer. Here, the thickness of the titanium layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the titanium layer is smaller than 10 μm, a gas barrier property might be lowered by pinholes of the titanium layer; thus, the thickness of the titanium layer is desirably larger than or equal to 10 μm.

A secondary battery using a film as its exterior body is referred to as a laminated secondary battery. Although not illustrated in this embodiment, a can case may be used as the exterior body. For example, a secondary battery using a circular case is referred to as a coin-type secondary battery. A secondary battery using a cylindrical case is referred to as a cylindrical secondary battery.

### [Bendable Secondary Battery]

Next, a bendable secondary battery 100x is described with reference to FIGS. 5A and 5B. FIG. 5A is a cross-sectional view of the secondary battery 100x, and FIG. 5B is a perspective view thereof. Like the secondary battery 100, the secondary battery 100x includes the positive electrode 103, the separator 105, and the negative electrode 106, and each of the positive electrode 103, the separator 105, and the negative electrode 106 is preferably formed using a flexible member. The description of portions of the positive electrode 103, the separator 105, and the negative electrode 106 that are similar to those of the secondary battery 100 is omitted. Differently from the secondary battery 100, the bendable secondary battery 100x may have a structure in which two positive electrodes 103 each having a single-side coating structure are prepared and the positive electrode current collectors of the positive electrodes are in contact with each other. The structure in which the positive electrode current collectors are in contact with each other is referred to as a current collector contact structure. Similarly, a negative electrode may be prepared, having a current collector contact structure in which two negative electrodes 106 each having a single-side coating structure are prepared and the negative electrode current collectors of the negative electrodes are in contact with each other. In a secondary battery having such a current collector contact structure, current collectors that are in contact with each other are likely to be shifted from each other when the secondary battery is bent. Thus, the current collector contact structure is suitable for the bendable secondary battery 100x.

In the bendable secondary battery 100x, the protruding portion 31t might have more creases and the protruding portion 31t might be disconnected. An example of inhibiting generation of creases in the protruding portion 31t, FIGS. 5A and 5B illustrate the secondary battery 100x bent such that end portions on the protruding portions 31t side of the stacked battery are aligned with each other. Then, in the secondary battery 100x, a shift occurs in the stacked battery on the side opposite to the protruding portion 31t side, and the shift becomes larger toward the opposite side. In that case, when the current collector contact structure is used, the current collectors in contact with each other are likely to be shifted, so that an appropriate shift can be caused. In the secondary battery 100x, which is bent such that end portions on the protruding portion 31t side of the stacked battery are aligned with each other, separators other than that in the outermost layer might be in contact with the exterior body.

In the case where the protruding portion 31t is disconnected due to creases, the position where the secondary battery 100x is bent, i.e., the position where external force is applied, is preferably positioned at a position that is farther from the protruding portion 31t than the center of the stacked battery. Needless to say, the position where the secondary battery 100x is bent, i.e., the position where external force is applied, may be the center position of the stacked electrode.

In this specification and the like, the secondary battery 100x including a bent region (a curved region) as illustrated in FIGS. 5A and 5B is referred to as a bent secondary battery in some cases. As the secondary battery 100x, a laminated secondary battery is preferably used. An exterior body used for the laminated secondary battery is preferable because it has flexibility and thus is likely to follow the change of shape of the secondary battery, specifically, the bending of the secondary battery. The secondary battery 100x can be charged and discharged when bent and fixed as illustrated in FIGS. 5A and 5B.

The bendable secondary battery 100x includes a secondary battery that can be repeatedly changed between a flat state in FIG. 3A and a bent state as illustrated in FIGS. 5A and 5B. The secondary battery 100x can be discharged while being changed from the flat state to the bent state or from the bent state to the flat state. Instead of discharging, charging is also possible.

As the separator 105 of the bendable secondary battery 100x, the separator 105 described with reference to FIGS. 1A to 1D is preferably used. Note that in the bendable secondary battery 100x, it is preferable that an adhesive layer not be provided on the outermost surface of the separator 105 and the separator 105 include a region in contact with the positive electrode 103. The separator 105 and the positive electrode 103 can be shifted appropriately. Similarly, it is preferable that an adhesive layer not be provided and the separator 105 include a region in contact with the negative electrode 106. The separator 105 and the negative electrode 106 can be shifted from each other appropriately. As a structure not provided with an adhesive layer, specifically, it is preferable that the member 15 be positioned on one surface of the outermost surfaces of the separator 105 and the surface not be coated with a ceramic-based material, a fluorine-based material, a polyamide-based material, a mixture thereof, or the like. Similarly, it is preferable that the member 17 be positioned on the other surface of the outermost surfaces of the separator 105 and the surface not be coated with a ceramic-based material, a fluorine-based material, a polyamide-based material, a mixture thereof, or the like. Note that the member 15 and the member 17 may be coated with any of a ceramic-based material, a fluorine-based material, a polyamide-based material, and a mixture thereof that do not have a bonding function.

Since the bendable secondary battery 100x includes a separator having high wettability with an electrolyte solution, the electrolyte solution can be injected into the exterior body favorably. This is preferable because the amount of the electrolyte solution held in the separator 105 can be ensured also in the case where the electrodes expand and contract at the time of charging and discharging the bendable secondary battery 100x. Furthermore, with the use of a separator having a multilayer structure, the capacity per volume of the bendable secondary battery 100x can be increased.

The contents in this embodiment can be combined with the contents in any of the other embodiments as appropriate.

### Embodiment 2

A positive electrode active material of one embodiment of the present invention is described.

### <<Formation Method of Positive Electrode Active Material>>

A formation method of the positive electrode active material 10 is described with reference to FIG. 6 and FIGS. 7A to 7C.

### <Step S11>

In Step S11 shown in FIG. 6, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide such as tricobalt tetroxide, cobalt hydroxide, or the like can be used.

The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be provided.

Furthermore, the cobalt source preferably has high crystallinity and for example, the cobalt source preferably includes single crystal grains. The crystallinity of the cobalt source can be evaluated with a transmission electron microscope (TEM) image, a scanning transmission electron microscope (STEM) image, a high-angle annular dark field scanning transmission electron microscope (HAADF-STEM) image, or an annular bright-field scan transmission electron microscope (ABF-STEM) image or by X-ray diffraction (XRD), electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 6, the lithium source and the cobalt source are ground and mixed to form a mixed material. The grinding and mixing can be performed by a dry method or a wet method. A wet method is preferable because it can crush a material into a smaller size. In the case of a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the circumferential speed is preferably higher than or equal to 100 mm/s and lower than or equal to 2000 mm/s in order to inhibit contamination from the medium. In this embodiment, the grinding and mixing are performed at a circumferential speed of 838 mm/s (the number of rotations: 400 rpm, the ball mill diameter: 40 mm).

### <Step S13>

Next, in Step S13 shown in FIG. 6, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature may lead to insufficient decomposition and melting of the lithium source and the cobalt source. An excessively high temperature may lead to a defect due to evaporation of lithium from the lithium source and/or excessive reduction of cobalt, for example. An oxygen vacancy or the like may be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature raising rate is preferably higher than or equal to 80° C./h and lower than or equal to 250° C./h although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flow”.

In the case where the heating atmosphere is an oxygen-containing atmosphere, oxygen flow is preferably not performed. For example, a method in which the pressure in the reaction chamber is reduced, the reaction chamber is filled (or purged) with oxygen, and the exit and entry of the oxygen are prevented is preferable in some cases. For example, it is preferable that the pressure of the reaction chamber read by the differential pressure gauge be reduced to −970 hPa and then the reaction chamber be filled with oxygen until the differential pressure gauge shows 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container holding an object to be heated at the time of heating is preferably a crucible made of aluminum oxide or a setter (also referred to as a saggar) made of aluminum oxide. Almost no impurities enter the crucible made of aluminum oxide. In this embodiment, a setter made of aluminum oxide with a purity of 99.9% is used. The crucible or the setter is preferably covered with a lid before heating, in which case volatilization of a material can be prevented. Furthermore, as materials of the crucible and the setter, mullite-cordierite may be used.

A crucible that has been used a plurality of times is preferred to a new crucible. In this specification and the like, a new crucible refers to a crucible that is subjected to heating two or less times while materials including lithium, the transition metal M, and/or the additive element are contained therein. A crucible that has been used a plurality of times refers to a crucible that is subjected to heating three or more times while materials including lithium, the transition metal M, and/or the additive element are contained therein. In the case where a new crucible is used, part of a material such as lithium fluoride is liable to be absorbed by, diffused in, transferred to, and/or attached to a sagger. Loss of part of a material due to such phenomena increases a concern that an element is not distributed in a preferable range particularly in the surface portion of the positive electrode active material. In contrast, such a risk is low in the case of a crucible that has been used a plurality of times.

The heated material is ground as needed and may be made to pass through a sieve. The collection of the heated material may be performed after the material is moved from the crucible to a mortar. As the mortar, an aluminum oxide mortar is preferably used. An aluminum oxide mortar is made of a material that hardly releases impurities. Specifically, a mortar made of aluminum oxide with a purity higher than or equal to 90%, preferably higher than or equal to 99% is used. Note that heating conditions similar to those in Step S13 can be employed in later-described heating steps other than Step S13.

### <Step S14>

Through the above steps, lithium cobalt oxide (LiCoO₂) can be synthesized as in Step S14 in FIG. 6. The lithium cobalt oxide (LiCoO₂) formed in this manner can be used as a starting material.

Although the example is described in which the composite oxide is formed by a solid phase method as in Steps S11 to S14, the composite oxide may be formed by a coprecipitation method. Alternatively, the composite oxide may be formed by a hydrothermal method.

Note that pre-synthesized lithium cobalt oxide may be used in Step S14. In this case, Steps S11 to S13 can be skipped. When the pre-synthesized lithium cobalt oxide is heated, lithium cobalt oxide with a smooth surface can be obtained.

### <Step S20>

Next, as shown in Step S20, an additive element is preferably added to the lithium cobalt oxide. Because the formation method of the positive electrode active material described in this embodiment can separate addition of the additive elements into a plurality of steps, in the flowchart illustrated in FIG. 6, the additive element to be added first is described as A1, the additive element to be added second is referred to as A2, and the additive element to be added third is referred to as A3.

The step of adding the additive element A1 is described with reference to FIG. 7A.

### <Step S21>

In Step S21 shown in FIG. 7A, an additive element source (A1 source) to be added to the lithium cobalt oxide is prepared. A lithium source may be prepared in addition to the A1 source.

As the additive element A1, any of the additive elements described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used also as the lithium source. Another example of the lithium source that can be used in Step S21 is lithium carbonate.

The fluorine source is preferably a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), nitrogen trifluoride (NF₃), or the like may be used and mixed in the atmosphere in a heating step described later. Two or more of these fluorine sources may be used.

In the formation method of positive electrode active material described with reference to FIG. 6 and FIG. 7A, magnesium and fluorine are used as the additive element A1. Lithium fluoride (LiF) is prepared as the fluorine source, and magnesium fluoride (MgF₂) is prepared as the fluorine source and the magnesium source. When lithium fluoride and magnesium fluoride are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value” means a value greater than 0.9 times and less than 1.1 times the given value.

### <Step S22>

Next, in Step S22 shown in FIG. 7A, the magnesium source and the fluorine source are ground and mixed. Any of the conditions for the grinding and mixing that are described for Step S12 can be selected to perform Step S22.

### <Step S23>

Next, in Step S23 shown in FIG. 7A, the materials ground and mixed in the above step are collected to give the A1 source. Note that the additive element A1 source in Step S23 contains a plurality of starting materials and can be referred to as a mixture.

As for the particle diameter of the mixture, the median diameter (D50) is preferably greater than or equal to 600 nm and less than or equal to 200 μm, further preferably greater than or equal to 1 μm and less than or equal to 150 μm. Also when one kind of material is used as the additive element source, the median diameter (D50) is preferably greater than or equal to 600 nm and less than or equal to 200 μm, further preferably greater than or equal to 1 μm and less than or equal to 150 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in a surface portion 10a of the composite oxide after heating.

### <Step S31>

Next, in Step S31 shown in FIG. 6, the lithium cobalt oxide and the A1 source are mixed. The ratio of the number of cobalt (Co) atoms in the lithium cobalt oxide to the number of magnesium (Mg) atoms in the A1 source (Co:Mg) is preferably 100:y (0.1≤y≤6), further preferably 100:y (0.3≤y≤3).

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill, a bead mill, or the like can be used for the mixing. When a ball mill is used, zirconium oxide balls are preferably used as a medium, for example.

In this embodiment, the mixing may be performed with a ball mill using zirconium oxide balls with a diameter of 1 mm by a dry method at 150 rpm for an hour. The mixing is performed in a dry room the dew point of which is higher than or equal to −100° C. and lower than or equal to −10° C.

In mixing of the lithium cobalt oxide and the A1 source in Step S31, a surface treatment or a composite formation process such as precision mixing or spheroidizing may be used.

In the composite formation process, when a pressure, a shearing force, or the like is applied to a mixture of two or more materials, a composite in which one of the materials is fused in the surface of the other of the materials, that is, a composite in which the materials are bonded to each other can be obtained.

As a typical apparatus for the composite formation process, Picoline (Hosokawa Micron) equipped with Nobilta as a rotor can be used, and stirring is preferably performed at a rotating speed of greater than or equal to 2000 rpm and less than or equal to 4000 rpm. The stirring time is preferably longer than or equal to 5 minutes and shorter than or equal to 1 hour. In addition, heat generation in a stirred region is preferably inhibited by using cooling water during the composite formation process. The composite formation process is preferably performed in a dry room whose dew point is higher than or equal to −100° C. and lower than or equal to −10° C.

### <Step S32>

Next, in Step S32 in FIG. 6, the materials mixed in the above step are collected, whereby a mixture 901 is obtained. At the time of the collection, the materials may be crushed as needed and made to pass through a sieve.

### <Step S33>

Then, in Step S33 shown in FIG. 6, the mixture 901 is heated. Any of the heating conditions described for Step S13 can be selected. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is preferably the temperature at which interdiffusion of the elements included in the lithium cobalt oxide and the additive element source occurs, and may be lower than the melting temperatures of these materials. It is known that in the case of an oxide as an example, solid phase diffusion occurs at the Tamman temperature T_{d} that is 0.757 times the melting temperature Tₘ. Accordingly, the heating temperature in Step S33 is preferably higher than or equal to 650° C.

Needless to say, the reaction more easily proceeds at a temperature higher than or equal to the temperature at which one or more of the materials contained in the mixture 901 are melted. For example, in the case where LiF and MgF₂ are used as the additive element sources, the lower limit of the heating temperature in Step S33 is preferably higher than or equal to 742° C. because the eutectic point of LiF and MgF₂ is around 742° C.

As for a mixture 903 obtained by mixing LiCoO₂, LiF, and MgF₂ to have a molar ratio of 100:0.33:1, the initial melting temperature Tᵢₘ is 779° C., the melting peak temperature Tₚₘ is 815° C., and the melting termination temperature Tₑₘ is 826° C. in a DSC measurement. Therefore, the lower limit of the heating temperature is further preferably higher than or equal to 826° C.

A higher heating temperature is preferable because it facilitates the reaction, shortens the heating time, and enables high productivity.

The upper limit of the heating temperature is lower than the melting point of the lithium cobalt oxide (1130° C.). At around the melting point, a slight amount of the lithium cobalt oxide might be decomposed. In addition, at the time of heating the mixture 903, the partial pressure of fluorine or a fluorine originating from the fluorine source or the like is preferably controlled to be within an appropriate range. When the temperature is too high, a fluoride is reduced by evaporation. For example, the vapor pressure of lithium fluoride increases rapidly from 900° C. Thus, the heating temperature is preferably lower than or equal to 1000° C., further preferably lower than or equal to 950° C., still further preferably lower than or equal to 900° C., still further preferably lower than or equal to 850° C. When evaporation of lithium fluoride is inhibited, the surface portion 10a containing fluorine and lithium at high concentrations can be obtained. When the surface portion 10a contains sufficient lithium, there is an advantage that a different phase (e.g., MgTiO₃) is less likely to be generated when titanium is added in a later step.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 826° C. and lower than or equal to 1100° C., further preferably higher than or equal to 826° C. and lower than or equal to 1130° C., still further preferably higher than or equal to 826° C. and lower than or equal to 1000° C., yet still further preferably higher than or equal to 826° C. and lower than or equal to 950° C., yet still further preferably higher than or equal to 826° C. and lower than or equal to 900° C. Note that the heating temperature in Step S33 is preferably lower than that in Step S13.

In addition, at the time of heating the mixture 901, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lower than the melting point of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize or sublimate LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 901 is preferably heated in an atmosphere containing LiF, i.e., the mixture 901 is preferably heated in a state where the partial pressure of LiF in the heating furnace is high. Such heating can inhibit volatilization of LiF in the mixture 901.

The heating in this step is preferably performed in a manner that can prevent the particles of the mixture 901 from being adhered to each other. Adhesion of the particles of the mixture 901 during the heating might decrease the area of contact with oxygen in the atmosphere and block a path of diffusion of the additive element (e.g., fluorine), thereby hindering distribution of the additive element (e.g., magnesium and fluorine) in the surface portion.

It is contemplated that uniform distribution of the additive element (e.g., fluorine) in the surface portion leads to a smooth positive electrode active material with little unevenness. Thus, it is preferable that the particles of the mixture 901 not be adhered to each other in order to allow the smooth surface to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flow of an atmosphere is preferably performed after an atmosphere is purged first and an oxygen atmosphere is introduced into the kiln. Oxygen flow, which might cause evaporation of the fluorine source, is not preferable for maintaining the smoothness of the surface.

In the case of using a roller hearth kiln for the heating, the mixture 901 can be heated in an atmosphere containing LiF with the container containing the mixture 901 covered with a lid.

A supplementary explanation of the heating time is provided. The heating time depends on conditions such as the heating temperature and the particle size and composition of the lithium cobalt oxide in Step S14. The heating may be preferably performed at a lower temperature or for a shorter time in the case where the particle size of the lithium cobalt oxide is small than in the case where the particle size is large.

In the case where the lithium cobalt oxide in Step S14 in FIG. 6 has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where the lithium cobalt oxide in Step S14 has a median diameter (D50) of approximately 7 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 6, in which crushing is performed as needed; thus, a composite oxide 902 is obtained.

### <Step S40>

In Step S40 shown in FIG. 6, an additive element source (A2 source) is prepared. As the additive element A2, any of the additive elements mentioned in description of Step S21 can be used. In the formation method of the positive electrode active material described with reference to FIG. 6 and FIGS. 7A to 7C, nickel and aluminum are used as the additive element A2. As the nickel source, nickel oxide, nickel hydroxide, or the like can be used. As the aluminum source, aluminum oxide, aluminum hydroxide, or the like can be used. As shown in Steps S41 to S43 in FIG. 7B, the nickel source and the aluminum source can each be ground to serve the A2 source. For the grinding conditions, the description of Step S22 can be referred to.

### <Step S51>

Next, in Step S51 shown in FIG. 6, the composite oxide 902 and the A2 source are mixed.

For the mixing conditions, the description of Step S31 can be referred to.

### <Step S52>

Next, in Step S52 in FIG. 6, the materials mixed in the above step are collected, whereby a mixture 903 is obtained. At the time of the collection, the materials may be crushed as needed and made to pass through a sieve.

### <Step S53>

Then, in Step S53 shown in FIG. 6, the mixture 903 is heated. For the heating conditions, the description of Step S33 can be referred to.

### <Step S54>

Next, the heated material is collected in Step S54 shown in FIG. 6, in which crushing is performed as needed; thus, a composite oxide 904 is obtained.

### <Step S60>

Next, in Step S60 shown in FIG. 6, an additive element source (A3 source) is prepared. As the additive element A3, any of the additive elements mentioned in description of Step S21 can be used. In the formation method of the positive electrode active material described with reference to FIG. 6 and FIGS. 7A to 7C, titanium is used as the additive element A3. As a titanium source, lithium titanate, titanium oxide, titanium hydroxide, or the like can be used. As shown in Step S61 to Step

S63 in FIG. 7C, the titanium source can be ground to serve as the A3 source. For the grinding conditions, the description of Step S22 can be referred to.

### <Step S71>

In Step S71 shown in FIG. 6, the composite oxide 904 and the A3 source are mixed. For the mixing conditions, the description of Step S31 can be referred to.

### <Step S72>

Next, in Step S72 in FIG. 6, the materials mixed in the above step are collected, whereby a mixture 905 is obtained. At the time of the collection, the materials may be crushed as needed and made to pass through a sieve.

### <Step S73>

Then, in Step S73 shown in FIG. 6, the mixture 905 is heated. For the heating conditions, the description of Step S33 can be referred to.

### <Step S74>

Next, the heated material is collected in Step S74 shown in FIG. 6, in which crushing is performed as needed; thus, the positive electrode active material 10 is obtained. Here, the collected particles are preferably made to pass through a sieve. Through the above process, the positive electrode active material 10 of one embodiment of the present invention can be formed. The positive electrode active material of one embodiment of the present invention has a smooth surface.

The positive electrode active material 10 with a smooth surface may be less likely to be physically broken by pressure application or the like than a positive electrode active material without a smooth surface. For example, the positive electrode active material 10 is unlikely to be broken in a test involving pressure application such as a nail penetration test, meaning that the positive electrode active material 10 has high safety.

### [Initial Heating]

In the manufacturing method described above, heat treatment is further preferably performed between the synthesis of the lithium cobalt oxide and the mixing of the additive element in some cases. This heating is referred to as initial heating.

Since lithium is extracted from part of the surface portion 10a of the lithium cobalt oxide by the initial heating, the distribution of the additive element becomes more favorable.

Specifically, the distributions of the additive elements can be easily made different from each other by the initial heating in the following mechanism. First, lithium is extracted from a part of the surface portion 10a by the initial heating. Next, additive element sources such as a nickel source, an aluminum source, and a magnesium source and lithium cobalt oxide including the surface portion 10a that is deficient in lithium are mixed and heated. Among the additive elements, magnesium is a divalent representative element, and nickel is a transition metal but is likely to be a divalent ion. Therefore, in a part of the surface portion 10a, a rock-salt phase containing Co²⁺, which is reduced due to lithium deficiency, Mg²⁺, and Ni²⁺ is formed. Note that this phase is formed in a part of the surface portion 10a, and thus is sometimes not clearly observed in an image obtained with an electron microscope, such as a STEM image, and an electron diffraction pattern.

In the case where lithium cobalt oxide having a layered rock-salt crystal structure is used as the positive electrode active material 10, nickel among the additive elements easily forms a solid solution and diffuses into the positive electrode active material 10. However, when a part of the surface portion of the positive electrode active material 10 has a rock-salt crystal structure, nickel is likely to remain in the surface portion 10a. Thus, a divalent additive element such as nickel can be kept in the surface portion of the positive electrode active material 10. The concentration of the divalent additive element typified by nickel is preferably higher particularly in the surface of the positive electrode active material 10 having an orientation other than a (001) orientation and the surface portion including the surface than in the inner portion.

Furthermore, in such a rock-salt crystal structure, the bond distance between a metal Me and oxygen (Me—O distance) tends to be longer than that in a layered rock-salt crystal structure.

For example, Me—O distance is 2.09 Å and 2.11 Å in Ni_{0.5}Mg_{0.5}O having a rock-salt crystal structure and MgO having a rock-salt crystal structure, respectively. Even when a spinel phase is formed in a part of the surface portion 10a, Me—O distance is 2.0125 Å and 2.02 Å in NiAl₂O₄ having a spinel structure and MgAl₂O₄ having a spinel structure, respectively. In each case, Me—O distance is longer than 2 Å. Note that 1 Å (angstrom) is 10⁻¹⁰ m.

Meanwhile, in a layered rock-salt crystal structure, the bond distance between oxygen and a metal other than lithium is shorter than the above-described distances. For example, Al—O distance is 1.905 Å (Li—O distance is 2.11 Å) in LiAlO₂ having a layered rock-salt crystal structure. In addition, Co—O distance is 1.9224 Å (Li—O distance is 2.0916 Å) in LiCoO₂ having a layered rock-salt crystal structure.

According to Shannon's ionic radii, the ion radius of hexacoordinated aluminum and the ion radius of hexacoordinated oxygen are 0.535 Å and 1.4 Å, respectively, and the sum of these values is 1.935 Å.

From the above, aluminum is considered to be stable at sites other than lithium sites more in a layered rock-salt crystal structure than in a rock-salt crystal structure. Thus, in the surface portion 10a, aluminum is more likely to be distributed in a region having a layered rock-salt phase at a larger depth and/or an inner portion 10b than in a region having a rock-salt phase that is close to the surface,

Moreover, the initial heating is expected to increase the crystallinity of the layered rock-salt crystal structure of the inner portion 10b.

However, the initial heating is not always required. In some cases, by controlling the atmosphere, temperature, time, or the like in another heating step, e.g., annealing, the positive electrode active material 10 that has the O3′ type structure when x in LiₓCoO₂ is small can be formed.

The features of the positive electrode active material 10 formed through the above steps will be described with reference to FIGS. 8A and 8B, FIGS. 9A to 9F, FIG. 10, FIG. 11, FIG. 12, FIG. 13, and FIGS. 14A to 14G.

### <Positive Electrode Active Material 10>

FIGS. 8A and 8B are cross-sectional views of the positive electrode active material 10 of one embodiment of the present invention. FIGS. 9A to 9C illustrate enlarged views of a portion near the line A-B in FIG. 8B. FIGS. 9D to 9F illustrate enlarged views of a portion near the line C-D in FIG. 8B.

As illustrated in FIG. 8A, the positive electrode active material 10 includes the surface portion 10a and the inner portion 10b. In FIGS. 8A and 8B, examples of a boundary between the surface portion 10a and the inner portion 10b are denoted by dashed lines.

The surface portion 10a of the positive electrode active material 10 refers to a region ranging from the surface to 50 nm or less, preferably 35 nm or less, further preferably 20 nm or less, most preferably 10 nm or less toward the inner portion in a perpendicular or substantially perpendicular direction. Note that “substantially perpendicular” refers to a state where an angle is greater than or equal to 80° and less than or equal to 100°. A plane generated by a split and/or a crack can be regarded as a surface. The surface portion 10a can be rephrased as the vicinity of a surface, a region in the vicinity of a surface, or a shell.

The inner portion 10b refers to a region deeper than the surface portion 10a of the positive electrode active material. The inner portion 10b can be rephrased as an inner region or a core.

In the case where the positive electrode active material 10 has a layered rock-salt crystal structure of a space group R-3m, the surface portion 10a includes an edge region 10a1 and a basal region 10a2 as illustrated in FIG. 8B. Note that in FIGS. 8A and 8B, the straight line denoted by (00l) represents a (00l) plane. Here, the edge region 10a1 is a region intersecting with the (00l) plane, and refers to a region ranging from the surface of the edge region 10a1 to 50 nm or less, preferably 35 nm or less, further preferably 20 nm or less, most preferably 10 nm or less toward the inner portion in a perpendicular direction or a substantially perpendicular direction. Here, “intersecting with the (00l) plane” means that an angle between a perpendicular line of the (00l) plane and a normal of the surface of the positive electrode active material 10 is greater than or equal to 100 and less than or equal to 90°, preferably greater than or equal to 300 and less than or equal to 90°.

Moreover, the basal region 10a2 has a surface parallel to the (00l) plane, and refers to a region ranging from the surface to 50 nm or less, preferably 35 nm or less, further preferably 20 nm or less, most preferably 10 nm or less toward the inner portion in a perpendicular direction or a substantially perpendicular direction. Here, “parallel to the (00l) plane” means that an angle between the perpendicular line of the (00l) plane and the normal of the surface of the positive electrode active material 10 is greater than or equal to 0° and less than or equal to 5°, preferably greater than or equal to 0° and less than or equal to 2.5°.

The surface of the positive electrode active material 10 refers to the surface of a composite oxide that includes the surface portion 10a and the inner portion 10b. Thus, the positive electrode active material 10 does not contain either a metal oxide, such as aluminum oxide (A1₂O₃), which is attached to a surface of the positive electrode active material 10 and does not include a lithium site contributing to charging and discharging; or a material such as a carbonate or a hydroxy group, which is chemically adsorbed after formation of the positive electrode active material. The attached metal oxide refers to, for example, a metal oxide having a crystal orientation different from that of the inner portion 10b.

The orientations of crystals in two regions being substantially aligned with each other can be confirmed, for example, with a TEM image, a STEM image, a HAADF-STEM image, an ABF-STEM image, an electron diffraction pattern, or the like. It can also be confirmed with an FFT pattern of a TEM image, an FFT pattern of a STEM image or the like. Additionally, XRD, neutron diffraction, or the like can be used for confirming.

Furthermore, an electrolyte solution, a decomposition product of the electrolyte solution, an organic solvent, a binder, a conductive material, and a compound originating from any of these that are attached to the positive electrode active material 10 are not contained either.

Since the positive electrode active material 10 is a compound containing oxygen and a transition metal into and from which lithium can be inserted and extracted, an interface between a region where oxygen and the transition metal M (e.g., Co, Ni, Mn, Fe, or the like) that is oxidized or reduced due to insertion and extraction of lithium are present and a region where oxygen and the transition metal M are absent is considered as the surface of the positive electrode active material. A plane generated by slipping and/or a crack also can be referred to as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

### <Element Contained>

The positive electrode active material 10 contains lithium, cobalt, oxygen, and an additive element A. The positive electrode active material 10 can contain lithium cobalt oxide (LiCoO₂) to which an additive element A is added. Note that the positive electrode active material 10 of one embodiment of the present invention preferably has a crystal structure described later, and thus the composition of the lithium cobalt oxide is not strictly limited to Li:Co:O=1:1:2.

The positive electrode active material particle needs to contain a transition metal which can take part in an oxidation-reduction reaction in order to maintain a neutrally charged state even when lithium ions are inserted and extracted. It is preferable that the positive electrode active material 10 of one embodiment of the present invention mainly contain cobalt as a transition metal taking part in an oxidation-reduction reaction. In addition to cobalt, at least one or both of nickel and manganese may be contained. Using cobalt at higher than or equal to 75 at %, preferably higher than or equal to 90 at %, further preferably higher than or equal to 95 at % as the transition metal contained in the positive electrode active material 10 brings many advantages such as relatively easy synthesis, easy handling, and excellent cycle performance, which is preferable.

When cobalt is used as the transition metal contained in the positive electrode active material 10 at higher than or equal to 75 atomic %, preferably higher than or equal to 90 atomic %, further preferably higher than or equal to 95 atomic %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure may break in charge-discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element A contained in the positive electrode active material 10, one or more selected from magnesium, fluorine, nickel, aluminum, zirconium, titanium, vanadium, iron, manganese, chromium, niobium, arsenic, zinc, silicon, sulfur, phosphorus, boron, barium, bromine, and beryllium are preferably used.

That is, for the positive electrode active material 10, one or more of lithium cobalt oxide containing magnesium, lithium cobalt oxide containing magnesium and aluminum, lithium cobalt oxide containing magnesium and nickel, lithium cobalt oxide containing magnesium, aluminum, and nickel, lithium cobalt oxide containing magnesium and fluorine, lithium cobalt oxide containing magnesium, fluorine, and nickel, lithium cobalt oxide containing magnesium, fluorine, nickel, and aluminum, and the like can be used.

As the positive electrode active material 10 in a lithium-ion secondary battery, any one or more of a positive electrode active material containing cobalt, oxygen, and magnesium; a positive electrode active material containing cobalt, oxygen, magnesium, and aluminum; a positive electrode active material containing cobalt, oxygen, magnesium, and nickel; a positive electrode active material containing cobalt, oxygen, magnesium, aluminum, and nickel; a positive electrode active material containing cobalt, oxygen, magnesium, and fluorine; a positive electrode active material containing cobalt, oxygen, magnesium, fluorine, and aluminum; a positive electrode active material containing cobalt, oxygen, magnesium, fluorine, and nickel; a positive electrode active material containing cobalt, oxygen, magnesium, fluorine, nickel, and aluminum; and the like can be used.

The additive element A is preferably dissolved in the positive electrode active material 10 so as to make a solid solution. For example, in STEM-EDX linear analysis, a position where the detection of the additive element A in the depth direction begins is preferably at a deeper level than a position where the detection of the transition metal M begins, i.e., on the inner portion side of the positive electrode active material 10.

Such an additive element A further stabilizes the crystal structure of the positive electrode active material 10 as described later.

Note that as the additive element A, magnesium, fluorine, nickel, aluminum, zirconium, vanadium, iron, manganese, chromium, niobium, arsenic, zinc, silicon, sulfur, phosphorus, boron, barium, bromine, or beryllium is not necessarily contained.

When the positive electrode active material 10 is substantially free from manganese, for example, the above advantages such as relatively easy synthesis, easy handling, and excellent cycle performance are enhanced. The weight of manganese contained in the positive electrode active material 10 is preferably less than or equal to 600 ppm, further preferably less than or equal to 100 ppm, for example.

The surface portion 10a is a region from which lithium ions are extracted first in charging, and tends to have a lower lithium concentration than the inner portion 10b. It can be said that bonds between atoms are partly cut on the surface of the particle of the positive electrode active material 10 included in the surface portion 10a. Therefore, the surface portion 10a is regarded as a region which is likely to be unstable and in which degradation of the crystal structure is likely to begin. Meanwhile, if the surface portion 10a can have sufficient stability, the layered structure, which is formed of octahedrons of cobalt and oxygen, of the inner portion 10b is difficult to break even when x in LiₓCoO₂ is small, e.g., 0.24 or less. Furthermore, a shift in layers, which are formed of octahedrons of cobalt and oxygen, of the inner portion 10b can be suppressed.

To obtain a stable crystal structure of the surface portion 10a, the surface portion 10a preferably contains the additive element A, further preferably a plurality of the additive elements A. The surface portion 10a preferably has a higher concentration of one or more selected from the additive elements A than the inner portion 10b. The one or more of the additive elements A contained in the positive electrode active material 10 preferably have a concentration gradient. In addition, it is further preferable that the additive elements A contained in the positive electrode active material 10 be differently distributed. For example, it is preferable that the additive elements A exhibit concentration peaks at different depths from a surface. The concentration peak here refers to the local maximum value of the concentration in the surface portion 10a or the concentration in a portion ranging from the surface to 50 nm or less.

### [Distribution]

Distributions of the additive elements A are described. FIGS. 9A to 9C illustrate the edge region 10a1 of the positive electrode active material 10. FIGS. 9D to 9F illustrate the basal region 10a2 of the positive electrode active material 10.

For example, one or more of the additive elements A such as magnesium, fluorine, silicon, phosphorus, titanium, boron, and calcium preferably have a concentration gradient as illustrated by gradation in FIGS. 9A and 9D, in which the concentration increases from the inner portion 10b toward the surface. The one or more of the additive elements A which have such a concentration gradient are referred to as an additive element X. The additive element X corresponds to the additive element A1 in many cases, but does not necessarily correspond to the additive element A1. The concentration gradient as illustrated by gradation in FIGS. 9A and 9D can be obtained depending on the diffusion rate, not on the timing of addition, of the additive element.

Another additive element A such as aluminum or manganese preferably has a concentration gradient as illustrated by hatching in FIGS. 9B and 9E and exhibits a concentration peak in a deeper region than a concentration peek of the additive element X shown in FIGS. 9A and 9D. The concentration peak may be observed in the surface portion 10a or observed in a region deeper than the surface portion 10a. For example, the peak is preferably observed in a region between 5 nm and 30 nm, both inclusive, from the surface toward the inner portion. An additive element which has such a concentration gradient is referred to as an additive element Y. The additive element Y corresponds to the additive element A2 in many cases, but does not necessarily correspond to the additive element A2. The concentration gradient in which the concentration at the boundary portion between the surface portion 10a and the inner portion 10b is high, as illustrated by the hatching density in FIGS. 9B and 9E, can be obtained depending on the diffusion rate, not on the timing of addition, of the additive element.

Another additive element such as nickel or barium is clearly included in the edge region 10a1 but is not substantially included in the basal region 10a2, in some cases, as illustrated by the presence or absence of hatching and the density of the hatching in FIGS. 9C and 9F. Note that here, “clearly included” means a case where the energy spectrum of characteristic X-ray of the element is detected in cross-sectional STEM-EDX analysis of the positive electrode active material 10. Note that here, “not substantially included” means a case where the energy spectrum of characteristic X-ray of the element is not detected in cross-sectional STEM-EDX analysis of the positive electrode active material 10. This is also expressed as that the amount of the element is below the lower detection limit in STEM-EDX analysis. This is also expressed as that the amount of the element is below the lower detection limit in STEM-EDX analysis. An additive element which has such distribution is referred to as an additive element Z. The additive element Z corresponds to the additive element A2 in many cases, but does not necessarily correspond to the additive element A2. The concentration gradient as illustrated by the hatching density in FIGS. 9B and 9E can be obtained depending on the diffusion rate, not on the timing of addition, of the additive element.

Magnesium, which is an example of the additive element X, is divalent, and a magnesium ion is more stable in lithium sites than in cobalt sites in a layered rock-salt crystal structure; thus, magnesium is likely to enter lithium sites. An appropriate concentration of magnesium in lithium sites of the surface portion 10a facilitates maintenance of the layered rock-salt crystal structure. This is probably because magnesium in lithium sites serves as a column supporting the CoO₂ layers. Moreover, magnesium can inhibit extraction of oxygen therearound in a state where x in LiₓCoO₂ is, for example, 0.24 or less. The presence of magnesium is also expected to increase the density of the positive electrode active material 10. In addition, a high magnesium concentration in the surface portion 10a can be expected to increase the corrosion resistance to hydrogen fluoride generated by the decomposition of the electrolyte solution.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters cobalt sites as well as lithium sites. Moreover, an excess magnesium compound (e.g., an oxide or a fluoride) which is substituted for neither the lithium site nor the cobalt site might segregate at the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters lithium sites and the amount of lithium contributing to charging and discharging decreases.

Thus, the entire positive electrode active material 10 preferably contains an appropriate amount of magnesium. The number of magnesium atoms is preferably greater than or equal to 0.001 times and less than or equal to 0.1 times, further preferably greater than 0.01 times and less than 0.04 times, still further preferably approximately 0.02 times the number of cobalt atoms, for example. The amount of magnesium in the entire positive electrode active material 10 may be a value obtained by performing element analysis on the entire positive electrode active material 10 using glow discharge mass spectrometry (GD-MS), inductively coupled plasma mass spectrometry (ICP-MS), or the like, or may be a value based on the ratio of the raw materials mixed in the process of forming the positive electrode active material 10, for example.

Aluminum, which is an example of the additive element Y, can be present in a cobalt site in a layered rock-salt crystal structure. Since aluminum is a trivalent representative element and its valence does not change, lithium around aluminum is less likely to move even in charging and discharging. Thus, aluminum and lithium around aluminum serve as columns to suppress a change in the crystal structure. Furthermore, aluminum has an effect of inhibiting dissolution of cobalt around aluminum and improving cycle performance. Moreover, an Al—O bond is stronger than a Co—O bond and thus extraction of oxygen around aluminum can be inhibited. These effects improve thermal stability. Therefore, a secondary battery that includes the positive electrode active material 10 containing aluminum as the additive element Y can have higher level of safety. In addition, the positive electrode active material 10 having a crystal structure that is unlikely to be broken by repeated charging and discharging can be provided.

Meanwhile, excess aluminum is liable to adversely affect insertion and extraction of lithium.

Thus, the entire positive electrode active material 10 preferably contains an appropriate amount of aluminum. For example, in the entire positive electrode active material 10, the number of aluminum atoms is preferably higher than or equal to 0.05% and lower than or equal to 4%, further preferably higher than or equal to 0.1% and lower than or equal to 2%, still further preferably higher than or equal to 0.3% and lower than or equal to 1.5% of the number of cobalt atoms. The above numerical range is preferably greater than or equal to 0.05% and less than or equal to 2%. The above numerical range is preferably greater than or equal to 0.1% and less than or equal to 4%. Here, the amount of an element contained in the entire positive electrode active material 10 may be a value obtained by performing element analysis on the entire positive electrode active material 10 with GD-MS, ICP-MS, or the like or may be a value based on the ratio of materials mixed in the process of forming the positive electrode active material 10, for example.

Nickel, which is an example of the additive element Z, can be present in both the cobalt site and the lithium site. Nickel is preferably present in the cobalt site because a lower oxidation-reduction potential can be obtained as compared with the case where only cobalt is present in the cobalt site, leading to an increase in discharge capacity.

In addition, when nickel is present in a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel in lithium sites also serves as a column supporting the CoO₂ layers. Therefore, in particular, the crystal structure is expected to be more stable in a charged state at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 10 preferably contains an appropriate amount of nickel. For example, in the positive electrode active material 10, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. The above numerical range is preferably greater than 0% and less than or equal to 4%. The above numerical range is preferably greater than 0% and less than or equal to 2%. The above numerical range is preferably greater than or equal to 0.05% and less than or equal to 7.5%. The above numerical range is preferably greater than or equal to 0.05% and less than or equal to 2%. The above numerical range is preferably greater than or equal to 0.1% and less than or equal to 7.5%. The above numerical range is preferably greater than or equal to 0.1% and less than or equal to 4%. The amount of nickel described here may be a value obtained by performing element analysis on the entire positive electrode active material with GD-MS, ICP-MS, or the like or may be a value based on the ratio of materials mixed in the process of forming the positive electrode active material, for example.

When fluorine, which is a monovalent anion and is an example of the additive element X, is substituted for part of oxygen in the surface portion 10a, the lithium extraction energy is lowered. This is because the change in valence of cobalt ions associated with lithium extraction is from trivalent to tetravalent in the case of not containing fluorine and from divalent to trivalent in the case of containing fluorine, and the oxidation-reduction potential differs therebetween. It can thus be said that when fluorine is substituted for part of oxygen in the surface portion 10a of the positive electrode active material 10, lithium ions near fluorine are likely to be extracted and inserted smoothly. Thus, a secondary battery including the positive electrode active material 10 can have improved charge and discharge characteristics, improved large current characteristics, or the like. When fluorine is included in the surface portion 10a, which has a surface in contact with the electrolyte solution, the corrosion resistance to hydrofluoric acid can be effectively increased. As described in Embodiment 1, a fluoride such as lithium fluoride that has a lower melting point than a different additive element source can serve as a fusing agent (also referred to as a flux) for lowering the melting point of the different additive element source.

As illustrated in FIGS. 9A and 9C, when the surface portion 10a contains both magnesium and nickel, divalent nickel can be present more stably in the vicinity of divalent magnesium. Thus, magnesium can be inhibited from being dissolved out even when x in LiₓCoO₂ is small. This can contribute to stabilization of the surface portion 10a.

Additive elements that are differently distributed, such as the additive elements X, Y, and Z, are preferably contained together, in which case the crystal structure of a wider region can be stabilized. For example, the crystal structure of a wider region can be stabilized in the case where the positive electrode active material 10 contains all of magnesium, which is an example of the additive element X; aluminum, which is an example of the additive element Y; and nickel, which is an example of the additive element Z as compared with the case where only one or two of the additive elements X, Y, and Z are contained. In the case where the positive electrode active material 10 contains all of the additive elements X, Y, and Z as described above, the surface can be sufficiently stabilized by the additive element X such as magnesium and the additive element Z such as nickel; thus, the additive element Y such as aluminum is not necessary for the surface. It is preferable that aluminum be widely distributed in a deeper region. For example, it is preferable that aluminum be continuously detected in a region extending from the surface to a depth of 1 nm to 25 nm, both inclusive. It is preferable that aluminum be widely distributed in such a manner because the crystal structure in a wider region can be stabilized.

In the case where a large amount of the additive element Z is contained in the edge region 10a1 than in the basal region 10a2 (also referred to as preferentially contained, selectively contained, or the like) as illustrated in FIGS. 9C and 9F, the stability of the crystal structure of the edge region 10a1 for insertion and extraction of lithium ions into/from the positive electrode active material 10 in charging and discharging of a lithium-ion battery is increased, which is preferable. In the case where the additive element Z has such distribution, for example, when the positive electrode active material 10 is lithium cobalt oxide, an influence of adding the additive element Z, such as a decrease in discharge voltage or a decrease in discharge capacity, can be kept to the minimum, which is preferable.

When the plurality of additive elements are contained as described above, the effects of the additive elements can contribute synergistically to further stabilization of the surface portion 10a. In particular, magnesium, nickel, and aluminum are preferably contained, in which case a high effect of stabilizing the composition and the crystal structure can be obtained. In particular, the surface portion 10a of the positive electrode active material 10 preferably includes a region where distribution of magnesium is closer to the surface than distribution of aluminum. Furthermore, in addition to the above distribution regions of magnesium and aluminum, a region where the distribution of nickel and the distribution of magnesium overlap with each other is most preferably included in the edge region 10a1 in the surface portion 10a of the positive electrode active material 10.

### <Crystal Structure>

<x in LiXCoO₂ being 1>

The positive electrode active material 10 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure has high discharge capacity and a two-dimensional diffusion path for lithium ions and is thus suitable for an insertion/extraction reaction of lithium ions, and is favorably used as a positive electrode active material of a secondary battery accordingly. For this reason, it is particularly preferable that the inner portion 10b, which accounts for the majority of the volume of the positive electrode active material 10, have a layered rock-salt crystal structure.

Meanwhile, the surface portion 10a of the positive electrode active material 10 of one embodiment of the present invention preferably has a function of reinforcing the layered structure, which is formed of octahedrons of the transition metal M and oxygen, of the inner portion 10b so that the layered structure does not break even when lithium is extracted from the positive electrode active material 10 by charging. In addition, the surface portion 10a preferably functions as a barrier film of the positive electrode active material 10. Moreover, the surface portion 10a, which is the outer portion of the positive electrode active material 10, preferably reinforces the positive electrode active material 10. Here, the term “reinforce” means inhibition of a change in the structures of the surface portion 10a and the inner portion 10b of the positive electrode active material 10 such as extraction of oxygen and/or inhibition of oxidative decomposition of an electrolyte solution on the surface of the positive electrode active material 10.

Accordingly, the surface portion 10a preferably has a crystal structure different from that of the inner portion 10b. The surface portion 10a preferably has a more stable composition and a more stable crystal structure than those of the inner portion 10b at room temperature (25° C.). For example, at least part of the surface portion 10a of the positive electrode active material 10 of one embodiment of the present invention preferably has a rock-salt crystal structure. In addition, the surface portion 10a preferably has both a layered rock-salt crystal structure and a rock-salt crystal structure. Alternatively, the surface portion 10a preferably has features of both a layered rock-salt crystal structure and a rock-salt crystal structure.

It is preferable that some additive elements A, in particular, magnesium, nickel, and aluminum have higher concentrations in the surface portion 10a than in the inner portion 10b and are present randomly also in the inner portion 10b at low concentrations. When magnesium and aluminum are present at lithium sites of the inner portion 10b at appropriate concentrations, an effect of facilitating maintenance of the layered rock-salt crystal structure can be obtained in a manner similar to the above. When nickel is present in the inner portion 10b at an appropriate concentration, a shift in the layered structure formed of octahedrons of the transition metal M and oxygen can be inhibited in a manner similar to the above. Also in the case where both magnesium and nickel are contained, a synergistic effect of inhibiting dissolution of magnesium can be expected since divalent magnesium can be present more stably in the vicinity of divalent nickel.

It is preferable that the crystal structure continuously change from the inner portion 10b toward the surface owing to the above-described concentration gradient of the additive element A. Alternatively, it is preferable that the orientations of a crystal in the surface portion 10a and a crystal in the inner portion 10b be substantially aligned with each other.

For example, a crystal structure preferably changes continuously from the inner portion 10b that has a layered rock-salt crystal structure toward the surface and the surface portion 10a that have a rock-salt crystal structure or both a rock-salt crystal structure and a layered rock-salt crystal structure. Alternatively, the crystal orientation in the surface portion 10a that has the rock-salt crystal structure or both the rock-salt crystal structure and the layered rock-salt crystal structure and the crystal orientation in the layered rock-salt inner portion 10b are preferably substantially aligned with each other.

Note that in this specification and the like, a layered rock-salt crystal structure, which belongs to the space group R-3m, of a composite oxide containing lithium and a transition metal M such as cobalt refers to a crystal structure in which a rock-salt ion arrangement where cations and anions are alternately arranged is included and lithium and the transition metal M are regularly arranged to form a two-dimensional plane, so that lithium can diffuse two-dimensionally. Note that a defect such as a cation or anion vacancy may be present. Moreover, in the layered rock-salt crystal structure, strictly, a lattice of the rock-salt crystal structure is distorted and the symmetry of the layered rock-salt crystal structure is inferior to that of the rock-salt crystal structure in some cases.

A rock-salt crystal structure is a structure in which a cubic crystal structure such as a crystal structure belonging to a space group Fm-3m is included and cations and anions are alternately arranged. Note that a cation or anion vacancy may be present.

It can be confirmed with electron diffraction, a TEM image, a cross-sectional STEM image, or the like whether both a layered rock-salt crystal structure and a rock-salt crystal structure are included.

There is no distinction among cation sites in a rock-salt crystal structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is common to a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in a rock-salt crystal structure in an ideal state, for instance, and on the (003) plane in a layered rock-salt crystal structure in an ideal state, for instance. For example, when electron diffraction patterns of rock-salt MgO and layered rock-salt LiCoO₂ are compared to each other, the distance between the bright spots on the (003) plane of LiCoO₂ is observed at a position approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image or the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal, which is described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

<x in LiₓCoO₂ is Small>

In the crystal structure in a state where x in LiₓCoO₂ is small of the positive electrode active material 10 of one embodiment of the present invention, magnesium in lithium sites has an effect of maintaining a layered rock-salt crystal structure belonging to R-3m, unlike in that of a conventional positive electrode active material, because the positive electrode active material 10 has the above-described distribution of the additive element A and/or the crystal structure in a discharged state. Here, “x is small” means 0.1<x<0.24.

A conventional positive electrode active material and the positive electrode active material 10 of one embodiment of the present invention are compared, and changes in the crystal structures owing to a change in x in LiₓCoO₂ will be described with reference to FIGS. 10 to 13.

A change in the crystal structure of the conventional positive electrode active material is illustrated in FIG. 11. The conventional positive electrode active material illustrated in FIG. 11 is lithium cobalt oxide (LiCoO₂) containing no additive element A.

In FIG. 11, the crystal structure of lithium cobalt oxide with x in LiₓCoO₂ being 1 is denoted by R-3m O3. In this crystal structure, lithium occupies octahedral sites and a unit cell includes three CoO₂ layers. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 m1 and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that the number of cobalt atoms per unit cell in the actual H1-3 type structure is twice that in other structures. However, in this specification, FIG. 11, and other drawings, the c-axis of the H1-3 type structure is half that of the unit cell for easy comparison with the other crystal structures.

For the H1-3 type structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A unit cell suitable for representing a crystal structure in a positive electrode active material can be selected by Rietveld analysis of XRD patterns, for example. In that case, a unit cell having a small value of goodness of fit (GOF) can be used.

When charging that makes x in LiₓCoO₂ be 0.24 or less and discharging are repeated, the crystal structure of conventional lithium cobalt oxide repeatedly changes between the R-3m O3 type structure in a discharged state and the H1-3 type structure (i.e., an unbalanced phase change).

However, there is a large shift in the CoO₂ layers between these two crystal structures. As denoted by the dotted lines and the arrows in FIG. 11, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. When the H1-3 type structure and the R-3m O3 type structure in a discharged state contain the same number of cobalt atoms, these structures have a difference in volume of greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites which lithium can occupy stably and makes it difficult to insert and extract lithium.

Meanwhile, in the positive electrode active material 10 of one embodiment of the present invention shown in FIG. 10, a change in the crystal structure between a discharged state with x in LiₓCoO₂ of 1 and a state with x of 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 10 of one embodiment of the present invention can have a crystal structure that is difficult to break even when charging that makes x be 0.24 or less and discharging are repeated, and obtain excellent cycle performance. In addition, the positive electrode active material 10 of one embodiment of the present invention with x in LiₓCoO₂ of 0.24 or less can have a more stable crystal structure than a conventional positive electrode active material. Thus, in the positive electrode active material 10 of one embodiment of the present invention, a short circuit is less likely to occur in a state where x in LiₓCoO₂ is kept at 0.24 or less. This is preferable because the safety of a secondary battery is further improved.

FIG. 10 illustrates crystal structures of the inner portion 10b of the positive electrode active material 10 in states where x in LiₓCoO₂ is 1 and approximately 0.2. The inner portion 10b, accounting for the majority of the volume of the positive electrode active material 10, largely contributes to charging and discharging and is accordingly a portion where a shift in CoO₂ layers and a volume change matter most.

The positive electrode active material 10 with x of 1 has the R-3m O3 type structure, which is the same as that of conventional lithium cobalt oxide.

However, in a state where x is 0.24 or less, e.g., approximately 0.2 or approximately 0.12, the positive electrode active material 10 has a crystal structure different from the H1-3 type structure of conventional lithium cobalt oxide.

The positive electrode active material 10 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 10, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (x 10⁻¹ nm), further preferably 2.807≤a≤2.827 (x 10⁻¹ nm), typically a=2.817 (x 10⁻¹ nm). The lattice constant of the c-axis is preferably 13.681≤c≤13.881 (x 10⁻¹ nm), further preferably 13.751≤c≤13.811 (x 10⁻¹ nm), typically, c=13.781 (x 10⁻¹ nm).

In the O3′ type structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 10, the CoO₂ layers hardly shift between the R-3m (O3) type structure in a discharged state and the O3′ type structure.

The R-3m (O3) type structure in a discharged state and the O3′ type structure that contain the same number of cobalt atoms have a difference in volume of 2.5% or less, specifically 2.2% or less, typically 1.8%.

As described above, in the positive electrode active material 10 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is reduced. Thus, the crystal structure of the positive electrode active material 10 is less likely to break even when charging that makes x be 0.24 or less and discharging are repeated. Therefore, the positive electrode active material 10 inhibits a decrease in charge and discharge capacity in charge and discharge cycle. Furthermore, the positive electrode active material 10 can stably use a larger amount of lithium than a conventional positive electrode active material and thus enables large discharge capacity per weight and per volume. Thus, with the use of the positive electrode active material 10, a secondary battery with large discharge capacity per weight and per volume can be manufactured.

Note that the positive electrode active material 10 is confirmed to have the O3′ type structure in some cases when x in LiₓCoO₂ is greater than or equal to 0.15 and less than or equal to 0.24, and is inferred to have the O3′ type structure even when x is greater than 0.24 and less than or equal to 0.27. However, the crystal structure is influenced by not only x in LiₓCoO₂ but also the number of charge-discharge cycles, a charge current and a discharge current, temperature, an electrolyte solution, and the like, so that the range of x is not limited to the above.

Hence, when x in LiₓCoO₂ in the positive electrode active material 10 is greater than 0.1 and less than or equal to 0.24, not all of the inner portion 10b of the positive electrode active material 10 has to have the O3′ type structure. The inner portion may partly have another crystal structure or be partly amorphous.

In order to make x in LiₓCoO₂ small, charging at a high charge voltage is necessary in general. Therefore, the state where x in LiₓCoO₂ is small can be rephrased as a state where charging at a high charge voltage has been performed. For example, when constant current/constant voltage (CC/CV) charging is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal.

That is, the positive electrode active material 10 of one embodiment of the present invention is preferable because the positive electrode active material 10 can maintain the R-3m O3 type structure having symmetry even when charging at a high charge voltage, e.g., 4.6 V or higher at 25° C., is performed. Moreover, the positive electrode active material 10 of one embodiment of the present invention is preferable because the O3′ type structure can be obtained when charging at a higher charge voltage, e.g., a voltage higher than or equal to 4.65 V and lower than or equal to 4.7 V is performed at 25° C.

At a far higher charge voltage, the H1-3 type structure is eventually observed in the positive electrode active material 10 in some cases. As described above, the crystal structure is affected by the number of charge-discharge cycles, a charge current and a discharge current, temperature, an electrolyte solution, and the like, so that the positive electrode active material 10 of one embodiment of the present invention sometimes has the O3′ type structure even at a lower charge voltage, e.g., a charge voltage higher than or equal to 4.5 V and lower than 4.6 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a similar crystal structure is obtained at a voltage corresponding to a difference between the above-described voltage and the potential of the graphite.

Although lithium occupies all lithium sites in the O3′ type structure with an equal probability in the illustration of FIG. 10, the present invention is not limited thereto. Lithium may occupy unevenly only some of the lithium sites. For example, lithium may be symmetrically present as in the monoclinic O1 type structure (Li_{0.5}CoO₂) in FIG. 11. Distribution of lithium can be analyzed by neutron diffraction, for example.

The O3′ type structure can be regarded as a crystal structure that contains lithium between layers randomly and is similar to a CdCl₂ crystal structure. The crystal structure similar to the CdCl₂ crystal structure is close to a crystal structure of lithium nickel oxide when charging is performed until Li_{0.06}NiO₂ is obtained; however, pure lithium cobalt oxide or a layered rock-salt positive electrode active material containing a large amount of cobalt is known not to have the CdCl₂ crystal structure generally.

The concentration gradient of the additive element A is preferably similar in a plurality of parts of the surface portion 10a of the positive electrode active material 10. In other words, it is preferable that the reinforcement owing to the additive element A be uniformly enabled in the surface portion 10a. Even when the surface portion 10a partly has reinforcement, stress might be concentrated on parts that do not have reinforcement. The concentration of stress on a part of the positive electrode active material 10 might cause defects such as cracks from the part, leading to cracking of the positive electrode active material and a decrease in discharge capacity undesirably.

Note that the additive element A does not necessarily have similar concentration gradients throughout the surface portion 10a of the positive electrode active material 10. The additive element A preferably has the distribution of the additive element X illustrated in FIG. 9A in the edge region 10a1 and the distribution of the additive element Y illustrated in FIG. 9E in the basal region 10a2.

Here, the portion near the line C-D has a layered rock-salt crystal structure belonging to R-3m and the surface of the portion has a (00l) orientation. The distribution of the additive element A at the surface having the (00l) orientation may be different from that at other surfaces. For example, concentration peaks of one or more selected from the additive elements A may be distributed shallower from the surface having the (00l) orientation and the surface portion 10a thereof than from a surface having an orientation other than the (00l) orientation. Alternatively, the surface having the (00l) orientation and the surface portion 10a thereof may have a lower concentration of one or more selected from the additive elements A than a surface having an orientation other than the (00l) orientation. Further alternatively, at the surface having the (00l) orientation and the surface portion 10a thereof, the concentration of one or more selected from the additive elements A may be below the lower detection limit.

In a layered rock-salt crystal structure belonging to R-3m, cations are arranged parallel to the (00l) plane. In other words, a CoO₂ layer and a lithium layer are alternately stacked parallel to the (00l) plane. Accordingly, a diffusion path of lithium ions is also parallel to the (00l) plane.

The CoO₂ layer is relatively stable and thus, the surface of the positive electrode active material 10 is more stable when having the (00l) orientation. A main diffusion path of lithium ions in charging and discharging is not exposed at the (00l) plane.

By contrast, a diffusion path of lithium ions is exposed at a surface having an orientation other than the (00l) orientation. Thus, the surface having an orientation other than the (00l) orientation and the surface portion 10a thereof easily lose stability because they are regions where extraction of lithium ions starts as well as important regions for maintaining a diffusion path of lithium ions. Thus, for maintaining the crystal structure of the entire positive electrode active material 10, it is very important to reinforce the surface having an orientation other than the (00l) orientation and the surface portion 10a.

### <Crystal Grain Boundary>

It is further preferable that the additive element A contained in the positive electrode active material 10 of one embodiment of the present invention have the above-described distribution and be at least partly unevenly distributed at the crystal grain boundary and the vicinity thereof, that is, be at a high concentration.

Note that in this specification and the like, uneven distribution means that the concentration of an element in a certain region differs from those in other regions. This may be rephrased as segregation, precipitation, unevenness, deviation, or a mixture of a high-concentration portion and a low-concentration portion.

For example, the magnesium concentration at the crystal grain boundary and the vicinity thereof in the positive electrode active material 10 is preferably higher than that in the other regions in the inner portion 10b. In addition, the fluorine concentration at the crystal grain boundary and the vicinity thereof is preferably higher than that in the other regions in the inner portion 10b. In addition, the nickel concentration at the crystal grain boundary and the vicinity thereof is preferably higher than that in the other regions in the inner portion 10b. In addition, the aluminum concentration at the crystal grain boundary and the vicinity thereof is preferably higher than that in the other regions in the inner portion 10b.

A crystal grain boundary is regarded as a plane defect. Thus, the crystal grain boundary tends to be unstable and the crystal structure easily starts to change like the surface of the particle. Thus, the higher the concentration of the additive element A at the crystal grain boundary and the vicinity thereof is, the more effectively the change in the crystal structure can be inhibited.

When the magnesium concentration and the fluorine concentration are high at the crystal grain boundary and the vicinity thereof, the magnesium concentration and the fluorine concentration in the vicinity of a surface generated by a crack are also high even when the crack is generated along the crystal grain boundary of the positive electrode active material 10 of one embodiment of the present invention. Thus, the positive electrode active material including a crack can also have an increased corrosion resistance to hydrofluoric acid.

### <Analysis Method>

Whether or not a positive electrode active material is the positive electrode active material 10 of one embodiment of the present invention, which has the O3′ type structure when x in LiₓCoO₂ is small, can be determined by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. Among some kinds of XRD, peaks appearing in powder XRD patterns can reflect the crystal structure of the inner portion 10b of the positive electrode active material 10, which accounts for the majority of the volume of the positive electrode active material 10.

In the case where the crystallite size is measured by powder XRD, the measurement is preferably performed while the influence of orientation of positive electrode active material particles due to pressure or the like is removed. For example, it is preferable that the positive electrode active material be taken out from a positive electrode obtained from a disassembled secondary battery, the positive electrode active material be made into a powder sample, and then the measurement be performed.

As described above, the feature of the positive electrode active material 10 of one embodiment of the present invention is a small change in the crystal structure between a state with x in LiₓCoO₂ of 1 and a state with x in LiₓCoO₂ of 0.24 or less. A positive electrode active material 50 wt % or more of which has the crystal structure to be largely changed by high-voltage charging is not preferred because the positive electrode active material cannot withstand repetition of high-voltage charging and discharging.

It should be noted that the O3′ type structure is not obtained in some cases only by addition of the additive element A. For example, in lithium cobalt oxide containing magnesium and fluorine or lithium cobalt oxide containing magnesium and aluminum in a state with x in LiₓCoO₂ of 0.24 or less, the proportion of the O3′ type structure to the total of the O3′ type structure and the H1-3 type structure is 60 wt % or more in some cases, and the proportion of the H1-3 type structure to the total of the O3′ type structure and the H1-3 type structure is 50 wt % or more in other cases

In addition, in a state where x is too small, e.g., 0.1 or less, or in the case where a charge voltage is higher than 4.9 V, the positive electrode active material 10 of one embodiment of the present invention sometimes may have the H1-3 type structure or the trigonal O1 type structure. Thus, to determine whether or not a positive electrode active material is the positive electrode active material 10 of one embodiment of the present invention, analysis of the crystal structure by a method such as XRD and data such as charge capacity or charge voltage are needed.

Note that the crystal structure of a positive electrode active material in a state with small x may be changed when the positive electrode active material is exposed to the air. For example, the O3′ type structure changes into the H1-3 type structure in some cases. For that reason, all samples to be used for analysis of the crystal structure are preferably handled in an inert atmosphere such as an argon atmosphere.

Whether the additive element A contained in a positive electrode active material has the above-described distribution can be determined by analysis using XPS, EDX, an electron probe microanalyzer (EPMA), or the like.

The crystal structure of a crystal grain boundary or the like can be analyzed by electron diffraction of a cross section of the positive electrode active material 10, for example.

### <Charging Method>

Whether or not a composite oxide is the positive electrode active material 10 of one embodiment of the present invention can be determined in the following manner: for example, a CR2032 coin cell (with a diameter of 20 mm and a height of 3.2 mm) is formed using a composite oxide for a positive electrode and a lithium metal for a counter electrode, and is charged. The coin cell includes an electrolyte solution, a separator, a positive electrode can, and a negative electrode can. The coin cell used for determining whether or not the composite oxide is the positive electrode active material 10 does not need to include the separator and the electrolyte solution of one embodiment of the present invention.

More specifically, a positive electrode can be formed by application of a slurry in which the positive electrode active material, a conductive material, and a binder are mixed to a positive electrode current collector made of aluminum foil. The slurry mentioned here refers to a material solution that is used to form an active material layer over the positive electrode current collector and contains an active material, a binder, and a solvent, preferably further contains a conductive material mixed therein.

A lithium metal can be used for a counter electrode. Note that when the counter electrode is formed using a material other than the lithium metal, the value of voltage of a secondary battery differs from the value of the potential of the positive electrode. Unless otherwise specified, the voltage and the potential in this specification and the like refer to the potential of a positive electrode.

As the electrolyte solution, a mixed solvent in which ethylene carbonate (EC) and diethyl carbonate (DEC) are mixed at a volume ratio of 3:7 and to which 2 wt % of vinylene carbonate (VC) is added can be used. As the lithium salt contained in the electrolyte solution, 1 mol of lithium hexafluorophosphate (LiPF₆) per liter of the mixed solvent containing vinylene carbonate can be used.

As a separator, a 25-μm-thick polypropylene porous film can be used. For the separator, another material may be used, other than polypropylene.

Stainless steel (SUS) can be used for a positive electrode can and a negative electrode can.

The coin cell obtained with the above conditions is charged with a given voltage (e.g., 4.5 V, 4.55 V, 4.58 V, 4.60 V, 4.62 V, 4.65 V, 4.7 V, 4.75 V, or 4.8 V). The charging method is not particularly limited as long as charging with a given voltage can be performed for sufficient time. In the case of CC/CV charging, for example, CC charging can be performed with a current higher than or equal to 20 mA/g and lower than or equal to 100 mA/g, and CV charging can be ended with a current higher than or equal to 2 mA/g and lower than or equal to 10 mA/g. To observe a phase change of the positive electrode active material, charging with such a small current value is preferably performed. The temperature is set to 25° C. or 45° C. After the coin cell is charged in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere for various kinds of analysis to be performed later. For example, XRD can be performed on the positive electrode active material enclosed in an airtight container with an argon atmosphere. After the charging is completed, the positive electrode is preferably taken out immediately and analyzed. Specifically, the positive electrode is preferably analyzed within an hour after the completion of the charging, further preferably 30 minutes after the completion of the charging.

In the case where the crystal structure in a charged state after multiple-time charging and discharging is analyzed, the charging and discharging can be performed in the following manner. As charging, constant current charging is performed with a current value greater than or equal to 20 mA/g and less than or equal to 100 mA/g until the voltage reaches a given value (e.g., 4.50 V, 4.55 V, 4.58 V, 4.60 V, 4.62 V, 4.65 V, 4.70 V, 4.75 V, or 4.80 V), and then constant voltage charging is performed until the current value becomes greater than or equal to 2 mA/g and less than or equal to 10 mA/g; as discharging, constant current discharging is performed with a current value greater than or equal to 20 mA/g and less than or equal to 100 mA/g until the voltage reaches 2.5 V. Alternatively, as discharging, constant current discharging can be performed with a current value greater than or equal to 20 mA/g and less than or equal to 200 mA/g until the voltages reaches 3.0 V.

Also in the case where the crystal structure in a discharged state after multiple-time charging and discharging is analyzed, constant current discharging can be performed with a current value greater than or equal to 20 mA/g and less than or equal to 200 mA/g until the voltage reaches 2.5 V, for example. Alternatively, constant current discharging can be performed with a current value greater than or equal to 20 mA/g and less than or equal to 200 mA/g until the voltage reaches 3.0 V.

### <XRD>

The apparatus and conditions adopted in the XRD measurement are not particularly limited. The measurement can be performed with the apparatus and conditions as described below, for example.
XRD apparatus: D8 ADVANCE (Bruker AXS)
X-ray source: CuKα₁ radiation
Output: 40 kV, 40 mA
Slit width: Div. Slit, 0.5°
Detector: LynxEye
Scanning method: 2θ/θ continuous scanning
Measurement range (2θ): from 15° to 90°, both inclusive
Step width (2θ): 0.010
Counting time: 1 second/step
Rotation of sample stage: 15 rpm.

In the case where the measurement sample is a powder, the sample can be set by, for example, being put in a glass sample holder or being sprinkled on a reflection-free silicon plate to which grease is applied. In the case where the measurement sample is a positive electrode, the positive electrode can be attached to a substrate with a double-sided adhesive tape, and the positive electrode active layer can be set at the level of a measurement plane required by the apparatus.

FIG. 12 and FIG. 13 show ideal powder XRD patterns with CuKα₁ radiation that are calculated from models of the O3′ type structure and the H1-3 type structure. For comparison, ideal XRD patterns calculated from the crystal structure of LiCoO₂ (O3) with x in LiₓCoO₂ of 1 and the trigonal O1 type structure with x of 0 are also shown. Note that the patterns of LiCoO₂ (O3) and CoO₂ (O1) are made on the basis of crystal structure data obtained from ICSD with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. XRD patterns of the H1-3 type structure are made on the basis of crystal structure data of the H1-3 type structure shown in FIG. 11 in a manner similar to the above-described method. The O3′ type structure is estimated from the XRD pattern of the positive electrode active material of one embodiment of the present invention, the crystal structure is fitted with TOPAS Version 3 (crystal structure analysis software produced by Bruker Corporation), and the XRD pattern of the O3′ type structure is made in a similar manner to other structures.

As shown in FIG. 12, the O3′ type structure exhibits diffraction peaks at 2θ of 19.25±0.12° (greater than or equal to 19.13° and less than or equal to 19.37°) and 2θ of 45.47±0.100 (greater than or equal to 45.37° and less than or equal to 45.57°).

However, as shown in FIG. 13, the H1-3 type structure and the trigonal O1 type structure do not exhibit peaks at these positions. Thus, the diffraction peaks at 2θ of 19.25±0.12° (greater than or equal to 19.130 and less than or equal to 19.37°) and 2θ of 45.47±0.10° (greater than or equal to 45.37° and less than or equal to 45.57°) in a state where x in LiₓCoO₂ is small can be the features of the positive electrode active material 10 of one embodiment of the present invention.

Note that in the case where the O3′ type crystal structure is such that the value of x in LiₓCoO₂ is slightly larger than that in the XRD pattern shown in FIG. 12, observed peaks are shifted in the lower angle side from the above peaks, for example, when charging is performed with a voltage slightly lower than 4.60 V (4.56 V, 4.57 V, 4.58 V, or 4.59 V) as an upper limit of the charge voltage. For example, when the charging is performed with 4.58 V as the upper limit of the charge voltage, the positive electrode active material 10 exhibits diffraction peaks at 2θ of 18.85±0.20° and 2θ of 45.15±0.10° as diffraction peaks derived from the O3′ type crystal structure.

It can be said that, the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 10 of one embodiment of the present invention has the O3′ type structure when x in LiₓCoO₂ is small, not all the positive electrode active material 10 has to have the O3′ type structure. The positive electrode active material 10 of the present invention may include another crystal structure or may be partly amorphous. Additionally, in a plurality of the positive electrode active materials 10, a positive electrode active material having a crystal structure different from the O3′ type structure may be included. Note that when the XRD patterns are subjected to the Rietveld analysis, the proportion of the O3′ type structure is preferably higher than or equal to 50 wt %, further preferably higher than or equal to 60 wt %, still further preferably higher than or equal to 66 wt % of the crystal structures of a plurality of positive electrode active materials 10. The proportion of the O3′ type structure is higher than or equal to 50 wt %, preferably higher than or equal to 60 wt %, further preferably higher than or equal to 66 wt %, means sufficiently good cycle performance.

Furthermore, even when 5 or more cycles, 30 or more cycles, 50 or more cycles, or 100 or more cycles of charging and discharging have passed after the measurement starts, the proportion of the O3′ type structure is preferably higher than or equal to 35 wt %, further preferably higher than or equal to 40 wt %, still further preferably higher than or equal to 43 wt % of the crystal structures of a plurality of positive electrode active materials 10 in the Rietveld analysis of XRD patterns.

Sharpness of a diffraction peak in an XRD pattern indicates the degree of crystallinity. Thus, it is preferable that the diffraction peaks after charging be sharp or in other words, have a narrow half width. Even peaks that are derived from the same crystal phase have different half widths depending on the XRD measurement conditions or the 2θ value. In the case of the above-described measurement conditions, the peak observed in the 2θ range of 43° to 46°, both inclusive, preferably has a half width less than or equal to 0.2°, further preferably less than or equal to 0.15°, still further preferably less than or equal to 0.12°, for example. Note that not all peaks need to fulfill the requirement. A crystal phase can be regarded as having high crystallinity when one or more peaks derived from the crystal phase fulfill the requirement. Such high crystallinity greatly contributes to stability of the crystal structure after charging.

The crystallite size of the O3′ type structure of the positive electrode active material 10 is decreased to approximately one-twentieth that of LiCoO₂ (O3) in a discharged state. Thus, the peak of the O3′ type structure can be clearly observed when x in LiₓCoO₂ is small even under the same XRD measurement conditions as those of a positive electrode before charging and discharging. By contrast, the conventional LiCoO₂ has a small crystallite size and exhibits a broad and small peak although it might partly have a structure similar to the O3′ type structure. The crystallite size can be calculated from the half width of the XRD peak.

### <XPS>

In an inorganic oxide, a region ranging from the surface to a depth of approximately 2 nm to 8 nm (normally, less than or equal to 5 nm) can be analyzed by X-ray photoelectron spectroscopy (XPS) using monochromatic aluminum Kα radiation as an X-ray source; thus, the concentrations of elements in approximately half the depth of the surface portion 10a can be quantitatively analyzed by XPS. The bonding states of the elements can be analyzed by narrow scanning. The quantitative accuracy of XPS is about ±1 atomic % in many cases. The lower detection limit is approximately 1 atomic % but depends on the element.

In the positive electrode active material 10 of one embodiment of the present invention, the concentrations of one or more selected from the additive elements A are preferably higher in the surface portion 10a than in the inner portion 10b. This means that the concentrations of one or more selected from the additive elements A in the surface portion 10a are preferably higher than the average concentrations of the selected elements in the entire positive electrode active material 10. For this reason, for example, it is preferable that the concentrations of one or more additive elements A in the surface portion 10a, which is measured by XPS or the like, be higher than the average concentrations of the additive elements A in the entire positive electrode active material 10, which is measured by ICP-MS, GD-MS, or the like. For example, the concentration of magnesium of at least part of the surface portion 10a, which is measured by XPS or the like, is preferably higher than the average concentration of magnesium of the entire positive electrode active material 10. The concentration of nickel of at least part of the surface portion 10a is preferably higher than the average concentration of nickel of the entire positive electrode active material 10. The concentration of aluminum of at least part of the surface portion 10a is preferably higher than the average concentration of aluminum of the entire positive electrode active material 10. The concentration of fluorine of at least part of the surface portion 10a is preferably higher than the average concentration of fluorine of the entire positive electrode active material 10.

Note that the surface and the surface portion 10a of the positive electrode active material 10 of one embodiment of the present invention do not contain a carbonate, a hydroxy group, or the like which is chemically adsorbed after formation of the positive electrode active material 10. Furthermore, an electrolyte solution, a binder, a conductive material, and a compound originating from any of these that are attached to the surface of the positive electrode active material 10 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, samples of a positive electrode active material, a positive electrode active material layer, and the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element A is not easily dissolved even in that case; thus, the atomic ratio of the additive element is not affected.

The concentration of the additive element A may be compared using the ratio of the additive element A to cobalt. The use of the ratio of the additive element to cobalt is preferable because it enables comparison while reducing the influence of a carbonate or the like which is chemically adsorbed after formation of the positive electrode active material. For example, the atomic ratio of magnesium to cobalt (Mg/Co) in the XPS analysis is preferably greater than or equal to 0.400 and less than or equal to 1.20, further preferably greater than or equal to 0.500 and less than or equal to 1.00, still further preferably greater than or equal to 0.500 and less than or equal to 0.900, yet still further preferably greater than or equal to 0.500 and less than or equal to 0.700.

For example, the atomic ratio of nickel to cobalt (Ni/Co) in the XPS analysis is preferably greater than or equal to 0.050 and less than or equal to 0.200, further preferably greater than or equal to 0.050 and less than or equal to 0.150, still further preferably greater than or equal to 0.050 and less than or equal to 0.100, yet still further preferably greater than or equal to 0.500 and less than or equal to 0.070.

For example, the atomic ratio of aluminum to cobalt (Al/Co) in the XPS analysis is preferably greater than or equal to 0.010 and less than or equal to 0.100, further preferably greater than or equal to 0.010 and less than or equal to 0.050, still further preferably greater than or equal to 0.010 and less than or equal to 0.040.

For example, the atomic ratio of fluorine to magnesium (F/Mg) in the XPS analysis is preferably greater than or equal to 0.100 and less than or equal to 1.00, further preferably greater than or equal to 0.100 and less than or equal to 0.800, still further preferably greater than or equal to 0.100 and less than or equal to 0.500, yet still further preferably greater than or equal to 0.100 and less than or equal to 0.300, yet still further preferably greater than or equal to 0.100 and less than or equal to 0.200.

When the ratio is within the above range, it can be said that the additive element A is not attached to a narrow area of the surface of the positive electrode active material 10 but widely distributed at a preferable concentration in the surface portion 10a of the positive electrode active material 10. That is, when the ratios are within the above ranges in the XPS analysis results of the positive electrode active material 10, the crystal structure is less likely to be broken even when charging that makes x be 0.24 or less and discharging are repeated, so that excellent cycle performance can be achieved. In addition, lithium can be inserted and extracted favorably in/from the positive electrode active material 10, and excellent rate characteristics can be achieved.

In the XPS analysis, monochromatic aluminum Kα radiation can be used as an X-ray, for example. Furthermore, an XPS apparatus enabling energy resolution such that the half width of Ag3d5/2 peak (112 eV) is 1.0 eV±0.1 eV in an XPS spectrum of an Ag sample may be used. An extraction angle can be, for example, 45°. For example, the measurement can be performed using the following XPS apparatus and conditions.
Measurement apparatus: PHI Quantera II
X-ray: monochromatic Al Kα (1486.6 eV)
Energy resolution: 1.0 eV±0.1 eV as the half width of the Ag3d5/2 peak
Detection area: 100 μm
Detection depth: approximately 4 to 5 nm (extraction angle 45°)
Measurement spectrum: wide scan, narrow scan of each detected element

Furthermore, when the positive electrode active material 10 of one embodiment of the present invention is analyzed by XPS, a peak indicating the binding energy of magnesium with another element (Mg1s peak) is preferably at higher than or equal to 1303.0 eV and lower than 1305.0 eV, further preferably approximately 1304.0 eV. This value is different from the binding energy of magnesium fluoride (1306.0 eV) and is close to that of magnesium oxide.

In the XPS analysis of the positive electrode active material 10 of one embodiment of the present invention, the measured XPS spectrum is preferably corrected such that the C1s peak is aligned with the reference value (284.8 eV), i.e., the whole XPS spectrum is preferably shifted. Thus, the influence of a mechanical difference, a difference in measurement conditions, or the like of the XPS apparatus on XPS measurement can be reduced.

In the XPS analysis of the positive electrode active material 10 of one embodiment of the present invention, when the proportions of peak components derived from an O—Mg—O bond, an O—Mg—F bond, and an F—Mg—F bond are analyzed in analysis of a Mg1s peak, the peak component derived from an O—Mg—O bond is preferably contained. Note that the peak component derived from the O—Mg—F bond may be contained, but the proportion thereof is preferably lower than or equal to 30% of the total of the above three peak components, further preferably lower than or equal to 20% thereof, still further preferably lower than or equal to 10% thereof. Furthermore, the peak component derived from the F—Mg—F bond may be contained, but the proportion thereof is preferably lower than or equal to 10% of that of the total of the above three peak components.

In other words, in the XPS analysis of the positive electrode active material 10 of one embodiment of the present invention, when the proportions of the peak components derived from the O—Mg—O bond, the O—Mg—F bond, and the F—Mg—F bond are analyzed, the proportion of the peak component derived from the O—Mg—O bond is preferably is preferably higher than or equal to 70%, further preferably higher than or equal to 80%, still further preferably higher than or equal to 90%, yet still further preferably 100%.

An analysis method of the Mg1s peak of an XPS spectrum in XPS analysis is described. In a preferred example, assuming that the peak component derived from the O—Mg—O bond is Fit Peak 1, that from the O—Mg—F bond is Fit Peak 2, and that from the F—Mg—F bond is Fit Peak 3 in the analysis of the Mg1s peak, a cumulative peak of these three peaks is prepared, the peak of the cumulative peak is calculated to have a smallest difference from the Mg1s peak of the XPS spectrum obtained by the XPS analysis, and the proportions of the areas of Fit peak 1, Fit peak 2, and Fit peak 3 in the cumulative peak are calculated. The analysis results can be output on the assumption that the proportions of the areas of Fit peak 1, Fit peak 2, and Fit peak 3 are the proportions of the O—Mg—O bond, the O—Mg—F bond, and the F—Mg—F bond.

In the analysis method of the XPS spectrum, for an energy value (Ep1) at the maximum value (also referred to as a peak top) of Fit Peak 1, the energy value at the maximum value of the Mg1s peak separately measured using a standard sample of LiCoO₂ coated with MgO can be referred to. For an energy value (Ep3) at the maximum value of Fit Peak 3, the energy value at the maximum value of the Mg1s peak separately measured using a standard sample of magnesium fluoride (MgF₂) (e.g., MGH18XB with purity of 99.9% (3N) up, Kojundo Chemical Laboratory Co., Ltd.) can be referred to. An energy value (Ep2) at the maximum value of Fit Peak 2 can be an intermediate value between Ep1 and Ep3. Moreover, Ep1 is positioned on the lower energy side than Ep3. Note that the energy value at the maximum peak value is also referred to as a peak position.

In the XPS analysis of the positive electrode active material 10 of one embodiment of the present invention, the half width of the Mg1s peak is preferably greater than or equal to 1.0 eV and less than or equal to 3.0 eV, further preferably greater than or equal to 1.0 eV and less than or equal to 2.8 eV, and particularly preferably greater than or equal to 1.0 eV and less than or equal to 2.6 eV. In the above, the peak position of the Mg1s peak is on the lower energy side than the energy value at the maximum value of the Mg1s peak measured separately using the standard sample of magnesium fluoride.

### <EDX>

One or more selected from the additive elements A contained in the positive electrode active material 10 preferably have a concentration gradient. In the case where two or more additive elements A are used, the additive elements A preferably exhibit concentration peaks at different depths from the surface. The concentration gradients, concentration peaks, and the like of the additive elements A can be evaluated by exposing a cross section of the positive electrode active material 10 using a focused ion beam (FIB) or the like and analyzing the cross section using EDX, electron probe microanalysis (EPMA), or the like.

EDX measurement for evaluating an area two-dimensionally while the area is being scanned is referred to as EDX area analysis. EDX measurement for evaluation of the atomic concentration distribution in a positive electrode active material by line scan is referred to as EDX line analysis. Furthermore, extracting data of a linear region from EDX area analysis is referred to as EDX line analysis in some cases. The measurement of a region without scanning is referred to as EDX point analysis.

By EDX area analysis (e.g., element mapping), the concentrations of the additive elements A in the surface portion 10a, the inner portion 10b, the vicinity of the crystal grain boundary, and the like of the positive electrode active material 10 can be quantitatively analyzed. By EDX line analysis, the concentration distributions and the highest concentrations of the additive elements A can be analyzed. An analysis method in which a thinned sample is used, such as STEM-EDX, is preferred because the method makes it possible to analyze the concentration distribution in the depth direction from the surface toward the center in a specific region of the positive electrode active material regardless of elements contained in the front-back direction of a sample.

Since the positive electrode active material 10 is a compound containing oxygen and a transition metal into and from which lithium can be inserted and extracted, an interface between a region where oxygen and the transition metal M (e.g., Co, Ni, Mn, Fe, or the like) that is oxidized or reduced due to insertion and extraction of lithium are present and a region where oxygen and the transition metal M are absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

A reference point in STEM-EDX line analysis or the like is a point that is 50% of the average value M_{AVE} of the detected amounts of the characteristic X-ray of the transition metal M1 in the positive electrode active material. In the case where the left side of the reference point is referred to as the outside of the positive electrode active material and the right side of the reference point is referred to as the inner portion of the positive electrode active material, the reference point is referred to as the position of the surface of the positive electrode active material in some cases. In STEM-EDX line analysis or the like, in the case where the detected amount of the characteristic X-ray of the transition metal M1 does not sufficiently decrease at the left side of the reference point, the detected amount of the characteristic X-ray of the transition metal M1 on the left side of the reference point is referred to as a background, and the reference point can be a point that is 50% of the sum of the average value M_{BG} of the detected amounts of the characteristic X-ray of the transition metal M1 of the background and the average value M_{AVE} of the detected amounts of the characteristic X-ray of the transition metal M1 in the inner portion in some cases. Instead of the transition metal M1, the detected amount of characteristic X-rays of oxygen in the positive electrode active material may be used, in which case the reference point can be obtained by replacing the transition metal M1 with oxygen. Note that since oxygen is an element that is easily influenced by the outside of the positive electrode active material, the reference point is preferably calculated from 50% of the average value M_{AVE} of the detected amounts of characteristic X-ray of the transition metal M1. In the case where 50% of the average value M_{AVE} of the detected amounts of the characteristic X-ray of the transition metal M1 is different from 50% of the average value M_{AVE} of the detected amounts of the characteristic X-ray of oxygen, there is probably an influence of a metal oxide containing oxygen, a carbonate, or the like attached to the surface of the positive electrode active material; thus, a point that is 50% of the average value M_{AVE} of the detected amounts of the characteristic X-ray of the transition metal M1 is preferably employed. In the case of a positive electrode active material containing a plurality of the transition metals M1, the reference point can be determined using the average value M_{AVE} of a transition metal whose detected amounts of the characteristic X-ray in the inner portion are larger than that of any other element.

The average value M_{AVE} of the detected amounts of the characteristic X-ray of the transition metal M1 in the inner portion can be calculated by averaging the detected amounts in the range greater than or equal to 2 nm, preferably greater than or equal to 3 nm at the depth at which the detected amount of the characteristic X-ray of the transition metal M1 is saturated and stabilized, e.g., at a depth larger than, by greater than or equal to 20 nm, preferably greater than 30 nm, the depth at which the detected amount of the characteristic X-ray of the transition metal M1 begins to increase. The average value M_{BG} of the detected amounts of the characteristic X-ray of the transition metal M1 of the background can be calculated by averaging the detected amounts in the range greater than or equal to 2 nm, preferably greater than or equal to 3 nm, which is outside a portion in the vicinity of the portion at which the detected amount of the characteristic X-ray of the transition metal M1 begins to increase, for example. The average value O_{AVE} of the detection amounts of the characteristic X-ray of oxygen in the inner portion and the average value O_{BG} of the detection amounts of the characteristic X-ray of oxygen of the background can be calculated in a similar manner.

The surface of the positive electrode active material 10 in, for example, a cross-sectional STEM image is a boundary between a region where an image derived from the crystal structure of the positive electrode active material is observed and a region where the image is not observed. The surface of the positive electrode active material 10 is also determined as the outermost surface of a region where an atomic column derived from an atomic nucleus of, among metal elements which constitute the positive electrode active material, a metal element that has a larger atomic number than lithium is observed in the cross-sectional STEM image.

A peak in STEM-EDX line analysis refers to the local maximum value of a projecting shape appearing in the graph of the characteristic X-ray intensity of each element or the maximum value of the characteristic X-ray of each element. As an example of a noise in STEM-EDX line analysis, a measured value having a half width smaller than or equal to spatial resolution (R), for example, smaller than or equal to R/2 can be given.

A peak in STEM-EDX line analysis refers to the local maximum value of a projecting shape appearing in the graph of the characteristic X-ray intensity of each element or the maximum value of the characteristic X-ray of each element. As an example of a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning two times can be used as the detected value of each element. The number of scanning is not limited to two and an integrated value obtained by performing scanning three or more times can be used as the detected value of each element.

STEM-EDX line analysis can be performed as follows, for example. First, a protective film is deposited by evaporation over the surface of a positive electrode active material. For example, carbon can be deposited by evaporation with a carbon coating unit of an ion sputtering apparatus (MC1000, produced by Hitachi High-Tech Corporation).

Next, the positive electrode active material is thinned to obtain a cross-section sample for STEM analysis. For example, the positive electrode active material can be thinned with an FIB-SEM apparatus (XVision 200TBS, Hitachi High-Tech Corporation). Here, the thinned sample can be picked up by a micro probing system (MPS), and the acceleration voltage at final processing can be, for example, 10 kV.

The STEM-EDX line analysis can be performed using, for example, HD-2700 (Hitachi High-Tech Corporation) as a STEM apparatus and Octane T Ultra W (Dual EDS) of EDAX Inc as an EDX detector. As one example of conditions for the EDX line analysis using HD-2700 by Hitachi High-Tech Corporation, the accelerating voltage and the emission current of the STEM apparatus are set to 200 kV and within the range of 6 μA to 10 μA, respectively, and a portion of the thinned sample, which is not so deep and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm. To increase the analysis sensitivity in STEM-EDX line analysis, a beam current of an electron beam (also referred to as a probe current) is preferably increased. That is, the apparatus used for STEM-EDX line analysis preferably includes a spherical aberration corrector (Cs collector) that can make a beam diameter small and increase a beam current.

When the positive electrode active material 10 contains magnesium and fluorine as the additive elements A, the distribution of fluorine preferably includes a region that overlaps with the distribution of magnesium. For example, a difference in the depth direction between a peak of the concentration or detected amount of fluorine and a peak of the concentration or detected amount of magnesium is preferably within 10 nm, further preferably within 3 nm, still further preferably within 1 nm, yet still further preferably within 0.5 nm.

In the positive electrode active material 10 containing nickel as the additive element A, a peak of the concentration or detected amount of nickel in the surface portion 10a is preferably observed in a region ranging from the surface of the positive electrode active material 10 or a reference point to a depth of 3 nm, further preferably to a depth of 1 nm toward the center. When the positive electrode active material 10 contains magnesium and nickel, the distribution of nickel preferably includes a region that overlaps with the distribution of magnesium. For example, a difference in the depth direction between a peak of the concentration or detected amount of nickel and a peak of the concentration or detected amount of magnesium is preferably less than or equal to 3 nm, further preferably less than or equal to 1 nm.

In the case where the positive electrode active material 10 contains aluminum as the additive element A, in the EDX line analysis, the peak of the concentration or detected amount of magnesium, nickel, or fluorine is preferably located closer to the surface than the peak of the concentration or detected amount of aluminum in the surface portion 10a. In other words, the peak of the concentration or detected amount of aluminum in the surface portion 10a is preferably located more inwardly than the peak of the concentration or detected amount of magnesium, nickel, or fluorine. For example, the peak of the concentration or detected amount of aluminum is preferably observed in a region ranging from the surface of the positive electrode active material 10 or a reference point to a depth of 0.5 nm to 50 nm, both inclusive, further preferably a depth of 5 nm and to 50 nm, both inclusive, toward the center of the positive electrode active material 10.

Here, how to express the positional relation of distributed elements subjected to EDX line analysis is described with reference to FIGS. 14A to 14G. FIGS. 14A to 14F are schematic diagrams showing the distribution of concentrations or detected amounts of a first element e1 and a second element e2. FIG. 14G is a schematic diagram showing the distribution of concentrations or detected amounts of the first element e1, the second element e2, and a third element e3.

For example, in the case where the distributions of concentrations or detected amounts of the first element e1 and the second element e2 have profiles as shown in FIG. 14A, it is expressed that the position where the concentration or detected amount of the second element e2 is the maximum is located nearer to the inner portion than the position where the concentration or detected amount of the first element e1 is the maximum. For example, in the case where the distributions of concentrations or detected amounts of the first element e1 and the second element e2 have profiles as shown in FIG. 14B, it is expressed that the position where the concentration or detected amount of the second element e2 is the maximum is located nearer to the inner portion than the position where the concentration or detected amount of the first element e1 is the maximum. For example, in the case where the distributions of the concentrations or detected amounts of the first element e1 and the second element e2 have profiles as shown in FIG. 14C, it is expressed that the position where the concentration or detected amount of the first element e1 is the maximum is located nearer to the inner portion than the position where the concentration or detected amount of the second element e2 is the maximum. For example, in the case where the distributions of the concentrations or detected amounts of the first element e1 and the second element e2 have profiles as shown in FIG. 14D, it is expressed that the position where the concentration or detected amount of the second element e2 is the maximum is located nearer to the inner portion than the position where the concentration or detected amount of the first element e1 is the maximum. For example, in the case where the distributions of the concentrations or detected amounts of the first element e1 and the second element e2 have profiles as shown in FIG. 14E, it is expressed that the position where the concentration or detected amount of the first element e1 is the maximum is located nearer to the inner portion than the position where the concentration or detected amount of the second element e2 is the maximum. For example, in the case where the distributions of the concentrations or detected amounts of the first element e1 and the second element e2 have profiles as shown in FIG. 14F, it is expressed that the position where the concentration or detected amount of the second element e2 is the maximum is located nearer to the inner portion than the position where the concentration or detected amount of the first element e1 is the maximum.

The expression “the distribution of one element has a region overlapping with the distribution of another element” is described with the case where the distributions of the concentrations or detected amounts of the first element e1, the second element e2, and the third element e3 has a positional relation as shown in FIG. 14G as an example. In this specification and the like, the expression “distributions of two elements have an overlapping region” means that a position of the maximum value in the distribution of the concentration or detected amount of at least one element is located in the range higher than or equal to ⅕ of the maximum value in the distribution of the concentration or detected amount of the other element, for example.

For example, in the case of the positional relation as shown in FIG. 14G, the position (P2) at the maximum value in the distribution of the concentration or detected amount of the second element e2 is located within a range (a hatched region in the diagram) higher than or equal to ⅕ of the maximum value (or the lower detection limit) in the distribution of the concentration or detected amount of the first element e1. Thus, this is expressed as follows: the distribution of the first element e1 and the distribution of the second element e2 have an overlapping region. The position (P3) at the maximum value in the distribution of the concentration or detected amount of the third element e3 is not located within a range (a hatched region in the diagram) where the concentration or detected amount of the first element e1 is higher than or equal to ⅕ of the maximum value (or the lower detection limit) in the distribution of the concentration or detected amount of the first element e1. This is expressed as follows: the distributions of the first element e1 and the distribution of the third element e3 do not have an overlapping region.

In the case of the positional relation as shown in FIG. 14G, it can be said that the distribution of the second element e2 and the distribution of the third element e3 are located nearer to the inner portion than the distribution of the first element e1. It can also be said that the distribution of the second element e2 and the distribution of the third element e3 are located more inwardly than the distribution of the first element e1.

The contents in this embodiment can be freely combined with the contents in any of the other embodiments.

### Embodiment 3

In this embodiment, components included in a secondary battery will be described.

### [Positive Electrode]

A secondary battery includes a positive electrode. The positive electrode is as described in Embodiments 1, 2, and the like.

### <Positive Electrode Current Collector>

The positive electrode includes a positive electrode current collector. The positive electrode current collector can be formed using a material that has high conductivity, such as a metal like stainless steel, gold, platinum, aluminum, or titanium, or an alloy thereof, or the material having a coating layer on its surface. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

### <Binder>

The positive electrode preferably includes a binder. As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

For the binder, for example, a water-soluble polymer is preferably used. As the water-soluble polymer, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

Two or more of the above materials may be used in combination for the binder. For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of the water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, examples of the cellulose and the cellulose derivative used as a binder of an electrode include salts thereof.

A water-soluble polymer can stabilize the viscosity by being dissolved in water and can allow stable dispersion of the active material and another material combined as the binder, e.g., styrene-butadiene rubber, in an aqueous solution. Furthermore, a water-soluble polymer is expected to be easily and stably adsorbed on an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, the passivation film refers to a film without electric conductivity or a film with extremely low electric conductivity, and can inhibit the decomposition of an electrolyte solution at a potential at which a secondary battery reaction occurs when the passivation film is formed on the active material surface, for example. It is preferable that the passivation film can conduct lithium ions while suppressing electrical conduction.

### <Conductive Material>

The positive electrode preferably includes a conductive material. A conductive material is also referred to as a conductivity-imparting agent or a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, but also the following states: a case where covalent bonding occurs, a case where bonding with the Van der Waals force occurs, a case where a conductive material covers a part of the surface of an active material, a case where a conductive material is embedded in surface roughness of an active material, and a case where an active material and a conductive material are electrically connected to each other without being in contact with each other, for example.

As the conductive material, for example, one or more of carbon black such as acetylene black or furnace black, graphite such as artificial graphite or natural graphite, carbon fibers such as a carbon nanofiber and a carbon nanotube, and a graphene compound can be used.

Examples of the carbon fiber include a mesophase pitch-based carbon fiber and an isotropic pitch-based carbon fiber. As the carbon fiber, a carbon nanofiber, a carbon nanotube, or the like can be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer, resulting in increased discharge capacity of the secondary battery.

A particulate carbon-containing compound such as carbon black or graphite or a fibrous carbon-containing compound such as a carbon nanotube easily enters a microscopic space. A microscopic space refers to, for example, a space between a plurality of active materials. When a carbon-containing compound that easily enters a microscopic space and a fibrous carbon-containing compound, such as graphene, that can impart conductivity to a plurality of particles are used in combination, the density of the electrode increases and an excellent conductive path can be formed. The secondary battery obtained by the manufacturing method of one embodiment of the present invention can have high capacitive density and stability, and is effective as an in-vehicle secondary battery.

### [Negative Electrode]

The negative electrode includes a negative electrode active material layer and a negative electrode current collector. The negative electrode active material layer contains a negative electrode active material, and may also contain a conductive material and a binder.

### <Negative Electrode Active Material>

As the negative electrode active material, for example, an alloy-based material or a carbon material can be used.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. Thus, it is preferable to use silicon for a negative electrode active material. Alternatively, a compound containing any of the above elements may be used. Examples of the compound include SiO, Mg₂Si, Mg₂Ge, SnO, SnO₂, Mg2Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB, which may have a spherical shape, is preferably used. Moreover, MCMB, which can relatively easily have a small surface area, may preferably be used. Examples of natural graphite include flake graphite and spherical natural graphite.

Graphite has a low potential substantially equal to that of a lithium metal (0.05 V to 0.3 V, both inclusive, vs. Li/Li⁺) when lithium ions are inserted into the graphite (while a lithium-graphite intercalation compound is generated). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of lithium metal.

For the negative electrode active material, an oxide such as titanium dioxide (TiO₂), lithium titanium oxide (Li₄Ti₅O₁₂), lithium-graphite intercalation compound (LiₓC), niobium pentoxide (Nb₂O₅), tungsten dioxide (WO₂), or molybdenum dioxide (MoO₂) can also be used.

Still alternatively, as the negative electrode active material, Li₃₋ₓMₓN (M═Co, Ni, or Cu) with a Li₃N structure, which is a nitride containing lithium and a transition metal, can be used. For example, Li_{2.6}Co_{0.4}N is preferable because of its high discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₅. Note that in the case of using a material containing lithium ions as the positive electrode active material, the nitride containing lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material after completion of manufacturing of the secondary battery may be used. As the negative electrode that does not contain a negative electrode active material, for example, a negative electrode can be used in which only a negative electrode current collector is included after completion of manufacturing of the secondary battery and in which lithium ions extracted from the positive electrode active material due to charging of the secondary battery are deposited as a lithium metal over the negative electrode current collector and form the negative electrode active material layer. A secondary battery including such a negative electrode is referred to as a negative electrode-free (anode-free) secondary battery, a negative electrodeless (anodeless) secondary battery, or the like in some cases.

When the negative electrode that does not contain a negative electrode active material is used, a film may be included over a negative electrode current collector for making lithium deposition uniform. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over a negative electrode current collector relatively easily, and thus is preferable as the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

When the negative electrode that does not contain a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

For the conductive material and the binder that can be included in the negative electrode active material layer, materials similar to those of the conductive material and the binder that can be included in the positive electrode active material layer can be used.

### <Negative Electrode Current Collector>

Note that a material that does not alloy with carrier ions of lithium or the like is preferably used for the negative electrode current collector. For the negative electrode current collector, copper or the like can be used, as well as the above-materials usable for the positive electrode current collector. In addition, a structure in which a coating layer is provided on a surface of any of the above-described materials may be employed.

### <Manufacturing Method of Negative Electrode>

A method for manufacturing a negative electrode is described with reference to FIG. 15.

### <Step S160>

As shown in Step S160, a negative electrode active material is prepared. Furthermore, in this step, a binder, a thickener, a conductive material, and a solvent are prepared. There are no limitations on the binder, the thickener, and the conductive material, and the mixture ratio of these materials is not limited. The proportion of the negative electrode active material in the negative electrode active material layer is higher than or equal to 95 wt % and lower than or equal to 99 wt %. Water can be used as the solvent.

### <Step S161 and Step S162>

As shown in Step S161, the prepared members are mixed in the solvent, whereby slurry is formed as shown in Step S162. The slurry mentioned here refers to a material solution that is used to form an active material layer over the negative electrode current collector described later and contains an active material, a binder, and a solvent, preferably also contains a conductive material mixed therein. Furthermore, in Step S162, a negative electrode current collector is prepared.

### <Step S165 and Step S166>

The slurry is applied to the negative electrode current collector as shown in Step S165, and the slurry is dried so that the solvent is removed as shown in Step S166.

### <Step S167 and Step S169>

As shown in Step S167, the negative electrode active material layer and the negative electrode current collector are pressed together, so that the negative electrode is completed as shown in Step S169.

### [Separator]

The secondary battery includes a separator. The separator is as described in Embodiment 1 and the like.

### [Exterior Body]

The secondary battery includes an exterior body. The exterior body is as described in Embodiment 1 and the like.

### [Electrolyte Solution]

The secondary battery includes an electrolyte solution containing carrier ions. The electrolyte solution is as described in Embodiment 1 and the like.

### [Nail Penetration Test]

A nail penetration test is a type of safety testing for secondary batteries, and in the nail penetration test, a nail having a predetermined diameter within the range of 2 mm to 10 mm penetrates a secondary battery in a fully charged state at a predetermined speed.

### <Nail Penetration Test Device>

A nail penetration test device is described first. FIG. 18A is a side view of a nail penetration test device 1000 and 18B is a perspective view of a stage of the nail penetration test device 1000. The nail penetration test device 1000 illustrated in FIG. 18A includes a stage 1001, a driving portion 1002, a nail 1003, a voltage measuring device 1015, a temperature measuring device 1016, and a control portion 1018. The driving portion 1002 includes a driving mechanism 1012 for moving the nail 1003 in the arrow direction indicated in the diagram. The driving mechanism 1012 is operative to make the nail 1003 pass through a secondary battery 1004 placed over the stage 1001. Here, the secondary battery 1004 is in a fully charged state (the state of charge (SOC) of the secondary battery is 100%). This operation is referred to as nail penetration operation. The dashed line in FIG. 18A shows a depression of the stage 1001 for holding the nail 1003 that has passed through the secondary battery in the nail penetration operation.

Data on the voltage of the secondary battery during the nail penetration operation is transmitted from the voltage measuring device 1015 to the control portion 1018. Specifically, the amount of change in voltage and the like are transmitted to the control portion 1018. Data on the temperature during the nail penetration operation is transmitted from the temperature measuring device 1016 to the control portion 1018. To control operation conditions of the nail 1003, the control portion 1018 can transmit a control signal to the driving portion 1002.

FIG. 18B is a perspective view illustrating the upper side of the stage 1001 of the nail penetration test device 1000 and the vicinity of the upper side. The secondary battery 1004 placed over the stage 1001 is electrically connected to a wiring 1005a and a wiring 1005b. The wiring 1005a and the wiring 1005b, which belong to the voltage measuring device 1015, are electrically connected to a positive electrode side tab and a negative electrode side tab of the secondary battery 1004, so that the voltage of the secondary battery 1004 can be measured. The voltage of the secondary battery 1004 is simply referred to as a voltage, or is referred to as a voltage value between positive and negative electrodes, a battery voltage, a cell voltage, or an open-circuit voltage. In the case where a temperature sensor is used as the temperature measuring device 1016, the temperature sensor is provided to be in contact with a surface of an exterior body of the secondary battery 1004.

In the example illustrated in FIG. 18B, a first temperature sensor 1006a and a second temperature sensor 1006b are provided; alternatively, one temperature sensor or three or more temperature sensors may be provided. In FIG. 18B, the first temperature sensor 1006a is provided on a side where the wiring 1005a and the wiring 1005b are not disposed, and the second temperature sensor 1006b is provided on the side where the wiring 1005a and the wiring 1005b are disposed. It is preferable to provide two or more temperature sensors because in the case where one temperature sensor cannot be used owing to expansion of the exterior body or the like, another of the temperature sensors can be used.

The side where the wiring 1005a and the wiring 1005b are disposed has a welded region, whereas the side where the wiring 1005a and the wiring 1005b are not disposed does not have the above welded region because the exterior body is bent at the latter side. This structure is preferable because it would inhibit expansion at the side where the wiring 1005a and the wiring 1005b are not disposed if the exterior body expands, making the first temperature sensor 1006a less likely to be peeled off than the second temperature sensor 1006b.

The dashed line ellipse in FIG. 18B shows the region in which the nail 1003 passes through the secondary battery 1004 in the nail penetration operation. It is preferable that the first temperature sensor 1006a and the second temperature sensor 1006b be provided in the regions that are equidistant from the region in which the nail 1003 passes through the secondary battery. Typically, the first temperature sensor 1006a and the second temperature sensor 1006b are provided preferably less than or equal to 5 cm away from the region in which the nail 1003 passes through the secondary battery, further preferably less than or equal to 2 cm away from the region. In that case, preferably, it is possible to monitor a temperature change in the vicinity of the region in which the nail 1003 passes through the secondary battery. In the case where two or more temperature sensors are provided, the nail penetration operation is preferably started after it is confirmed that the difference between the temperatures indicated by the temperature sensors is less than or equal to ±5° C., preferably less than or equal to ±2° C.

### <Secondary Battery in Nail Penetration Test>

Next, the state of the secondary battery in the nail penetration test is specifically described with reference to FIG. 19 and the like. In the nail penetration test, the nail 1003 having a predetermined diameter in the range of 2 mm to 10 mm penetrates the secondary battery 1004 in a fully charged state at a predetermined speed. FIG. 19 is a cross-sectional view illustrating the state where the nail 1003 penetrates the secondary battery 1004. The secondary battery 1004 has a structure in which a positive electrode 503, a separator 508, a negative electrode 506, and an electrolyte solution 530 are held in an exterior body 541. The positive electrode 503 includes a positive electrode current collector 501 and positive electrode active material layers 502 formed over both surfaces of the positive electrode current collector 501. The structure described in the above embodiment is preferably employed for the positive electrode active material layers. The negative electrode 506 includes a negative electrode current collector 521 and negative electrode active material layers 512 formed on both surfaces of the negative electrode current collector 521.

As illustrated in FIG. 19, when the nail 1003 penetrates the secondary battery 1004, or specifically, when the nail 1003 passes through the positive electrode 503 and the negative electrode 506, an internal short circuit occurs. This makes the potential of the nail 1003 equal to that of the negative electrode 506, so that an electron (e⁻) flows to the positive electrode 503 through the nail 1003 and the like as indicated by the black arrows and Joule heat is generated in the portion where the internal short circuit has occurred and the vicinity of the portion. The internal short circuit causes carrier ions, typically lithium ions (Li⁺), to be extracted from the negative electrode 506 and to be released into the electrolyte solution as indicated by the white arrows. Note that before all the lithium ions are released from the negative electrode, reductive decomposition of the electrolyte solution starts on the negative electrode surface owing to a rapid increase in the battery temperature by the Joule heat generated by the internal short circuit. This is one of electrochemical reactions and is referred to as a reduction reaction of an electrolyte solution by a negative electrode.

In the case where the Joule heat increases the temperature of the secondary battery 1004 and the positive electrode active material is lithium cobalt oxide, the lithium cobalt oxide sometimes undergoes a phase change (i.e., a structural change) to an H1-3 type structure or an O1 type structure to further generate heat.

Then, the electron (e) that has flowed to the positive electrode 503 reduces Co, which is tetravalent in the lithium cobalt oxide in the charged state, to trivalent or divalent Co. This reduction reaction causes oxygen release from the lithium cobalt oxide, and an oxidation reaction due to the oxygen decomposes the electrolyte solution 530. This is one of electrochemical reactions and is referred to as an oxidation reaction of an electrolyte solution by a positive electrode. The speed at which a current flows into the positive electrode active material such as lithium cobalt oxide slightly varies depending on the insulating property of the positive electrode active material, and it is presumable that the speed at which a current flows affects the above electrochemical reaction.

When an internal short circuit of a secondary battery occurs as described above, the temperature is presumed to change as shown in the graph of FIG. 20. FIG. 20 is the graph cited from [FIG. 2-12] on p. 70 of Non-Patent Document 1, which is partly retouched. This graph shows the temperature (specifically, the internal temperature) of a secondary battery as a function of time. Upon an internal short circuit at (P0), the temperature of the secondary battery increases over time. When the temperature of the secondary battery increases to reach approximately 100° C. as indicated by (P1) owing to heat generation due to Joule heat by the internal short circuit, the temperature sometimes further increases to exceed the threshold temperature for thermal runaway of the secondary battery, the reference temperature (Ts). Then, reduction of an electrolyte solution by a negative electrode (the negative electrode is C₆Li when graphite is used) and heat generation of the electrolyte solution are caused at (P2), oxidation of the electrolyte solution by a positive electrode and heat generation of the electrolyte solution are caused at (P3), and heat generation due to thermal decomposition of the electrolyte solution is caused at (P4). Accordingly, the secondary battery enters thermal runaway, resulting in ignition or the like.

In a positive electrode active material at this time, a reaction occurs in which electrons rapidly flowing into the positive electrode active material reduce cobalt Co⁴⁺ to Co²⁺ and oxygen is released from the positive electrode active material. This reaction, which is an exothermic reaction, accelerates thermal runaway. In other words, inhibiting this reaction enables a safe secondary battery that does not easily undergo thermal runaway.

To inhibit the above reaction, for example, it is preferable that a surface portion of the positive electrode active material contain an additive element X inhibiting release of oxygen and the concentration of the additive element X be higher in the surface portion than in an inner portion. When no oxygen is released from the positive electrode active material, the above reduction reaction (e.g., the reaction in which Co⁴⁺ becomes Co²⁺) is inhibited. Examples of the additive element X inhibiting release of oxygen include magnesium and aluminum. Magnesium is suitable as the additive element X inhibiting release of oxygen because oxygen closer to magnesium requires higher energy for release. Nickel is also presumed to have an effect of inhibiting release of oxygen when present at a lithium site.

Even when cobalt or the like is reduced, insertion of lithium ions into the positive electrode active material before oxygen release would maintain electrical neutrality and thus prevent oxygen release. It can be thus said that regardless of whether electrons rapidly flow into the positive electrode active material, the crystal structure of the positive electrode active material should at least remain stable until insertion of lithium ions into the positive electrode active material from the negative electrode through the electrolyte solution is completed.

To prevent smoking, heat generation, and the like in the nail penetration test, it is probably preferable that an increase in the temperature of the secondary battery be inhibited and the negative electrode, the positive electrode, and/or the electrolyte solution have stable characteristics at high temperatures. Specifically, it is preferable that the first positive electrode active material 10x have a stable structure from which no oxygen is released, or specifically, no oxygen is released even at high temperatures. Alternatively, the first positive electrode active material 10x preferably has a structure such that a current flows to the positive electrode active material at a low speed. In that case, a significant effect that thermal runaway is less likely to occur and thus ignition or the like is less likely to occur can be obtained. As described later, the first positive electrode active material 10x of one embodiment of the present invention can have both the above stable structure and the structure such that a current flows at a low speed.

### <Thermal Runaway of Secondary Battery>

The mechanism of thermal runaway of a secondary battery is described with reference to FIG. 21 showing a graph cited from [FIG. 2-11] on p. 69 of Non-Patent Document 1, which is partly retouched. A secondary battery as described above enters thermal runaway after experiencing some states when the temperature (specifically, the internal temperature) increases during charging, for example. FIG. 21 is a graph showing the temperature of a secondary battery as a function of time. When the temperature of the secondary battery reaches 100° C. or the vicinity thereof, for example, (1) collapse of a solid electrolyte interphase (SEI) of a negative electrode and heat generation are caused. When the temperature of the secondary battery exceeds 100° C., (2) reduction of an electrolyte solution by the negative electrode (the negative electrode is C₆Li when graphite is used) and heat generation of the electrolyte solution are caused. At 150° C. and the vicinity thereof, (3) oxidation of the electrolyte solution by a positive electrode and heat generation of the electrolyte solution are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change of a positive electrode active material) are caused. Subsequently, when the temperature of the secondary battery exceeds 200° C., (6) decomposition of the negative electrode is caused, and finally, (7) the positive electrode and the negative electrode come into direct contact with each other. The secondary battery enters thermal runaway after experiencing such states, specifically the state (5), the state (6), or the state (7).

To prevent thermal runaway, it is probably preferable that an increase in the temperature of the secondary battery be inhibited and the separator, the negative electrode, the positive electrode, and/or the electrolyte solution have stable characteristics at high temperatures.

### <Feature of Secondary Battery in Nail Penetration Test>

The features of the secondary battery in the nail penetration test performed on the secondary battery including the second electrode including the positive electrode active material, the separator, and the like described in the above embodiments and the like are described.

An increase in the temperature of the secondary battery when the nail penetration test is conducted, i.e., the difference between the temperature before the nail penetration test and the maximum temperature reached after the nail penetration (also referred to as temperature rise ΔT), is preferably less than or equal to 100° C., further preferably less than or equal to 70° C., still further preferably less than or equal to 50° C. The temperature is that at a position less than or equal to 5 cm away from the nail hole, preferably less than or equal to 2 cm away from the nail hole, and is specifically a value output with the use of the temperature sensor disposed less than or equal to 5 cm away from the nail hole, preferably less than or equal to 2 cm away from the nail hole. The temperature sensor is preferably provided to be in contact with the exterior body of the secondary battery.

The maximum temperature at the time of the nail penetration test is preferably lower than or equal to 250° C., further preferably lower than or equal to 200° C., still further preferably lower than or equal to 180° C. Further preferably, the maximum temperature is lower than the temperature at which oxygen release from the positive electrode and thermal decomposition of the positive electrode are caused.

The maximum temperature at the time of the nail penetration test is preferably lower than or equal to 150° C., further preferably lower than or equal to 100° C., still further preferably lower than or equal to 80° C. Further preferably, the maximum temperature is lower than the temperature at which oxidation of the electrolyte solution by the positive electrode is caused. Further preferably, the maximum temperature is lower than the flash point of a mixed solvent used in the electrolyte solution. In the case where the flash point of the mixed solvent is unknown, the flash points of the solvents contained in the mixed solvent can be referred to. Further preferably, the maximum temperature is lower than the softening point of the separator. For example, the softening point of polypropylene that can be used as the separator is approximately 155° C.

This embodiment can be implemented in appropriate combination with any of the other embodiments.

### Embodiment 4

In this embodiment, a secondary battery including an electrolyte solution and a separator of one embodiment of the present inventio will be described. The secondary battery including the electrolyte solution and the separator is preferable because it can prevent thermal runaway and/or ignition. In the case where an electrode expands and contracts at the time of charging and discharging of the secondary battery, the amount of the electrolyte solution held in the separator can be ensured, which is preferable.

### [Coin-Type Secondary Battery]

An example of a coin-type secondary battery is described. FIG. 22A, FIG. 22B, and FIG. 22C are an exploded perspective view, an external view, and a cross-sectional view of a coin-type (single-layer flat) secondary battery. Coin-type secondary batteries are mainly used in small electronic devices.

For easy understanding, FIG. 22A is a schematic view illustrating overlap (a vertical relation and a positional relation) between components. Thus, FIGS. 22A and 22B do not completely correspond with each other.

In FIG. 22A, a positive electrode 304, a separator 310, a negative electrode 307, a spacer 322, and a washer 312 are overlaid. The separator of one embodiment of the present invention can be used as the separator 310. They are sealed with a negative electrode can 302, a positive electrode can 301, and a gasket. The gasket for sealing is not illustrated in FIG. 22A. The spacer 322 and the washer 312 are used to protect the inside or fix the positions of the components inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305. As the positive electrode active material of the positive electrode active material layer 306, lithium cobalt oxide of one embodiment of the present invention can be used.

FIG. 22B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and a lithium metal foil or lithium-aluminum alloy foil may be used.

Note that only one surface of each of the positive electrode 304 and the negative electrode 307 used for the coin-type secondary battery 300 can be provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 22C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured. The mixed solvent of one embodiment of the present invention is preferably used as the solvent of the electrolyte solution.

### [Cylindrical Secondary Battery]

An example of a cylindrical secondary battery is described with reference to FIG. 23A. As illustrated in FIG. 23A, a cylindrical secondary battery 616 includes a positive electrode cap (secondary battery cap) 601 on the top surface and a secondary battery can (outer can) 602 on the side surface and bottom surface. The positive electrode cap 601 and the secondary battery can (outer can) 602 are insulated from each other by a gasket (insulating gasket) 610.

FIG. 23B schematically illustrates a cross section of the cylindrical secondary battery. The cylindrical secondary battery illustrated in FIG. 23B includes the positive electrode cap (secondary battery cap) 601 on the top surface and the secondary battery can (outer can) 602 on the side and bottom surfaces. The positive electrode cap and the secondary battery can (outer can) 602 are insulated from each other by the gasket (insulating gasket) 610.

Inside the secondary battery can 602 having a hollow cylindrical shape, a secondary battery element in which a strip-like positive electrode 604 and a strip-like negative electrode 606 are wound with a strip-like separator 605 located therebetween is provided. The separator of one embodiment of the present invention can be used as the separator 605. Although not illustrated, the secondary battery element is wound around a central axis. One end of the secondary battery can 602 is closed and the other end thereof is opened. For the secondary battery can 602, a metal having corrosion resistance to an electrolyte solution, such as nickel, aluminum, or titanium, an alloy of such a metal, or an alloy of such a metal and another metal (e.g., stainless steel) can be used. The secondary battery can 602 is preferably covered with nickel, aluminum, or the like in order to prevent corrosion due to the electrolyte solution. Inside the secondary battery can 602, the battery element in which the positive electrode, the negative electrode, and the separator are wound is provided between a pair of insulating plates 608 and 609 that face each other. The inside of the secondary battery can 602 provided with the secondary battery element is filled with an electrolyte solution (not illustrated). As the electrolyte solution, an electrolyte solution similar to that for the coin-type secondary battery can be used.

Since the positive electrode and the negative electrode of the cylindrical secondary battery are wound, active materials are preferably formed on both sides of the current collectors.

As the positive electrode active material of the positive electrode 604, lithium cobalt oxide of one embodiment of the present invention can be used, and the cylindrical secondary battery 616 with favorable high-voltage charge characteristics can be obtained.

A positive electrode terminal (positive electrode current collecting lead) 603 is connected to the positive electrode 604, and a negative electrode terminal (negative electrode current collecting lead) 607 is connected to the negative electrode 606. The positive electrode terminal 603 can be formed using a metal material such as aluminum. The negative electrode terminal 607 can be formed using a metal material such as copper. The positive electrode terminal 603 and the negative electrode terminal 607 are resistance-welded to a safety valve mechanism 613 and the bottom of the secondary battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the secondary battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 23C illustrates an example of a power storage system 615. The power storage system 615 includes a plurality of secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charge and discharge control circuit for performing charging, discharging, and the like or a protection circuit for preventing overcharging and/or overdischarging can be used.

FIG. 23D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through wirings 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. In this manner, the performance of the power storage system 615 is less likely to be influenced by the outside temperature.

In FIG. 23D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

Structure examples of secondary batteries are described with reference to FIGS. 24A to 24C and FIGS. 25A to 25C.

The secondary battery 913 illustrated in FIG. 24A includes a wound body 950 provided with the terminals 951 and 952 inside a housing 930. The wound body 950 is immersed in an electrolyte solution inside the housing 930. The mixed solvent of one embodiment of the present invention is preferably used as the solvent of the electrolyte solution. The terminal 952 is in contact with the housing 930. The terminal 951 is not in contact with the housing 930 with use of an insulator or the like. Note that FIG. 24A illustrates the housing 930 divided into two pieces for convenience; however, in the actual structure, the wound body 950 is covered with the housing 930 and the terminals 951 and 952 extend to the outside of the housing 930. For the housing 930, a metal material (e.g., aluminum) or a stack of a metal material and a resin material can be used.

Note that as illustrated in FIG. 24B, the housing 930 in FIG. 24A may be formed using a plurality of materials. For example, in the secondary battery 913 in FIG. 24B, a housing 930a and a housing 930b are bonded to each other, and the wound body 950 is provided in a region surrounded by the housing 930a and the housing 930b.

For the housing 930a, a metal material (e.g., aluminum) or a stack of a metal material and a resin material can be used. An organic resin or the like can be used as the resin material. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material (e.g., aluminum) or a stack of a metal material and a resin material can be used.

FIG. 24C illustrates the structure of the wound body 950. The wound body 950 includes a negative electrode 931, a positive electrode 932, and separators 933. The separator of one embodiment of the present invention can be used as the separator 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 25A to 25C, the secondary battery 913 may include a wound body 950a. The wound body 950a illustrated in FIG. 25A includes the negative electrode 931, the positive electrode 932, and the separators 933. The negative electrode 931 includes a negative electrode active material layer 931a. The positive electrode 932 includes a positive electrode active material layer 932a.

As a positive electrode active material in the positive electrode active material layer 932a, lithium cobalt oxide of one embodiment of the present invention can be used.

The separator 933 has a larger width than the negative electrode active material layer 931a and the positive electrode active material layer 932a, and is wound, overlapping with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 25B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 25C, the wound body 950a and an electrolyte solution are covered with the housing 930, whereby the secondary battery 913 is completed. The housing 930 is preferably provided with a safety valve, an overcurrent protection element, and the like. A safety valve is a valve to be released at a predetermined internal pressure of the housing 930 in order to prevent the secondary battery from exploding.

As illustrated in FIG. 25B, the secondary battery 913 may include a plurality of wound bodies 950a. The use of the plurality of wound bodies 950a enables the secondary battery 913 to have higher discharge capacity. The description of the secondary battery 913 in FIGS. 24A to 24C can be referred to for the other components of the secondary battery 913 in FIGS. 25A and 25B.

### <Laminated Secondary Battery>

Next, examples of the appearance of a laminated secondary battery are illustrated in FIGS. 26A and 26B. FIGS. 26A and 26B each illustrate a positive electrode 503, a negative electrode 506, a separator 507, an exterior body 509, a positive electrode lead electrode 510, and a negative electrode lead electrode 511. The separator of one embodiment of the present invention can be used as the separator 507. Although not illustrated, the electrolyte solution of one embodiment of the present invention, in particular, a mixed solvent, is preferably used as the electrolyte solution.

FIG. 26A is an external view of the positive electrode 103 and the negative electrode 106. The positive electrode 103 includes the positive electrode current collector 21, and the positive electrode active material layer 22 is formed on a surface of the positive electrode current collector 21. As the positive electrode active material in the positive electrode active material layer 22, lithium cobalt oxide of one embodiment of the present invention can be used. The positive electrode 103 includes a region in which a part of the positive electrode current collector 21 is exposed (hereinafter, the region is referred to as a tab region). The negative electrode 106 includes a negative electrode current collector 31, and a surface of the negative electrode current collector 31 is provided with a negative electrode active material layer 32. The negative electrode 106 includes a region in which part of the negative electrode current collector 31 is exposed, i.e., a tab region. The areas or the shapes of the tab regions included in the positive electrode and the negative electrode are not limited to those illustrated in FIG. 26A.

The contents in this embodiment can be freely combined with the contents in any of the other embodiments.

### Embodiment 5

This embodiment describes an example of a vehicle including a secondary battery including an electrolyte solution and a separator of one embodiment of the present invention. Examples of the vehicle include an automobile, a train, an airplane, and a bus. The secondary battery including the electrolyte solution and the separator is preferable because it can prevent thermal runaway and/or ignition. In the case where an electrode expands and contracts at the time of charging and discharging of the secondary battery, the amount of the electrolyte solution held in the separator can be ensured, which is preferable.

An automobile 2001 illustrated in FIG. 27A is an electric vehicle that runs on the power of an electric motor. Alternatively, the automobile 2001 is a hybrid electric vehicle capable of driving using either an electric motor or an engine as appropriate. The automobile 2001 has a secondary battery pack 2200, and the secondary battery pack 2200 preferably has a secondary battery module in which a plurality of secondary batteries are connected and a charging control device which is electrically connected to the secondary battery module.

Next, the secondary battery pack 2200 is described with reference to FIG. 27B. FIG. 27B illustrates an example in which one secondary battery pack 2200 includes nine rectangular secondary batteries 1300. The nine rectangular secondary batteries 1300 are connected in series; one electrode group is fixed by a fixing portion 1413 made of an insulator, and the other electrode group is fixed by a fixing portion 1414 made of an insulator. Instead of using the fixing portion 1413 and the fixing portion 1414, the electrode groups may be fixed by being stored in a secondary-battery container box (also referred to as a housing). Since a vibration or a jolt is assumed to be given to the vehicle from the outside (e.g., a road surface), the plurality of rectangular secondary batteries 1300 are preferably fixed by the fixing portions 1413 and 1414, the secondary-battery container box, or the like. Furthermore, the one electrode group is electrically connected to a control circuit portion 1320 through a wiring 1421. The other electrode group is electrically connected to the control circuit portion 1320 through a wiring 1422.

The control circuit portion 1320 may include a memory circuit including a transistor using an oxide semiconductor. A charging control circuit or a secondary battery control system that includes a memory circuit including a transistor using an oxide semiconductor is referred to as a battery operating system or a battery oxide semiconductor (BTOS) in some cases.

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In—M—Zn oxide that can be used as the metal oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed. Note that a clear boundary between the first region and the second region is difficult to observe in some cases.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

A transistor using an oxide semiconductor in its semiconductor layer has an operating ambient temperature range of −40° C. to 150° C., both inclusive, which is wider than that of a single crystal Si transistor, and thus shows a smaller change in characteristics than the single crystal Si transistor when the secondary battery is overheated. The off-state current of the transistor using an oxide semiconductor is lower than the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 using the transistor using an oxide semiconductor can have improved safety. The secondary battery and the control circuit portion 1320 can greatly contribute to elimination of accidents due to secondary batteries, such as fires.

Next, FIG. 27C is an example of a block diagram regarding the automobile 2001 illustrated in FIG. 27A and the secondary battery pack 2200 illustrated in FIG. 27B.

The electric vehicle is provided with first batteries 1301a and 1301b as main secondary batteries for driving and a second battery 1311 that supplies electric power to an inverter 1312 for starting a motor 1304, as illustrated in FIG. 27C. The second battery 1311 is also referred to as a cranking battery or a starter battery. The second battery 1311 only needs high output and does not necessarily require high capacity, and the capacity of the second battery 1311 is lower than those of the first batteries 1301a and 1301b.

The internal structure of the first battery 1301a may be the wound structure illustrated in FIG. 24C or FIG. 25A or the stacked structure illustrated in FIG. 26A or FIG. 26B.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a secondary battery pack including a plurality of secondary batteries, large electric power can be output. The plurality of secondary batteries may be connected in parallel, connected in series, or connected in series after being connected in parallel. A plurality of secondary batteries can be collectively referred to as an assembled secondary battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to 42 V system in-vehicle parts (such as an electric power steering 1307, a heater 1308, and a defogger 1309) through a DC-DC circuit 1306. Even in the case where a rear motor 1317 is provided for rear wheels, the first battery 1301a is used to rotate the rear motor 1317.

The second battery 1311 supplies electric power to 14 V system in-vehicle parts (such as a stereo 1313, a power window 1314, and lamps 1315) through a DCDC circuit 1310.

The first batteries 1301a and 1301b mainly supply electric power to 42 V system (high-voltage system HV) in-vehicle parts, and the second battery 1311 supplies electric power to 14 V system (low-voltage system LV) in-vehicle parts. Lead storage batteries are usually used for the second battery 1311 due to cost advantage. Lead storage batteries have disadvantages compared with lithium ion secondary batteries in that they have a larger amount of self-discharging and are more likely to deteriorate due to a phenomenon called sulfation. There is an advantage that the second battery 1311 can be maintenance-free when a lithium-ion secondary battery is used; however, in the case of long-term use, for example three years or more, anomaly that is difficult to find at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which lithium-ion secondary batteries are used as both the first battery 1301a and the second battery 1311 is described. As the second battery 1311, a lead storage battery, an all-solid-state secondary battery, or an electric double layer capacitor may alternatively be used.

Regenerative energy generated by rolling of tires 1316 is transmitted to the motor 1304 through a gear 1305, and is stored in the second battery 1311 from a motor controller 1303 or a battery controller 1302 through the control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of being rapidly charged.

The battery controller 1302 can control the charge voltage, charge current, and the like of the first batteries 1301a and 1301b. The battery controller 1302 can set charge conditions in accordance with charge characteristics of a secondary battery used, so that rapid charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charging can be performed with electric power supplied from external charging equipment by a contactless power feeding method or the like.

For rapid charging, secondary batteries that can withstand charging at high voltage are desired to perform charging in a short time.

The contents in this embodiment can be freely combined with the contents in any of the other embodiments.

### Embodiment 6

In this embodiment, space equipment including the secondary battery including the electrolyte solution and the separator of one embodiment of the present invention is described. The secondary battery including the electrolyte solution and the separator is preferable because it can prevent thermal runaway and/or ignition. Also in the case where an electrode expands and contracts at the time of charging and discharging of the secondary battery, the amount of the electrolyte solution held in the separator can be ensured, which is preferable.

FIG. 28A illustrates an artificial satellite 6800 as an example of space equipment. The artificial satellite 6800 includes a body 6801, a solar panel 6802, an antenna 6803, and a secondary battery 6805.

When the solar panel 6802 is illuminated by sunlight, electric power required for operation of the artificial satellite 6800 is generated. However, for example, in the situation where the solar panel is not illuminated by sunlight or the situation where the amount of sunlight by which the solar panel is illuminated is small, the amount of generated electric power is small. Accordingly, a sufficient amount of electric power required for operation of the artificial satellite 6800 might not be generated. In order to operate the artificial satellite 6800 even with a small amount of generated electric power, the artificial satellite 6800 is preferably provided with the secondary battery 6805. When the secondary battery of the present invention is used as the secondary battery 6805, the secondary battery 6805 can have high reliability. Furthermore, when the secondary battery of the present invention is used as the secondary battery 6805, the secondary battery 6805 can have favorable low-temperature characteristics.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured. Thus, the artificial satellite 6800 can make up a part of a satellite positioning system.

The artificial satellite 6800 can include a sensor. For example, with a structure including a visible light sensor, the artificial satellite 6800 can have a function of sensing sunlight reflected by a ground-based object. In addition, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 28B illustrates a probe 6900 including a solar sail as an example of space equipment. The probe 6900 includes a body 6901, a solar sail 6902, and a secondary battery 6905. When the secondary battery of the present invention is used as the secondary battery 6905, the secondary battery 6905 can have high reliability. Furthermore, when the secondary battery of the present invention is used as the secondary battery 6905, the secondary battery 6905 can have favorable low-temperature characteristics. When photons emitted from the sun are incident on the surface of the solar sail 6902, the momentum is transmitted to the solar sail 6902. Hence, the surface of the solar sail 6902 preferably includes a thin film with high reflectance and further preferably faces in the direction of the sun.

The solar sail 6902 may be designed such that the solar sail 6902 is furled in a small size until it goes beyond the earth's atmosphere and is unfurled to have a large sheet-like shape as illustrated in FIG. 28B in the space beyond the earth's atmosphere (outer space).

FIG. 28C illustrates a spacecraft 6910 as an example of space equipment. The spacecraft 6910 includes a body 6911, a solar panel 6912, and a secondary battery 6913. When the secondary battery of the present invention is used as the secondary battery 6913, the secondary battery 6913 can have high reliability. Furthermore, when the secondary battery of the present invention is used as the secondary battery 6913, the secondary battery 6913 can have favorable low-temperature characteristics. The spacecraft body 6911 can include a pressurized cabin and an unpressurized cabin, for example. The pressurized cabin may be designed so that a crew can get into the cabin. Electric power that is generated by illumination of sunlight on the solar panel 6912 can be stored in the secondary battery 6913.

FIG. 28D illustrates a rover 6920 as an example of space equipment. The rover 6920 includes a body 6921 and a secondary battery 6923. When the secondary battery of the present invention is used as the secondary battery 6923, the secondary battery 6923 can have high reliability. Furthermore, when the secondary battery of the present invention is used as the secondary battery 6923, the secondary battery 6923 can have favorable low-temperature characteristics. The rover 6920 may include a solar panel 6922.

The rover 6920 may be designed so that a crew can get into the rover. Electric power that is generated by illumination of sunlight on the solar panel 6912 may be stored in the secondary battery 6923, or electric power generated by another power source such as a fuel cell or a radioisotope thermoelectric generator, for example, may be stored in the secondary battery 6923.

The contents of this embodiment can be combined with any of the contents in the other embodiments as appropriate.

### Example 1

In this example, DSC measurement, a combustion test, vapor pressure calculation, Raman spectroscopy analysis, and the like were performed on a plurality of electrolyte solutions shown in the following table. The electrolyte solution A and the electrolyte solution B are solutions containing LiFP₆ serving as a lithium salt at concentrations higher than 1 mol per liter of a fluoride mixed solvent; the electrolyte solution C is a solution containing LiFP₆ serving as a lithium salt at a concentration of 1 mol or lower per liter of a fluoride mixed solvent; the electrolyte solution D is a solution containing no lithium salt; and the electrolyte solution E is a solution containing LiFP₆ serving as a lithium salt at a concentration of 1 mol or lower per liter of a mixed solvent.

TABLE 2

| | Electrolyte | Electrolyte | Electrolyte | Electrolyte | Electrolyte |
|---|---|---|---|---|---|
| | solution A | solution B | solution C | solution D | solution E |
| Mixed solvent | FEC:MTFP (2:8 vol %) | | | | EC:DEC (3:7 vol %) |
| LiPF₆ concentration | 2.0M | 1.5M | 1.0M | 0.0M | 1.0M |
| (mol/L) | | | | | |

### <DSC Measurement of Electrolyte Solution>

DSC measurement was performed to check the thermal stability of the electrolyte solutions. First, 15 mL of the electrolyte solution B, 15 mL of the electrolyte solution C, and 15 mL of the electrolyte solution E were prepared. In an Ar-filled glove box, each electrolyte solution was enclosed in a SUS container, and DSC measurement was started. The measurement apparatus and the measurement conditions of the DSC measurement were as follows.
DSC apparatus: Rigaku EVO2 DSC8271
Temperature rising rate: 5° C./min
Temperature range: room temperature (25° C.) to 350° C., both inclusive
The obtained measurement results were subjected to background correction using analysis software Thermo plus EVO.

FIG. 29 shows DSC measurement results. In FIG. 29, the horizontal axis represents temperature (Temperature [° C.]), and the vertical axis represents heat flow [mW/g]. The heat flow corresponds to heat flow per weight of a sample. The heat flows of the electrolyte solution B and the electrolyte solution C were lower than that of the electrolyte solution E. This confirms that the electrolyte solution B and the electrolyte solution C each including the fluoride mixed solvent were thermally stabler than the electrolyte solution E. In particular, it was found that the peaks of the heat flows (the amounts of heat generation) of the electrolyte solution B and the electrolyte solution C in the range higher than or equal to 180° C. and lower than or equal to 300° C. were 200 mW/g or less, preferably 100 mW/g or less. It was found that there was no significant difference in thermal stability between the electrolyte solution B and the electrolyte solution C, and there was no significant difference between the heat flows even when the concentration of LiPF₆ was increased. The DSC measurement in this example demonstrates that the electrolyte solution B and the electrolyte solution C each including the fluoride mixed solvent have higher thermal stability than the electrolyte solution E. The secondary battery including the electrolyte solution B or the electrolyte solution C tends to be capable of inhibiting thermal runaway and/or ignition.

### <Combustion Test>

A combustion test was performed to confirm the incombustibility and thermal stability. First, four samples of each of the electrolyte solution A to the electrolyte solution C were prepared as follows: glass fiber (18 mm in diameter) was prepared and 2.8 mL of each of the electrolyte solution A to the electrolyte solution C was made to infiltrate the glass fiber. In this example, four samples are identified by notation of n1, n2, n3, and n4. The combustion time of fire ignited by bringing a test flame closer to each sample was measured. “Nonflammable” as an evaluation benchmark means the case where a sample was not ignited at all when brought close to a test flame. Moreover, “flammable” as an evaluation benchmark means the case where fire is observed.

The evaluation results of the combustion test are shown in the table below.

TABLE 3
Evaluation of combusion test

| | | |
|---|---|---|
| Electrolyte | Electrolyte | Electrolyte |
| solution A | solution B | solution C |

| | | | |
|---|---|---|---|
| n1 to n4 | n1, n2 | n3, n4 | n1 to n4 |
| Nonflammable | Flammable | Nonflammable | Flammable |

All of the four samples the electrolyte solution A were evaluated to be nonflammable. Two samples of the electrolyte solution B were evaluated to be flammable, whereas the other two samples were evaluated to be nonflammable. All of the four samples of the electrolyte solution C were evaluated to be flammable. Thus, the electrolyte solution A showed the highest thermal stability in the combustion test. The electrolyte solution A and the electrolyte solution B in which the concentrations of LiPF₆ serving as the lithium salt were higher than 1 mol per liter of the fluoride mixed solvent were found to be less likely to burn than the electrolyte solution C in which the concentration of LiPF₆ was 1 mol or lower per liter of the fluoride mixed solvent. It was proved that thermal runaway and/or ignition can be inhibited in the secondary battery including the electrolyte solution A or the electrolyte solution B.

The evaluation results of this combustion test were not inconsistent with the above-described DSC measurement results. Furthermore, although a large difference in heat flow was not observed even when the concentration of LiPF₆ was increased in the DSC measurement, the samples were evaluated to be nonflammable as the concentration of LiPF₆ was increased in the combustion test. Specifically, since the electrolyte solution C was burnt, it was found from this test that the concentration of LiPF₆ is preferably higher than 1 mol per liter of the fluoride mixed solvent. It was proved that the electrolyte solution containing a lithium salt at a predetermined concentration and including the fluoride mixed solvent has high thermal stability, and thus, thermal runaway and/or ignition can be inhibited in the secondary battery including the electrolyte solution.

### <Evaluation of Gas Generation Due to Vaporization>

The reason why the electrolyte solution burs or kept burning is presumably because of burning molecules of vaporized electrolyte solution. Thus, in this example, the ease of vaporization of the electrolyte solution A to the electrolyte solution D was calculated by classical molecular dynamics calculation.

The initial coordinates of each molecule and calculation of charge of each atom, which are used in the classical molecular dynamics calculation, are described. The initial coordinates of molecules of FEC, MTFP, and LiPF₆ (PF₆⁻) and charge assigned to each atom are obtained by quantum chemical calculation using Gaussian 16 as software. First, structure optimization is performed in a vacuum at a B3LYP/6-31G(d) level. After that, single point calculation is performed in a vacuum at a HF/6-31G(d) level to calculate ESP charges of the atoms. The value obtained by multiplying the obtained ESP charge by 0.8 in PF₆⁻ is a charge assigned to each atom. Note that the charge of Li⁺ is set to 0.8. The coordinates after the above-described structure optimization are used as the initial coordinates of molecules in the classical molecular dynamics calculation.

Next, models in which the electrolyte solution A to the electrolyte solution D are aggregated as droplets are prepared. The cell size is 10 nm×10 nm×10 nm of a cube. The numbers of molecules of the electrolyte solution A to the electrolyte solution D are shown in the following table. The volume ratio of FEC to MTFP is set to approximately 2:8.

TABLE 4

| | | | |
|---|---|---|---|
| Electrolyte | Electrolyte | Electrolyte | Electrolyte |
| solution A | solution B | solution C | solution D |

| | |
|---|---|
| FEC | 102 molecules |
| MTFP | 258 molecules |

| | | | | |
|---|---|---|---|---|
| LiPF₆ | 86 | 62 | 40 | — |
| | molecules | molecules | molecules | |

The classical molecular dynamics calculation for calculating the vapor pressure of the electrolyte solution is performed using Gromacs (version 2024.1) as software. GAFF2 is used for the intramolecular potential, and OPLS is used for the intermolecular potential. For the calculation of Coulomb interaction, a particle mesh Ewald (PME) method with a cut-off distance of 1.0 nm is used. For the calculation of Van der Waals force, a cut-off method with a cut-off distance of 1.0 nm is used. NVT is used for an ensemble, and a v-rescale method is used for temperature control. Classical molecular dynamics calculations at constant temperatures (51.85° C., 76.85° C., 101.85° C., 126.85° C., and 151.85° C.) are performed on the models of the electrolyte solution A to the electrolyte solution D. The timestep is set to 0.5 fs, and the calculation is performed up to 50 nsec. The vapor pressure is an average value of pressures of the X axis direction, the Y axis direction, and the Z axis direction of a particular cell that is assumed to be in vacuum and an average value between 20 nsec and 50 nsec.

FIG. 30 shows the calculation results of the vapor pressures of the electrolyte solution A to the electrolyte solution D. The values of the vapor pressures at the temperatures (51.85° C., 76.85° C., 101.85° C., 126.85° C., and 151.85° C.) are shown in the table below.

TABLE 5
Vapor pressure (MPa)

| | Electrolyte | Electrolyte | Electrolyte | Electrolyte |
|---|---|---|---|---|
| ° C. | solution A | solution B | solution C | solution D |
| 51.85 | 0.022 | 0.028 | 0.034 | 0.051 |
| 76.85 | 0.038 | 0.071 | 0.089 | 0.086 |
| 101.85 | 0.090 | 0.133 | 0.171 | 0.180 |
| 126.85 | 0.189 | 0.231 | 0.290 | 0.339 |
| 151.85 | 0.283 | 0.384 | 0.463 | 0.573 |

The calculation results show that the vapor pressure decreases (vaporization is less likely to occur) with an increase in the concentration of LiPF₆. The reason why vaporization is less likely to occur when the concentration of LiPF₆ is high is probably because the number of molecules of the mixed solvent being in the surface of a liquid phase decreases and a pulling force due to electrostatic interaction is applied between lithium ions generated from LiPF₆ and the molecule of the mixed solvent. That is, the higher the concentration of LiPF₆ is, the higher the proportion of molecules in the mixed solvent coordinated to the lithium ions is; thus, it is probable that vaporization is less likely to occur.

The calculation results show that the electrolyte solution A and the electrolyte solution B each including the fluoride mixed solvent are less likely to vaporize. In other words, it is inferred that the electrolyte solution containing the fluoride mixed solvent is less likely to vaporize when the concentration of LiPF₆ is higher than 1.0 mol per liter of the fluoride mixed solvent. The secondary battery including the electrolyte solution A or the electrolyte solution B is expected to be capable of inhibiting thermal runaway and/or ignition.

The calculation results show that the electrolyte solution A and the electrolyte solution B are preferable as the electrolyte solution that is less likely to vaporize; thus, the electrolyte solution preferably has a vapor pressure upper limit lower than 0.034 MPa at 51.85° C., preferably has a vapor pressure upper limit lower than 0.089 MPa at 76.85° C., preferably has a vapor pressure upper limit lower than 0.171 MPa at 101.85° C., preferably has a vapor pressure upper limit lower than 0.290 MPa at 126.85° C., and preferably has a vapor pressure upper limit lower than 0.463 MPa at 151.85° C. The electrolyte solution that satisfies the range of the vapor pressure at each of the above temperatures is expected to inhibit thermal runaway and/or ignition of the secondary battery. A secondary battery including the electrolyte solution that satisfies all the ranges of the vapor pressure at the above temperatures is expected to be capable of further inhibiting thermal runaway and/or ignition.

### <Raman Spectroscopy Analysis>

Raman spectra of the electrolyte solution A, the electrolyte solution C, FEC, and MTFP were measured to confirm solvation. The measurement conditions of Raman spectroscopy are as follows.
Ambient temperature: room temperature (17° C. to 25° C., both inclusive)
Lens: 50×LD
Laser wavelength: 785 nm
Output: 5 mW
Aperture: 50 μm
Wavenumber resolution: 1.5 cm⁻¹
Spectra range: 1200a, 50-1400 cm⁻¹
Number of accumulations: 32
Light exposure time: 5000 milliseconds

Analysis conditions of Raman spectroscopy are as follows.
Wavenumber region: 200 cm⁻¹ or less is cut
Baseline correction: Concave rubberband correction method
Iterations: 10
Baseline points: 64

FIG. 31 shows the measurement results of Raman spectroscopy analysis. FIG. 31 shows a profile in the range of 700 cm⁻¹ to 1000 cm⁻¹ with the wave number [cm⁻¹] on the horizontal axis and an intensity (a.u.) on the vertical axis. As for the electrolyte solution A and the electrolyte solution C, peaks (1) corresponding to solvation of MTFP and Li ions (Li cations) included in the electrolyte solution A and the electrolyte solution C were observed in the range of 830 cm⁻¹ to 850 cm⁻¹. The peaks (1) show that the electrolyte solution A has higher intensity than the electrolyte solution C, and the solvation increases as the concentration of LiPF₆ increases. It was confirmed that MTFP with low solvation energy was able to solvate Li ions unexpectedly. In addition, peaks (2) corresponding to solvation of Li ions (Li cations) and FEC contained in the electrolyte solution A and the electrolyte solution C were observed in the range of 900 cm⁻¹ to 950 cm⁻¹. The peaks (2) show that the electrolyte solution A has higher intensity than the electrolyte solution C, and the solvation increases as the concentration of LiPF₆ increases. The Raman spectroscopy analysis in this example shows that the electrolyte solutions containing the fluoride mixed solvent enable solvation with LiPF₆, which is a lithium salt, appropriately.

### <Calculation of Wettability of Separator>

The wettability of FEC and the wettability of MTFP with the separator were calculated by first-principles calculation. The separator are assumed to be polypropylene and polyimide. Note that for simplification of calculation, an imide compound, which is a partial structure, is used in the calculation of polyimide. The structural formula of polyimide used in the calculation is shown in Structural Formula (H31) below.

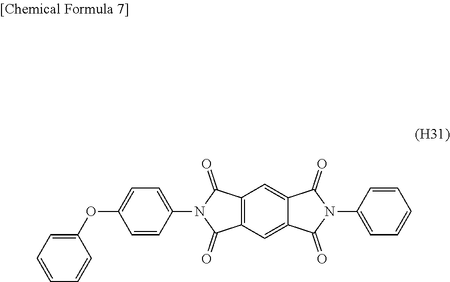 [SMILES: O=c1c2cc3c(=O)n(-c4ccc(Oc5ccccc5)cc4)c(=O)c3cc2c(=O)n1-c1ccccc1]

The structural formula of polypropylene used in the calculation is shown in Structural Formula (H32) below.

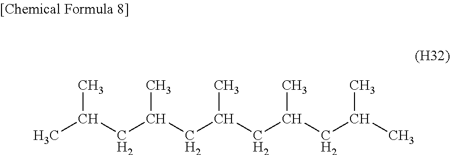 [SMILES: CC(C)CC(C)CC(C)CC(C)CC(C)C]

The structural formula of FEC used in the calculation is represented by Structural Formula (H10) above, and the structural formula of MTFP is represented by Structural Formula (H22) above.

First, the interaction between the separator and FEC in the same space was examined by first-principles calculation. Similarly, the stabilization energy was examined by first-principles calculation for the interaction between the separator and MTFP in the same space. The following table lists stabilization energies between polypropylene and FEC, between polypropylene and MTFP, between the imide compound and FEC, and between the imide compound and MTFP. In the following table, the higher the value of the stabilization energy is, the more stable it is and the more easily the interaction occurs. The imide compound is found to have higher stabilization energy and be stabler in the same space than polypropylene. This suggests that the imide compound (polyimide) has higher wettability than polypropylene.

TABLE 6
Stabilization energy [eV]

| | | Imide compound |
|---|---|---|
| | Polypropylene | (polyimide) |
| FEC | 0.32 | 0.52 |
| MTFP | 0.38 | 0.60 |

The reason why the imide compound was greatly stabilized in proximity to FEC and MTFP is probably because the imide compound has negatively polarized oxygen that interacts with hydrogen in FEC and hydrogen in MTFP.

Next, separation of charges in polypropylene and separation of charges in the imide compound were calculated. The separation of charges is also referred to as polarization. Polypropylene contains carbon and hydrogen but contains no other element. Moreover, although hydrogen contained in polypropylene is a candidate for an atom that can interact with another molecule, the charge of the hydrogen is weak and thus the hydrogen is less likely to interact with FEC and MTFP. As a result, the wettability of polypropylene with a mixed solvent containing FEC and MTFP is presumably lower than that of polyimide.

The imide compound (polyimide) contains carbon and hydrogen and further contains nitrogen and oxygen as the other elements. It is considered that oxygen in the imide compound has a large separation of charges and thus another molecule is likely to come close thereto. Since the oxygen has a negative charge, the oxygen easily interacts with hydrogen of FEC and MTFP, which has a positive charge. As a result, the wettability of the imide compound (polyimide) with the mixed solvent containing FEC and MTFP is presumably higher than that of polypropylene.

### Example 2

In this example, physical characteristics of a separator containing polyimide (referred to as a PI separator) will be described.

### [DSC Measurement of Separator]

DSC measurement was performed on the PI separator and a polypropylene separator (referred to as a PP separator). In an Ar-filled glove box, each separator was cut out to 3 mmϕ. After that, three cut-out separators were stacked and put in a SUS container, a 2-mmϕ zirconia ball was put thereon and enclosed in the SUS container, and then DSC measurement was started. The apparatus and the conditions of the DSC measurement were as follows.
DSC apparatus: Rigaku EVO2 DSC8271
Temperature rising rate: 5° C./min
Temperature range: from room temperature (25° C.) to 350° C., both inclusive
The obtained measurement results were subjected to background correction using analysis software Thermo plus EVO.

FIG. 32 show the DSC measurement results. In FIG. 32, the horizontal axis represents temperature [° C.], and the vertical axis represents heat flow [mW]. The heat flow corresponds to heat flow per weight of a sample. The dashed line represents the result of the PP separator and the solid line represents the result of the PI separator.

The peak of the PP separator that seemed to be due to an endothermic reaction was observed at higher than or equal to 155° C. and lower than or equal to 165° C. The temperature higher than or equal to 155° C. and lower than or equal to 165° C. is close to the temperature at the time of abnormal heat generation of the secondary battery. Thus, the PP separator having the above heat absorption reaction can be a material having a favorable shut-down function.

On the other hand, the peak of the PI separator that seemed to be due to an endothermic reaction was not observed at higher than or equal to 25° C. and lower than or equal to 350° C. That is, the shape of the PI separator is inhibited from changing even when the temperature of the secondary battery increases. For example, in the nail penetration test, assuming that abnormal heat generation caused when a nail penetrates a secondary battery in a charged state and an internal short circuit occurs, the PI separator can withstand the abnormal heat generation, so that a large amount of current can be inhibited from flowing to the internal short circuit portion. Thus, the PI separator that does not show a peak that seems to be due to an endothermic reaction at higher than or equal to 25° C. and lower than or equal to 350° C. can inhibit the secondary battery from being brought into a high-temperature state, and the secondary battery including the PI separator has a high level of safety.

### <Thermomechanical Measurement (TMA)>

A thermomechanical measurement (TMA) is a method in which deformation of a substance is measured as a function of temperature or time under a non-oscillating stress such as compression, tension, or bending while the temperature of a sample is programmed.

The PI separator was subjected to thermal mechanical analysis. Analysis conditions are as follows:
Measurement apparatus: TMA/SS6100 (Hitachi High-Tech Science)
Temperature range: 29° C. to 550° C., both inclusive
Temperature rising rate: 5° C./min
Measurement atmosphere: N₂
Measurement load: 98 mN (approximately 10 g)
Sample size: length 20 mm, width 3 mm, thickness 0.036 mm

FIG. 33A shows the TMA results. The horizontal axis represents temperature [° C.], and the vertical axis represents TMA [μm]. Here, TMA represents the amount of change [μm] from the start of the measurement. In FIG. 33B, the vertical axis represents an elongation rate (the length of expansion or shrinkage [μm]/temperature [° C.]) of a sample and the horizontal axis represents the temperature [° C.]. A change that seemed to be shrinkage was not observed in the PI separator. Specifically, it was confirmed that the PI separator did not shrink at a temperature higher than or equal to 155° C. and lower than or equal to 165° C. Since the temperature at the time of abnormal heat generation of the secondary battery is higher than or equal to 155° C. and lower than or equal to 165° C., an internal short circuit in the secondary battery is expected to be less likely to occur owing to the PI separator that is less likely to shrink. Furthermore, the elongation rate changes in accordance with the load at higher than or equal to 350° C. and lower than or equal to 400° C. The elongation rate is higher than or equal to 0.5 μm/° C. and lower than or equal to 1.5 μm/° C. at higher than or equal to 150° C. and lower than or equal to 300° C., and the PI separator is found to be easily elongated at higher than or equal to 300° C. and lower than or equal to 400° C. Such a PI separator can be elongated along with a nail in a nail penetration test described later, and it is expected that thermal runaway and/or ignition of the secondary battery can be inhibited.

### <Tensile Test>

In order to obtain the mechanical strength characteristic value of the PI separator, a tensile test was performed with AG-X as a mechanical measurement different from TMA. The measurement was performed at 25° C. on the assumption of room temperature and 250° C. on the assumption of the attained temperature of thermal runaway of the secondary battery. The tensile speed in this example was 50 mm/min, and the tensile test was stopped when the sample was broken. In the tensile test in this example, the PI separator was evaluated using the maximum value [N] of the test force and the maximum value [MPa] of the stress.

Table 7 shows the maximum values of the test forces [N] and the maximum values of the stresses [MPa] at 25° C. and 250° C., and the rates [%] of change in the maximum values of the test forces [N] and the maximum values of the stresses [MPa] from 25° C. to 250° C.

TABLE 7

| | |
|---|---|
| Maximum value | Maximum value |
| of test force | of stress |

25° C.

| | | | |
|---|---|---|---|
| 2.01 | [N] | 39.5 | [Mpa] |

250° C.

| | | | |
|---|---|---|---|
| 1.07 | [N] | 20.6 | [Mpa] |

Change rate from 25 to 250° C.

| | | | |
|---|---|---|---|
| −46.8 | [%] | −47.8 | [%] |

The result of the tensile test at 25° C. indicates that the maximum value of the test force of the PI separator was greater than or equal to 1.8 N and less than or equal to 2.2 N, and the maximum value of the stress of the PI separator was greater than or equal to 35 MPa and less than or equal to 45 MPa. The result of the tensile test at 250° C. indicates that the maximum value of the test force of the PI separator was greater than or equal to 0.8 N and less than or equal to 1.2 N, and the maximum value of the stress of the PI separator was greater than or equal to 15 MPa and less than or equal to 25 MPa. Furthermore, the rates of change of the maximum value of the test force and the maximum value of the stress at 250° C. from those at 25° C. were both found to be greater than or equal to −55% and less than or equal to −40%, showing that the mechanical strength of the PI separator is unlikely to change. This suggests that the PI separator maintains its mechanical strength even when abnormal heat generation occurs due to an internal short circuit or the like of the secondary battery; thus, the safety of the secondary battery using the PI separator is probably high.

### Example 3

In this example, a nail penetration test was performed. A method for manufacturing a laminate cell for a nail penetration test will be described.

### <Laminate Cell>

A laminate cell for a nail penetration test was prepared.

### <Manufacturing of Positive Electrode Active Material>

The manufacturing conditions of the positive electrode active material in this example are described with reference to the steps shown in FIG. 6 and FIGS. 7A to 7C.

### <Sample A>

As the LiCoO₂ in Step S14 in FIG. 6, a commercially available lithium cobalt oxide (Cellseed C-5H, NIPPON CHEMICAL INDUSTRIAL CO., LTD.) not containing any additive element was prepared. As the lithium cobalt oxide in this step, a lithium cobalt oxide with sufficiently low concentrations of magnesium and titanium as additive elements described later, i.e., with low concentrations of impurities is preferably used, in which case the distribution and the like of the additive elements described later can be easily controlled. The lithium cobalt oxide used in this step preferably has a median diameter (D50) of 10 μm or less, typically 7.0 μm. The median diameter (D50) can be measured with a laser diffraction particle size analyzer, SHIMADZU SALD-2200. Note that the heating for the lithium cobalt oxide in this step was not performed.

In accordance with Step S20 to Step S33 in FIG. 6, magnesium and fluorine were added as the additive element A1. First, as shown in Step S21 in FIG. 7A, magnesium fluoride (MgF₂) and lithium fluoride (LiF) were prepared as a magnesium source and a fluorine source, respectively. In addition, magnesium fluoride may also be referred to as a fluorine source. LiF and MgF₂ were weighed so that the molar ratio of LiF to MgF₂ was 1:3. Then, LiF and MgF₂ were put in dehydrated acetone and mixed at a rotating speed of 500 rpm for 20 hours (Step S22). In the mixing, a ball mill was used and zirconium oxide balls having diameters of 1 mm were used as a grinding medium. In a 45-mL-capacity container of a mixing ball mill, LiF and MgF₂ weighing approximately 10 g in total were put together with 20 mL of dehydrated acetone and 22 g of zirconium oxide balls and mixed. After the mixing, dehydrated acetone was removed using a drying furnace, and the mixture was made to pass through a sieve with an aperture size of 300 μm and a sieve with an aperture size of 53 μm, whereby an additive element source (A1 source) was obtained (Step S23). When the mixture was made to pass through the sieve with the aperture size of 53 μm, the median diameter (D50) of the A1 source was less than or equal to 100 μm, which was suitable for use in Picoline described later.

Next, in Step S31, the A1 source and the lithium cobalt oxide were weighed such that the number of fluorine atoms of MgF₂ contained in the A1 source was 0.75 atomic % with respect to the number of cobalt atoms of the lithium cobalt oxide, and the A1 source and the lithium cobalt oxide were mixed by a composite formation process to obtain the mixture 901 (Step S32). As an apparatus for the composite formation process, Picoline (Hosokawa Micron) equipped with Nobilta as a rotor was used and stirring was performed at a rotating speed of 3000 rpm for 10 minutes. During the composite formation process, heat generation was suppressed using cooling water.

Next, as Step S33, the mixture 901 was heated. The heating was performed at 850° C. for 10 hours. During the heating, the mixture 901 was in a sagger covered with a lid. The sagger was placed in a roller hearth kiln simulator furnace (produced by NORITAKE CO., LIMITED) and heated at the above heating temperature. Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the heating, the furnace was cooled at a rate of 200° C./h, with the oxygen flow continued until the temperature reached 200° C. In this manner, the composite oxide 902 containing Mg and F was obtained (Step S34a).

Next, in accordance with Step S40 to Step S54, nickel and aluminum were added as the additive elements A2. First, as shown in Step S41 and Step S43 in FIG. 7B, nickel hydroxide (Ni(OH)₂) that has been subjected to a grinding step (Step S42) was prepared as the nickel source, and aluminum hydroxide (Al(OH)₃) that has been subjected to the grinding step (Step S42) was prepared as the aluminum source. The grinding step was performed by a wet method using dehydrated acetone. After the grinding, dehydrated acetone was removed using a drying furnace, and the mixture was made to pass through a sieve with an aperture size of 300 μm and a sieve with an aperture size of 53 μm. When the mixture was made to pass through the sieve with the aperture size of 53 μm, the diameters of particles contained in the A2 source were less than or equal to 100 μm, which was suitable for use in Picoline described later.

The nickel hydroxide and the aluminum hydroxide were weighed such that the number of nickel atoms in the nickel hydroxide was 0.50 atomic % with respect to the number of cobalt atoms in the lithium cobalt oxide, and the number of aluminum atoms in the aluminum hydroxide was 0.25 atomic % with respect to the number of cobalt atoms in the lithium cobalt oxide, and the nickel hydroxide, the aluminum hydroxide, and the composite oxide 902 were mixed by a composite formation process to obtain the mixture 903 (Step S52). As an apparatus for the composite formation process, Picoline (Hosokawa Micron) equipped with Nobilta as a rotor was used and stirring was performed at a rotating speed of 3000 rpm for 10 minutes. During the composite formation process, heat generation was suppressed using cooling water.

Next, in Step S53, the mixture 903 was heated. The heating was performed at 850° C. for 2 hours. As a result of performing the mixing step utilizing the composite formation process, Step S53 can be performed in a shorter time than Step S33, leading to an improvement of the productivity. During the heating, the mixture 903 was in a sagger covered with a lid. The sagger was placed in a roller hearth kiln simulator furnace (produced by NORITAKE CO., LIMITED) and heated at the above heating temperature. Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the heating, the furnace was cooled at a rate of 200° C./h, with the oxygen flow continued until the temperature reached 200° C. In this manner, the composite oxide 904 containing Mg, F, A1, and Ni was obtained (Step S54).

Next, titanium was added as the additive element A3 in accordance with Step S60 to Step S74. As shown in Step S61 to Step S63 in FIG. 7C, lithium titanate (Li₂TiO₃) that has been subjected to a grinding step (Step S62) was prepared as the titanium source. As media, zirconium oxide balls were used, lithium titanate was put in dehydrated acetone, and stirring was performed at a rotating speed of 400 rpm for 12 hours. Specifically, Li₂TiO₃ weighing approximately 5 g was put in a 45-mL-capacity container of a mixing ball mill together with 20 mL of dehydrated acetone and 22 g of zirconium oxide balls (1 mmϕ) and mixed. Then, the mixture was made to pass through a sieve with an aperture size of 300 μm, whereby the A3 source was obtained (Step S63).

Next, in Step S71, the A3 source and the lithium cobalt oxide were weighed such that the number of titanium atoms in the A3 source was 0.1 atomic % with respect to the number of cobalt atoms of the lithium cobalt oxide, and the A3 source and the composite oxide 904 were mixed by a composite formation process to obtain the mixture 905 (Step S72). As an apparatus for the composite formation process, Picoline (Hosokawa Micron) equipped with Nobilta as a rotor was used and stirring was performed at a rotating speed of 3000 rpm for 10 minutes. During the composite formation process, heat generation was suppressed using cooling water.

Next, as Step S73, the mixture 905 was heated. The heating was performed at 850° C. for 2 hours. Step S73 can be performed in a shorter time than Step S33, leading to an improvement of the productivity. During the heating, the mixture 903 was in a sagger covered with a lid. The sagger was placed in a roller hearth kiln simulator furnace (produced by NORITAKE CO., LIMITED) and heated at the above heating temperature. Oxygen was made to flow at 10 L/min in the furnace (02 flow). The flow rate, specifically, the width of an opening of an outlet, was adjusted such that a differential pressure gauge read 5 Pa, whereby the inside of the furnace was under positive pressure. After the heating, the furnace was cooled at a rate of 200° C./h, with the oxygen flow continued until the temperature reached 200° C.

The composite oxide containing Mg, F, A1, Ni, and Ti obtained in this manner was used as Sample X, which was the positive electrode active material in Example 1.

### <Manufacturing of Positive Electrode>

Sample A described above, acetylene black (AB), and poly(vinylidene fluoride) (PVDF) were prepared as a positive electrode active material, a conductive material, and a binding agent in a laminate cell, respectively. The PVDF prepared was one dissolved in N-methyl-2-pyrrolidone (NMP) at a weight ratio of 5%. Then, the positive electrode active material, AB, and PVDF were mixed at a weight ratio of 95:3:2 to form a slurry. The slurry was applied to a positive electrode current collector of aluminum, and the slurry was dried at 70° C. to volatilize NMP. The thickness of the positive electrode current collector of aluminum was 12 μm. After that, pressing was performed with a roller press machine to increase the density of a positive electrode active material layer over the positive electrode current collector. The pressing was performed with a linear pressure of 210 kN/m. Note that the temperature of each of an upper roll and a lower roll of the roller press machine was 120° C.

Through the above steps, the positive electrode was obtained. By the manufacturing method described here, a positive electrode X including Sample X of the positive electrode active material was manufactured. As the positive electrode of the laminate cell, 15 double-side coated positive electrodes X were prepared to make a double-side coating state (slurry was applied on both surfaces of the positive electrode current collectors).

### <Manufacturing of Negative Electrode>

A negative electrode used in this example is described with reference to the manufacturing method in FIG. 15.

In accordance with Step S160 in FIG. 15, as the negative electrode active material, graphite particles each having a median diameter (D50) of 10.1 μm and a specific surface area of 1.57 m²/g (ground carbon-coated MCMB, manufactured by Long Time Technology, Product Name: PWSHC) were prepared. The specific surface area is a value measured by a BET method. In addition, SBR (50% water-dispersed SBR; manufactured by JSR Corporation, Product Name: TRD2001) was prepared as a binder, and CMC (manufactured by Kishida Chemical, Product No.: 020-14515) was prepared as a thickener. Carbon fiber (VGCF (registered trademark) produced by Resonac) was prepared as a conductive material. Water (deionized water) was prepared as a solvent.

Next, in accordance with Step S161 and Step S162 in FIG. 15, graphite particles, CMC, SBR, and VGCF were weighed such that a weight ratio of graphite particle:CMC:SBR:VGCF was 97:1:1:1, and the graphite particles, VGCF, CMC, and SBR were added to water serving as a solvent and mixed to form a slurry.

In accordance with Step S162 in FIG. 15, a copper foil with a thickness of 18 μm was prepared as the negative electrode current collector.

In accordance with Step S165 in FIG. 15, the negative electrode slurry was applied to coat the negative electrode current collector. Coating in Step S165 was performed using a micro bar reverse coater. As the negative electrode for the laminate cell in this example, 14 double-side coated negative electrodes (slurry applied on both surfaces of the negative electrode current collector) and two single-side coated negative electrodes (slurry applied on one surface of the negative electrode current collector) were prepared. The single-side coated negative electrodes were placed as an outer surface of the stack.

In accordance with Step S166 in FIG. 15, the negative electrode slurry was dried to remove water. The drying in Step S166 was performed in Smart Lab produced by Techno Smart: drying was performed in a drying furnace at 50° C. for three minutes, and then drying was performed in a drying furnace at 70° C. for three minutes.

In accordance with Step S167 in FIG. 15, pressing was performed with a roller press machine to increase the density of the active material layer in the negative electrode. The pressing was performed at 120° C. under a linear pressure of 28 kN/m.

In this manner, the negative electrode was manufactured as in Step S169 in FIG. 15.

### <Separator>

Two kinds of separators were prepared. A separator using polypropylene (PP separator) was prepared as Separator A, and a separator using polyimide (PI separator) was prepared as Separator B.

### <Electrolyte Solution>

As the electrolyte solution, a mixed solvent in which fluoroethylene carbonate (FEC) and methyl 3,3,3-trifluoropropionate (MTFP) were mixed at a FEC:MTFP volume ratio of 2:8 was prepared, and lithium hexafluorophosphate (LiPF₆) was prepared as the lithium salt contained in the electrolyte solution. The lithium salt was adjusted to be 1.5 mol/L in the mixed solvent.

### <Exterior Body>

As the exterior body, an aluminum laminate film was prepared. The aluminum laminate film includes first polypropylene (that is referred to as PP in some cases and has a thickness of 22.5 μm), second polypropylene (with a thickness of 22.5 μm), aluminum foil (with a thickness of 40 μm), and nylon (with a thickness of 25 μm) in this order from the inside of the exterior body. The first polypropylene includes a region in contact with the single-side coated negative electrode, specifically, the negative electrode current collector. Furthermore, nylon is positioned as the outermost surface of the exterior body.

### <Manufacturing of Laminate Cell Used in Nail Penetration Test>

A laminate cell A was manufactured using the positive electrode X, the negative electrode formed above, the electrolyte solution, the separator A, and the exterior body. A laminate cell B was manufactured using the positive electrode X, the negative electrode formed above, the electrolyte solution, the separator B, and the exterior body. In each of the laminate cells, after the injection of 15 mL of the electrolyte solution, the cell was sealed under a pressure reduced to −60 kPa with the use of a degassing sealer capable of reducing pressure.

The loading level of the positive electrode active material (the loading level of the positive electrode active material composite) in each of the laminate cell A and the laminate cell B was approximately 21 mg/cm². The loading level of the negative electrode active material in the negative electrode was approximately 15 mg/cm². In the case of double-side coating, the loading level of the active material is represented by a value per active material layer on one side of the current collector. In each of the laminate cells, the area of the positive electrode applied to one side of the current collector was approximately 21 cm² and the area of the negative electrode was approximately 24 cm². In the laminate cell, the area of the negative electrode is preferably larger than the area of the positive electrode, and is preferably more than or equal to 1.1 times and less than or equal to 1.3 times the area of the positive electrode. Therefore, the loading level of the negative electrode active material is preferably lower than the loading level of the positive electrode active material (the loading level of the positive electrode active material composite).

The table below lists the manufacturing conditions of the laminate cell A and the laminate cell B used in the nail penetration test.

TABLE 8

| | | Laminate | Laminate |
|---|---|---|---|
| | | cell A | cell B |
| Positive electrode | Active material | Sample X | |
| | Binder | PVdF | |
| | Conductive additive | Acetylene black | |
| | Loading level (one side) | 21.4 mg/cm² | 21.6 mg/cm² |
| | Current collector | Al (double mirror surfaces)/20 μm | |
| | material/Thickness | | |
| | Pressure for pressing | 210 kN/m | |
| Negative electrode | Active material | Artificial graphite, PWSHC | |
| | Binder, Thickener | SBR, CMC | |
| | Conductive additive | VGCF | |
| | Loading level (one side) | 14.7 mg/cm² | 14.8 mg/cm² |
| | Current collector | Cu/18 μm | |
| | material/Thickness | | |
| Separator | Material/Thickness | PP (polypropylene)/ | PI (polyimide)/ |
| | | 24 μm | 25 μm |
| Electrolyte solution | Mixed solvent | FEC:MTFP (20:80 volume ratio) | |
| | Lithium salt | 1.5 mol/L_LiPF₆ | |
| | Amount of injected | 15 mL | |
| | electrolyte solution | | |
| Cell conditions | Number of positive | 15 pieces (double-side coating) | |
| | electrodes | | |
| | Number of negative | 14 pieces (double-side coating) + 2 pieces | |
| | electrodes | on outer side (single-side coating) | |
| | Exterior body | Aluminum laminate film | |
| Nail penetration test | Charge voltage (aging) | 4.5 V | |
| | Charge voltage (nail | 4.5 V | |
| | penetrating) | | |
| | Design capacity | 2500 mAh | |
| | Capacity ratio between | 83.2% | 83.6% |
| | positive and negative | | |
| | electrodes | | |

### <Aging and Resealing>

First, aging and resealing of the laminate cells A and B were performed. The aging and resealing methods are shown in the table below. Note that aging is sometimes referred to as initial charging and discharging or conditioning. In the table below, 1C was set to 200 mA/g (per weight of a positive electrode active material). Step A4 in the table below corresponds to resealing, and the resealing is referred to degasification resealing. The ambient temperature in the following table allows an error of ±5° C.

TABLE 9

| | Charging/discharging | Conditions |
|---|---|---|
| Step A1 | Constant current | 0.01 C, ambient temperature: 23° C. |
| | charging | Charging was stopped when the voltage reached |
| | | 4.5 V or the capacity reached 15 mAh/g. |
| Step A2 | Constant current | 0.1 C, ambient temperature: 23° C. |
| | charging | Charging was stopped when the voltage reached |
| | | 4.5 V or the capacity reached 105 mAh/g. |
| Step A3 | w/o | Placed still in a thermostatic chamber set at 60° |
| | | C. for 24 hours |
| Step A4 | w/o | In a glove box, one side of a cell was opened |
| | | and resealed under a pressure reduced to −60 |
| | | kPa. |
| Step A5 | Constant current- | 0.1 C, 4.5 V, ambient temperature: 23° C. |
| | constant voltage | Charging was stopped when the current reached |
| | charging | 0.01 C or less or 10 hours elapsed. |
| Step A6 | Constant current | 0.2 C, ambient temperature: 23° C. |
| | discharging | Discharging was stopped when the voltage |
| | | reached 2.5 V or 8 hours elapsed. |
| Step A7 | Constant current- | 0.2 C, 4.5 V, ambient temperature: 23° C. |
| | constant voltage | Charging was stopped when the current reached |
| | charging | 0.02 C or less or 8 hours elapsed. |
| Step A8 | Constant current | 0.2 C, ambient temperature: 23° C. |
| | discharging | Discharging was stopped when the voltage |
| | | reached 2.5 V or 8 hours elapsed. |

*Step A7 and Step A8 were repeated three times in total.

### <Charge Capacity Measurement>

After the aging treatment, the laminate cell A and the laminate cell B were charged in accordance with Step A7 in the above table, and the charge capacity of the laminate cells were measured. A charge-discharge test system (TOSCAT-3000, TOYO SYSTEM) was used as the charge-discharge measurement system to measure the charge capacity. The following table shows charge voltages, charge capacity, and charge capacity per weight of the positive electrode active material of the laminate cell A and the laminate cell B in charged states. The laminate cells both showed the charge capacity close to 2500 mAh as a set value, and abnormality in the charged state was not observed.

TABLE 10

| | | Laminated | Laminated |
|---|---|---|---|
| | | cell A | cell B |
| Conditions | Charge voltage | 4.5 V | |
| of nail | Charge capacity | 2590 mAh | 2614 mAh |
| penetration | Charge capacity | 198 mAh/g | 198 mAh/g |
| | per weight of | | |
| | positive electrode | | |
| | active material | | |

### <Nail Penetration Test>

A nail penetration test was performed on the laminate cells A and B in a fully charged state of 4.5 V (corresponding to 100% SOC). For the nail penetration test, an advanced safety tester (Espec) was used as the tester illustrated in FIGS. 18A and 18B, and the temperature of the tester was set in an environment at 25° C.

Before the nail penetration test, it was confirmed that the temperature of the exterior body of each of the laminate cell A and the laminate cell B was approximately 22° C. In this example, a temperature sensor was placed at a distance of 2 cm from the nail hole, and the value obtained with the temperature sensor was used as the temperature of the exterior body. By placing the temperature sensor in the same position, there is presumed to be no difference or an extremely small difference in the temperature of the exterior body between the laminate cell A and the laminate cell B even in the case where the temperature gradient in the exterior body is taken into consideration.

As the nail 1003 in FIGS. 18A and 18B, a nail having a diameter of 3 mm was used. The nail penetration speed was 5 mm/s. The depth of nail penetration was set to a value obtained by adding 5 mm to the thickness of the secondary battery. The other conditions in the nail penetration test were compliant with SAE J2464, “Electric and Hybrid Electric Vehicle Rechargeable Energy Storage System (RESS) Safety and Abuse Testing”.

FIG. 34A shows the state of the nail penetration test of the laminate cell A, and FIG. 34B shows the state of the nail penetration test of the laminate cell B. As shown in FIGS. 34A and 34B, it was concluded that the laminate cells A and B showed no ignition because the laminate cells A and B did not ignite or only a small amount of smoke from the laminate cell A or B was observed.

The cell temperatures (the temperature of the exterior body read by the temperature sensor) of the laminate cell A and the laminate cell B immediately after the nail penetration operation were the maximum temperatures, and the maximum temperatures of the laminate cell A and the laminate cell B were 57° C. and 35° C., respectively. The table below shows evaluation results and the maximum temperatures of the laminate cell A and the laminate cell B in the nail penetration test.

TABLE 11

| | | Laminate | Laminate |
|---|---|---|---|
| | | cell A | cell B |
| Nail | Evaluation | No ignition | No ignition |
| penetration | results | | |
| test | Maximum | 57° C. | 35° C. |
| | temperature | | |

The temperature which is presumed to be increased by heat generation in the nail penetration test is a temperature obtained by subtracting 22° C. from the maximum value obtained with the temperature sensor (the temperature is referred to as temperature rise ΔT). The temperature rise ΔT of the laminate cell A was 35° C., and the temperature rise ΔT of the laminate cell B was 13° C. Accordingly, it is proved that the temperature rise ΔT of the cell is lower than or equal to 60° C., preferably lower than or equal to 50° C., further preferably lower than or equal to 40° C., in order that no ignition is caused in the nail penetration test.

This application is based on Japanese Patent Application Serial No. 2024-088733 filed with Japan Patent Office on May 31, 2024, and Japanese Patent Application Serial No. 2025-057951 filed with Japan Patent Office on Mar. 31, 2025, the entire contents of which are hereby incorporated by reference.

What is claimed is:

1. A secondary battery comprising:
a positive electrode;
a negative electrode;
a separator between the positive electrode and the negative electrode; and
an electrolyte solution,
wherein the electrolyte solution comprises a mixed solvent and a lithium salt,
wherein in the electrolyte solution, a concentration of the lithium salt is higher than 1 mol per liter of the mixed solvent,
wherein the mixed solvent comprises a fluorinated linear carbonate and a fluorinated cyclic carbonate, and
wherein in a DSC measurement of the electrolyte solution, a peak of heat flow of a heat generation reaction in a range higher than or equal to 180° C. and lower than or equal to 300° C. is less than or equal to 200 mW/g.

2. A secondary battery comprising:
a positive electrode;
a negative electrode;
a separator between the positive electrode and the negative electrode; and
an electrolyte solution,
wherein the electrolyte solution comprises a mixed solvent and a lithium salt,
wherein in the electrolyte solution, a concentration of the lithium salt is higher than 1 mol per liter of the mixed solvent,
wherein the mixed solvent comprises a fluorinated linear carbonate and a fluorinated cyclic carbonate, and
wherein in a DSC measurement of the electrolyte solution, a peak of heat flow of a heat generation reaction in a range higher than or equal to 180° C. and lower than or equal to 300° C. is less than or equal to 100 mW/g.

3. The secondary battery according to claim 1,
wherein the separator comprises an imide compound in a region in contact with the electrolyte solution.

4. The secondary battery according to claim 1,
wherein the lithium salt comprises one or more of LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂.

5. The secondary battery according to claim 1,
wherein the fluorinated linear carbonate comprises fluoroethylene carbonate.

6. The secondary battery according to claim 1,
wherein the fluorinated cyclic carbonate comprises methyl 3,3,3-trifluoropropionate.

7. The secondary battery according to claim 2,
wherein the separator comprises an imide compound in a region in contact with the electrolyte solution.

8. The secondary battery according to claim 2,
wherein the lithium salt comprises one or more of LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂.

9. The secondary battery according to claim 2,
wherein the fluorinated linear carbonate comprises fluoroethylene carbonate.

10. The secondary battery according to claim 2,
wherein the fluorinated cyclic carbonate comprises methyl 3,3,3-trifluoropropionate.

11. The secondary battery according to claim 3,
wherein the imide compound is polyimide.

12. The secondary battery according to claim 7,
wherein the imide compound is polyimide.
